(19) United States
(12) Patent Application Publication
(10) Pub. No.: US 2024/0322891 A1
(43) Pub. Date: Sep. 26, 2024

(54) Prioritization in Beam Failure Recovery Procedures

(71) Applicant: Comcast Cable Communications, LLC, Philadelphia, PA (US)

(72) Inventors: Ali Cagatay Cirik, Chantilly, VA (US); Esmael Hejazi Dinan, McLean, VA (US); Hua Zhou, Vienna, VA (US); Hyoungsuk Jeon, Centreville, VA (US); Alireza Babaei, Fairfax, VA (US)

(21) Appl. No.: 18/735,842

(22) Filed: Jun. 6, 2024

Related U.S. Application Data
(63) Continuation of application No. 17/368,501, filed on Jul. 6, 2021, now Pat. No. 12,034,511.
Application No. 17/368,501 is a continuation of application No. 16/409,103, filed on May 10, 2019, now Pat. No. 11,095,355.
(60) Provisional application No. 62/669,473, filed on May 10, 2018.

(51) Int. Cl. H04B 7/06; H04L 1/00; H04L 1/1812; H04L 5/00; H04W 72/044; H04W 72/23; H04W 74/0833; H04W 76/27; H04W 80/02

(52) U.S. Cl. CPC H04B 7/0695; H04L 1/0026; H04L 1/1819; H04L 5/005; H04L 5/0055; H04W 72/046; H04W 72/23; H04W 74/0833; H04W 76/27; H04W 80/02

(57) ABSTRACT

Beam failure recovery (BFR) procedures are described for wireless communications. At least one transmission for BFR may overlap with a scheduled transmission. A wireless device may prioritize the at least one transmission for BFR, for example, over the scheduled transmission and may transmit the at least one transmission for BFR.

### CROSS-REFERENCE TO RELATED APPLICATIONS

This application is a continuation of U.S. application Ser. No. 17/368,501, filed Jul. 6, 2021, which is a continuation of U.S. application Ser. No. 16/409,103, filed on May 10, 2019, now U.S. Pat. No. 11,095,355, which claims the benefit of U.S. Provisional Application No. 62/669,473, titled “Prioritization in Beam Failure Recovery Procedure” and filed on May 10, 2018. The above-referenced applications are hereby incorporated by reference in their entirety.

### BACKGROUND

A base station and/or a wireless device may use a beam failure recovery (BFR) procedure based on detecting a beam failure. A BFR procedure may include transmission of at least one control signal. The transmission of the at least one control signal, or other portion of the BFR procedure, may be unsuccessful and/or delayed, which may lead to undesirable outcomes.

### SUMMARY

The following summary presents a simplified summary of certain features. The summary is not an extensive overview and is not intended to identify key or critical elements.

BFR procedures are described. A wireless device may be configured for a BFR procedure based on configuration parameters transmitted by a base station. A wireless device may transmit at least one signal to facilitate BFR (e.g., a BFR request). For example, a wireless device may transmit at least one signal to facilitate BFR based on the wireless device detecting a beam failure. A wireless device may determine that the at least one signal for the BFR procedure overlaps with a scheduled transmission on another channel. A wireless device may drop the scheduled transmission and transmit the at least one signal for the BFR procedure, for example, if the wireless device determines that a control channel to be used for the transmission of the at least one signal for the BFR procedure overlaps with the scheduled transmission. By dropping the scheduled transmission and transmitting the at least one signal for the BFR procedure, the wireless device may be able to complete the BFR procedure successfully and/or with reduced delay.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example radio access network (RAN) architecture.

FIG. 2A shows an example user plane protocol stack.

FIG. 2B shows an example control plane protocol stack.

FIG. 3 shows an example wireless device and two base stations.

FIG. 4A, FIG. 4B, FIG. 4C, and FIG. 4D show examples of uplink and downlink signal transmission.

FIG. 5A shows an example uplink channel mapping and example uplink physical signals.

FIG. 5B shows an example downlink channel mapping and example downlink physical signals.

FIG. 6 shows an example transmission time and/or reception time for a carrier.

FIG. 7A and FIG. 7B show example sets of orthogonal frequency division multiplexing (OFDM) subcarriers.

FIG. 8 shows example OFDM radio resources.

FIG. 9A shows an example channel state information reference signal (CSI-RS) and/or synchronization signal (SS) block transmission in a multi-beam system.

FIG. 9B shows an example downlink beam management procedure.

FIG. 10 shows an example of configured bandwidth parts (BWPs).

FIG. 11A and FIG. 11B show examples of multi connectivity.

FIG. 12 shows an example of a random access procedure.

FIG. 13 shows example medium access control (MAC) entities.

FIG. 14 shows an example RAN architecture.

FIG. 15 shows example radio resource control (RRC) states.

FIG. 16A and FIG. 16B show examples of beam failure scenarios.

FIG. 17 shows an example of a beam failure recovery (BFR) procedure.

FIG. 18 shows an example of a request configuration for a BFR procedure.

FIG. 19 shows an example of a BFR procedure.

FIG. 20 shows an example of a BFR procedure.

FIG. 21A and FIG. 21B show examples of BFR procedures.

FIG. 22A and FIG. 22B show examples of BFR procedures.

FIG. 23 shows an example method of a BFR procedure by a wireless device.

FIG. 24 shows an example method for a BFR procedure by a base station.

FIG. 25 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive and that there are other examples of how features shown and described may be practiced.

Examples are provided for operation of wireless communication systems which may be used in the technical field of multicarrier communication systems. More particularly, the technology described herein may relate to beam failure recovery procedures in multicarrier communication systems.

The following acronyms are used throughout the drawings and/or descriptions, and are provided below for convenience although other acronyms may be introduced in the detailed description:
3GPP 3rd Generation Partnership Project
5GC 5G Core Network
ACK Acknowledgement
AMF Access and Mobility Management Function
ARQ Automatic Repeat Request
AS Access Stratum
ASIC Application-Specific Integrated Circuit
BA Bandwidth Adaptation
BCCH Broadcast Control Channel
BCH Broadcast Channel
BFR Beam Failure Recovery
BLER Block Error Rate
BPSK Binary Phase Shift Keying
BSR Buffer Status Report
BWP Bandwidth Part
CA Carrier Aggregation
CC Component Carrier
CCCH Common Control CHannel
CDMA Code Division Multiple Access
CN Core Network
CORESET Control Resource Set
CP Cyclic Prefix
CP-OFDM Cyclic Prefix-Orthogonal Frequency Division Multiplex
C-RNTI Cell-Radio Network Temporary Identifier
CS Configured Scheduling
CSI Channel State Information
CSI-RS Channel State Information-Reference Signal
CQI Channel Quality Indicator
CSS Common Search Space
CU Central Unit
DC Dual Connectivity
DCCH Dedicated Control Channel
DCI Downlink Control Information
DL Downlink
DL-SCH Downlink Shared CHannel
DM-RS DeModulation Reference Signal
DRB Data Radio Bearer
DRX Discontinuous Reception
DTCH Dedicated Traffic Channel
DU Distributed Unit
EPC Evolved Packet Core
E-UTRA Evolved UMTS Terrestrial Radio Access
E-UTRAN Evolved-Universal Terrestrial Radio Access Network
FDD Frequency Division Duplex
FPGA Field Programmable Gate Arrays
F1-C F1-Control plane
F1-U F1-User plane
gNB next generation Node B
HARQ Hybrid Automatic Repeat reQuest
HDL Hardware Description Languages
IE Information Element
IP Internet Protocol
LCH Logical Channel
LCID Logical Channel Identifier
LTE Long Term Evolution
MAC Media Access Control
MCG Master Cell Group
MCS Modulation and Coding Scheme
MeNB Master evolved Node B
MIB Master Information Block
MME Mobility Management Entity
MN Master Node
NACK Negative Acknowledgement
NAS Non-Access Stratum
NG CP Next Generation Control Plane
NGC Next Generation Core
NG-C NG-Control plane
ng-eNB next generation evolved Node B
NG-U NG-User plane
NR New Radio
NR MAC New Radio MAC
NR PDCP New Radio PDCP
NR PHY New Radio PHYsical
NR RLC New Radio RLC
NR RRC New Radio RRC
NSSAI Network Slice Selection Assistance Information
O&M Operation and Maintenance
OFDM Orthogonal Frequency Division Multiplexing
PBCH Physical Broadcast CHannel
PCC Primary Component Carrier
PCCH Paging Control CHannel
PCell Primary Cell
PCH Paging CHannel
PDCCH Physical Downlink Control CHannel
PDCP Packet Data Convergence Protocol
PDSCH Physical Downlink Shared CHannel
PDU Protocol Data Unit
PHICH Physical HARQ Indicator CHannel
PHY PHYsical
PLMN Public Land Mobile Network
PMI Precoding Matrix Indicator
PRACH Physical Random Access CHannel
PRB Physical Resource Block
PSCell Primary Secondary Cell
PSS Primary Synchronization Signal
pTAG primary Timing Advance Group
PT-RS Phase Tracking Reference Signal
PUCCH Physical Uplink Control CHannel
PUSCH Physical Uplink Shared CHannel
QAM Quadrature Amplitude Modulation
QCLed Quasi-Co-Located
QCL Quasi-Co-Location
QFI Quality of Service Indicator
QoS Quality of Service
QPSK Quadrature Phase Shift Keying
RA Random Access
RACH Random Access CHannel
RAN Radio Access Network
RAT Radio Access Technology
RA-RNTI Random Access-Radio Network Temporary Identifier
RB Resource Blocks
RBG Resource Block Groups
RI Rank indicator
RLC Radio Link Control
RRC Radio Resource Control
RS Reference Signal
RSRP Reference Signal Received Power
SCC Secondary Component Carrier
SCell Secondary Cell
SCG Secondary Cell Group
SC-FDMA Single Carrier-Frequency Division Multiple Access
SDAP Service Data Adaptation Protocol
SDU Service Data Unit
SeNB Secondary evolved Node B
SFN System Frame Number
S-GW Serving GateWay
SI System Information
SIB System Information Block
SINR Signal-to-Interference-plus-Noise Ratio
SMF Session Management Function
SN Secondary Node
SpCell Special Cell
SR Scheduling Request
SRB Signaling Radio Bearer
SRS Sounding Reference Signal
SS Synchronization Signal
SSB Synchronization Signal Block
SSS Secondary Synchronization Signal
sTAG secondary Timing Advance Group
TA Timing Advance
TAG Timing Advance Group
TAI Tracking Area Identifier
TAT Time Alignment Timer
TB Transport Block
TC-RNTI Temporary Cell-Radio Network Temporary Identifier
TCI Transmission Configuration Indication
TDD Time Division Duplex
TDMA Time Division Multiple Access
TRP Transmission and Receiving Point
TTI Transmission Time Interval
UCI Uplink Control Information
UE User Equipment
UL Uplink
UL-SCH Uplink Shared CHannel
UPF User Plane Function
UPGW User Plane Gateway
VHDL VHSIC Hardware Description Language
Xn-C Xn-Control plane
Xn-U Xn-User plane

Examples described herein may be implemented using various physical layer modulation and transmission mechanisms. Example transmission mechanisms may include, but are not limited to: Code Division Multiple Access (CDMA), Orthogonal Frequency Division Multiple Access (OFDMA), Time Division Multiple Access (TDMA), Wavelet technologies, and/or the like. Hybrid transmission mechanisms such as TDMA/CDMA, and/or OFDM/CDMA may be used. Various modulation schemes may be used for signal transmission in the physical layer. Examples of modulation schemes include, but are not limited to: phase, amplitude, code, a combination of these, and/or the like. An example radio transmission method may implement Quadrature Amplitude Modulation (QAM) using Binary Phase Shift Keying (BPSK), Quadrature Phase Shift Keying (QPSK), 16-QAM, 64-QAM, 256-QAM, 1024-QAM and/or the like. Physical radio transmission may be enhanced by dynamically or semi-dynamically changing the modulation and coding scheme, for example, depending on transmission requirements and/or radio conditions.

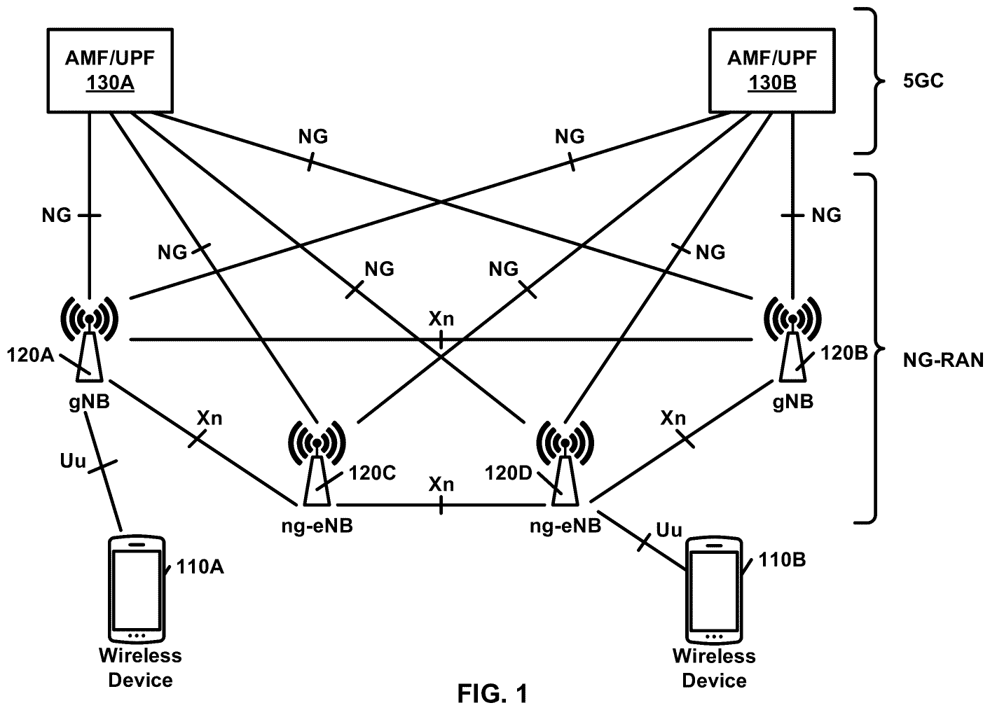

FIG. 1 shows an example Radio Access Network (RAN) architecture. A RAN node may comprise a next generation Node B (gNB) (e.g., 120A, 120B) providing New Radio (NR) user plane and control plane protocol terminations towards a first wireless device (e.g., 110A). A RAN node may comprise a base station such as a next generation evolved Node B (ng-eNB) (e.g., 120C, 120D), providing Evolved UMTS Terrestrial Radio Access (E-UTRA) user plane and control plane protocol terminations towards a second wireless device (e.g., 110B). A first wireless device 110A may communicate with a base station, such as a gNB 120A, over a Uu interface. A second wireless device 110B may communicate with a base station, such as an ng-eNB 120D, over a Uu interface. The wireless devices 110A and/or 110B may be structurally similar to wireless devices shown in and/or described in connection with other drawing figures. The Node B 120A, the Node B 120B, the Node B 120C, and/or the Node B 120D may be structurally similar to Nodes B and/or base stations shown in and/or described in connection with other drawing figures.

A base station, such as a gNB (e.g., 120A, 120B, etc.) and/or an ng-eNB (e.g., 120C, 120D, etc.) may host functions such as radio resource management and scheduling, IP header compression, encryption and integrity protection of data, selection of Access and Mobility Management Function (AMF) at wireless device (e.g., User Equipment (UE)) attachment, routing of user plane and control plane data, connection setup and release, scheduling and transmission of paging messages (e.g., originated from the AMF), scheduling and transmission of system broadcast information (e.g., originated from the AMF or Operation and Maintenance (O&M)), measurement and measurement reporting configuration, transport level packet marking in the uplink, session management, support of network slicing, Quality of Service (QoS) flow management and mapping to data radio bearers, support of wireless devices in an inactive state (e.g., RRC_INACTIVE state), distribution function for Non-Access Stratum (NAS) messages, RAN sharing, dual connectivity, and/or tight interworking between NR and E-UTRA.

One or more first base stations (e.g., gNBs 120A and 120B) and/or one or more second base stations (e.g., ng-eNBs 120C and 120D) may be interconnected with each other via Xn interface. A first base station (e.g., gNB 120A, 120B, etc.) or a second base station (e.g., ng-eNB 120C, 120D, etc.) may be connected via NG interfaces to a network, such as a 5G Core Network (5GC). A 5GC may comprise one or more AMF/User Plan Function (UPF) functions (e.g., 130A and/or 130B). A base station (e.g., a gNB and/or an ng-eNB) may be connected to a UPF via an NG-User plane (NG-U) interface. The NG-U interface may provide delivery (e.g., non-guaranteed delivery) of user plane Protocol Data Units (PDUs) between a RAN node and the UPF. A base station (e.g., a gNB and/or an ng-eNB) may be connected to an AMF via an NG-Control plane (NG-C) interface. The NG-C interface may provide functions such as NG interface management, wireless device (e.g., UE) context management, wireless device (e.g., UE) mobility management, transport of NAS messages, paging, PDU session management, configuration transfer, and/or warning message transmission.

A UPF may host functions such as anchor point for intra-/inter-Radio Access Technology (RAT) mobility (e.g., if applicable), external PDU session point of interconnect to data network, packet routing and forwarding, packet inspection and user plane part of policy rule enforcement, traffic usage reporting, uplink classifier to support routing traffic flows to a data network, branching point to support multi-homed PDU session, quality of service (QoS) handling for user plane, packet filtering, gating, Uplink (UL)/Downlink (DL) rate enforcement, uplink traffic verification (e.g., Service Data Flow (SDF) to QoS flow mapping), downlink packet buffering, and/or downlink data notification triggering.

An AMF may host functions such as NAS signaling termination, NAS signaling security, Access Stratum (AS) security control, inter Core Network (CN) node signaling (e.g., for mobility between 3rd Generation Partnership Project (3GPP) access networks), idle mode wireless device reachability (e.g., control and execution of paging retransmission), registration area management, support of intra-system and inter-system mobility, access authentication, access authorization including check of roaming rights, mobility management control (e.g., subscription and/or policies), support of network slicing, and/or Session Management Function (SMF) selection.

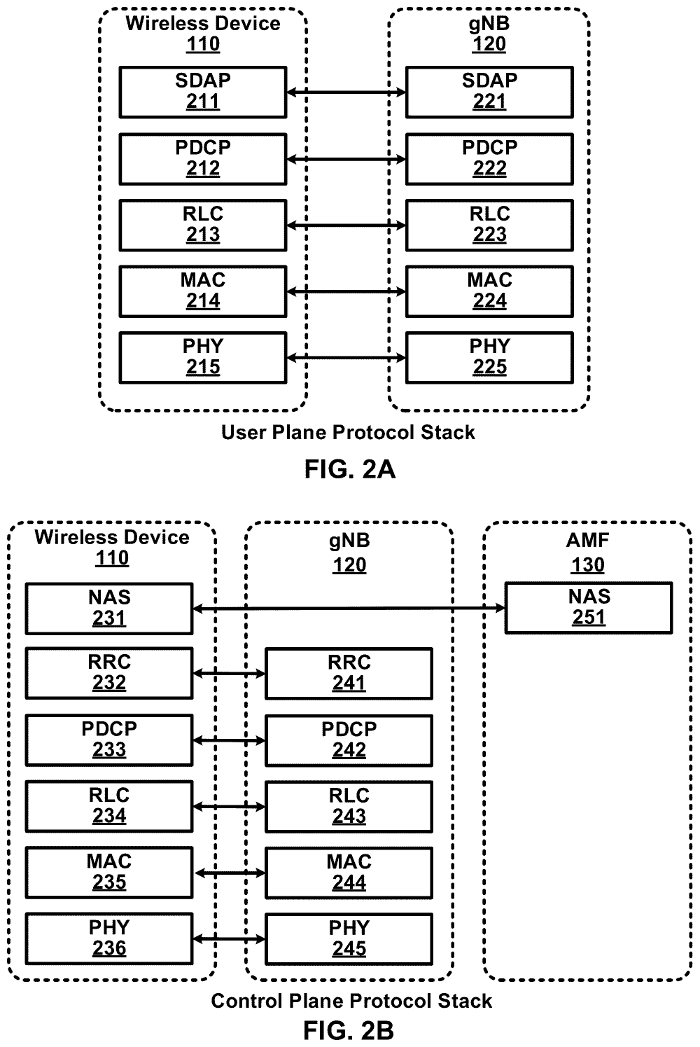

FIG. 2A shows an example user plane protocol stack. A Service Data Adaptation Protocol (SDAP) (e.g., 211 and 221), Packet Data Convergence Protocol (PDCP) (e.g., 212 and 222), Radio Link Control (RLC) (e.g., 213 and 223), and Media Access Control (MAC) (e.g., 214 and 224) sublayers, and a Physical (PHY) (e.g., 215 and 225) layer, may be terminated in a wireless device (e.g., 110) and in a base station (e.g., 120) on a network side. A PHY layer may provide transport services to higher layers (e.g., MAC, RRC, etc.). Services and/or functions of a MAC sublayer may comprise mapping between logical channels and transport channels, multiplexing and/or demultiplexing of MAC Service Data Units (SDUs) belonging to the same or different logical channels into and/or from Transport Blocks (TBs) delivered to and/or from the PHY layer, scheduling information reporting, error correction through Hybrid Automatic Repeat request (HARQ) (e.g., one HARQ entity per carrier for Carrier Aggregation (CA)), priority handling between wireless devices such as by using dynamic scheduling, priority handling between logical channels of a wireless device such as by using logical channel prioritization, and/or padding. A MAC entity may support one or multiple numerologies and/or transmission timings. Mapping restrictions in a logical channel prioritization may control which numerology and/or transmission timing a logical channel may use. An RLC sublayer may support transparent mode (TM), unacknowledged mode (UM), and/or acknowledged mode (AM) transmission modes. The RLC configuration may be per logical channel with no dependency on numerologies and/or Transmission Time Interval (TTI) durations. Automatic Repeat Request (ARQ) may operate on any of the numerologies and/or TTI durations with which the logical channel is configured. Services and functions of the PDCP layer for the user plane may comprise, for example, sequence numbering, header compression and decompression, transfer of user data, reordering and duplicate detection, PDCP PDU routing (e.g., such as for split bearers), retransmission of PDCP SDUs, ciphering, deciphering and integrity protection, PDCP SDU discard, PDCP re-establishment and data recovery for RLC AM, and/or duplication of PDCP PDUs. Services and/or functions of SDAP may comprise, for example, mapping between a QoS flow and a data radio bearer. Services and/or functions of SDAP may comprise mapping a Quality of Service Indicator (QFI) in DL and UL packets. A protocol entity of SDAP may be configured for an individual PDU session.

FIG. 2B shows an example control plane protocol stack. A PDCP (e.g., 233 and 242), RLC (e.g., 234 and 243), and MAC (e.g., 235 and 244) sublayers, and a PHY (e.g., 236 and 245) layer, may be terminated in a wireless device (e.g., 110), and in a base station (e.g., 120) on a network side, and perform service and/or functions described above. RRC (e.g., 232 and 241) may be terminated in a wireless device and a base station on a network side. Services and/or functions of RRC may comprise broadcast of system information related to AS and/or NAS; paging (e.g., initiated by a 5GC or a RAN); establishment, maintenance, and/or release of an RRC connection between the wireless device and RAN; security functions such as key management, establishment, configuration, maintenance, and/or release of Signaling Radio Bearers (SRBs) and Data Radio Bearers (DRBs); mobility functions; QoS management functions; wireless device measurement reporting and control of the reporting; detection of and recovery from radio link failure; and/or NAS message transfer to/from NAS from/to a wireless device. NAS control protocol (e.g., 231 and 251) may be terminated in the wireless device and AMF (e.g., 130) on a network side. NAS control protocol may perform functions such as authentication, mobility management between a wireless device and an AMF (e.g., for 3GPP access and non-3GPP access), and/or session management between a wireless device and an SMF (e.g., for 3GPP access and non-3GPP access).

A base station may configure a plurality of logical channels for a wireless device. A logical channel of the plurality of logical channels may correspond to a radio bearer. The radio bearer may be associated with a QoS requirement. A base station may configure a logical channel to be mapped to one or more TTIs and/or numerologies in a plurality of TTIs and/or numerologies. The wireless device may receive Downlink Control Information (DCI) via a Physical Downlink Control CHannel (PDCCH) indicating an uplink grant. The uplink grant may be for a first TTI and/or a first numerology and may indicate uplink resources for transmission of a transport block. The base station may configure each logical channel in the plurality of logical channels with one or more parameters to be used by a logical channel prioritization procedure at the MAC layer of the wireless device. The one or more parameters may comprise, for example, priority, prioritized bit rate, etc. A logical channel in the plurality of logical channels may correspond to one or more buffers comprising data associated with the logical channel. The logical channel prioritization procedure may allocate the uplink resources to one or more first logical channels in the plurality of logical channels and/or to one or more MAC Control Elements (CEs). The one or more first logical channels may be mapped to the first TTI and/or the first numerology. The MAC layer at the wireless device may multiplex one or more MAC CEs and/or one or more MAC SDUs (e.g., logical channel) in a MAC PDU (e.g., transport block). The MAC PDU may comprise a MAC header comprising a plurality of MAC sub-headers. A MAC sub-header in the plurality of MAC sub-headers may correspond to a MAC CE or a MAC SUD (e.g., logical channel) in the one or more MAC CEs and/or in the one or more MAC SDUs. A MAC CE and/or a logical channel may be configured with a Logical Channel IDentifier (LCID). An LCID for a logical channel and/or a MAC CE may be fixed and/or pre-configured. An LCID for a logical channel and/or MAC CE may be configured for the wireless device by the base station. The MAC sub-header corresponding to a MAC CE and/or a MAC SDU may comprise an LCID associated with the MAC CE and/or the MAC SDU.

A base station may activate, deactivate, and/or impact one or more processes (e.g., set values of one or more parameters of the one or more processes or start and/or stop one or more timers of the one or more processes) at the wireless device, for example, by using one or more MAC commands. The one or more MAC commands may comprise one or more MAC control elements. The one or more processes may comprise activation and/or deactivation of PDCP packet duplication for one or more radio bearers. The base station may send (e.g., transmit) a MAC CE comprising one or more fields. The values of the fields may indicate activation and/or deactivation of PDCP duplication for the one or more radio bearers. The one or more processes may comprise Channel State Information (CSI) transmission of on one or more cells. The base station may send (e.g., transmit) one or more MAC CEs indicating activation and/or deactivation of the CSI transmission on the one or more cells. The one or more processes may comprise activation and/or deactivation of one or more secondary cells. The base station may send (e.g., transmit) a MAC CE indicating activation and/or deactivation of one or more secondary cells. The base station may send (e.g., transmit) one or more MAC CEs indicating starting and/or stopping of one or more Discontinuous Reception (DRX) timers at the wireless device. The base station may send (e.g., transmit) one or more MAC CEs that indicate one or more timing advance values for one or more Timing Advance Groups (TAGs).

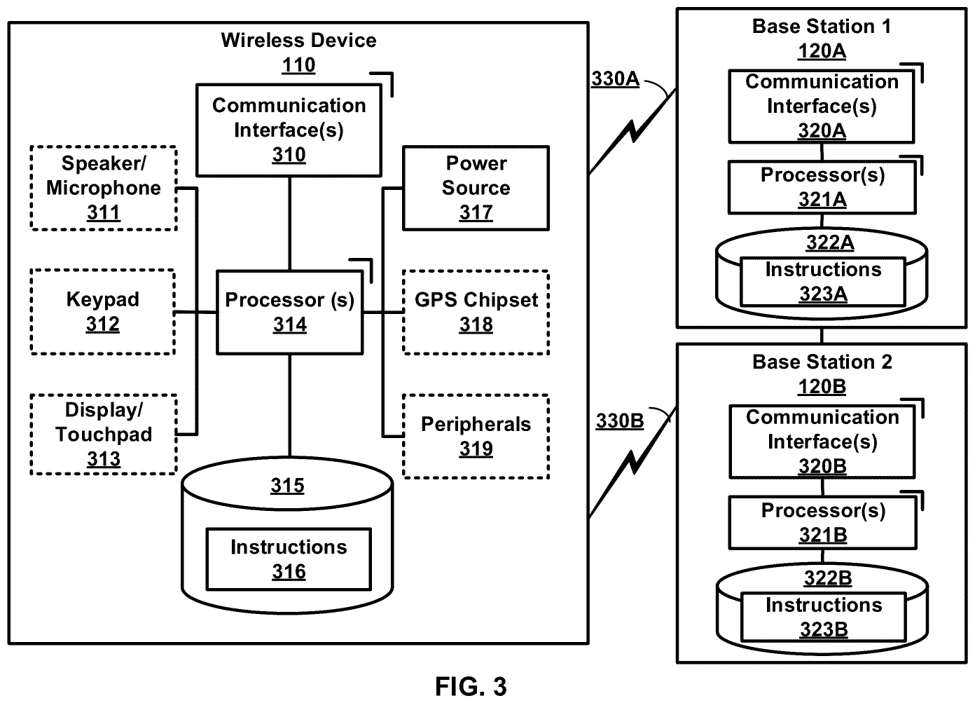

FIG. 3 shows an example of base stations (base station 1, 120A, and base station 2, 120B) and a wireless device 110. The wireless device 110 may comprise a UE or any other wireless device. The base station (e.g., 120A, 120B) may comprise a Node B, eNB, gNB, ng-eNB, or any other base station. A wireless device and/or a base station may perform one or more functions of a relay node. The base station 1, 120A, may comprise at least one communication interface 320A (e.g., a wireless modem, an antenna, a wired modem, and/or the like), at least one processor 321A, and at least one set of program code instructions 323A that may be stored in non-transitory memory 322A and executable by the at least one processor 321A. The base station 2, 120B, may comprise at least one communication interface 320B, at least one processor 321B, and at least one set of program code instructions 323B that may be stored in non-transitory memory 322B and executable by the at least one processor 321B.

A base station may comprise any number of sectors, for example: 1, 2, 3, 4, or 6 sectors. A base station may comprise any number of cells, for example, ranging from 1 to 50 cells or more. A cell may be categorized, for example, as a primary cell or secondary cell. At Radio Resource Control (RRC) connection establishment, re-establishment, handover, etc., a serving cell may provide NAS (non-access stratum) mobility information (e.g., Tracking Area Identifier (TAI)). At RRC connection re-establishment and/or handover, a serving cell may provide security input. This serving cell may be referred to as the Primary Cell (PCell). In the downlink, a carrier corresponding to the PCell may be a DL Primary Component Carrier (PCC). In the uplink, a carrier may be an UL PCC. Secondary Cells (SCells) may be configured to form together with a PCell a set of serving cells, for example, depending on wireless device capabilities. In a downlink, a carrier corresponding to an SCell may be a downlink secondary component carrier (DL SCC). In an uplink, a carrier may be an uplink secondary component carrier (UL SCC). An SCell may or may not have an uplink carrier.

A cell, comprising a downlink carrier and optionally an uplink carrier, may be assigned a physical cell ID and/or a cell index. A carrier (downlink and/or uplink) may belong to one cell. The cell ID and/or cell index may identify the downlink carrier and/or uplink carrier of the cell (e.g., depending on the context it is used). A cell ID may be equally referred to as a carrier ID, and a cell index may be referred to as a carrier index. A physical cell ID and/or a cell index may be assigned to a cell. A cell ID may be determined using a synchronization signal transmitted via a downlink carrier. A cell index may be determined using RRC messages. A first physical cell ID for a first downlink carrier may indicate that the first physical cell ID is for a cell comprising the first downlink carrier. The same concept may be used, for example, with carrier activation and/or deactivation (e.g., secondary cell activation and/or deactivation). A first carrier that is activated may indicate that a cell comprising the first carrier is activated.

A base station may send (e.g., transmit) to a wireless device one or more messages (e.g., RRC messages) comprising a plurality of configuration parameters for one or more cells. One or more cells may comprise at least one primary cell and at least one secondary cell. An RRC message may be broadcasted and/or unicasted to the wireless device. Configuration parameters may comprise common parameters and dedicated parameters.

Services and/or functions of an RRC sublayer may comprise at least one of: broadcast of system information related to AS and/or NAS; paging initiated by a 5GC and/or an NG-RAN; establishment, maintenance, and/or release of an RRC connection between a wireless device and an NG-RAN, which may comprise at least one of addition, modification, and/or release of carrier aggregation; and/or addition, modification, and/or release of dual connectivity in NR or between E-UTRA and NR. Services and/or functions of an RRC sublayer may comprise at least one of security functions comprising key management; establishment, configuration, maintenance, and/or release of Signaling Radio Bearers (SRBs) and/or Data Radio Bearers (DRBs); mobility functions which may comprise at least one of a handover (e.g., intra NR mobility or inter-RAT mobility) and/or a context transfer; and/or a wireless device cell selection and/or reselection and/or control of cell selection and reselection. Services and/or functions of an RRC sublayer may comprise at least one of QoS management functions; a wireless device measurement configuration/reporting; detection of and/or recovery from radio link failure; and/or NAS message transfer to and/or from a core network entity (e.g., AMF, Mobility Management Entity (MME)) from and/or to the wireless device.

An RRC sublayer may support an RRC_Idle state, an RRC_Inactive state, and/or an RRC_Connected state for a wireless device. In an RRC_Idle state, a wireless device may perform at least one of: Public Land Mobile Network (PLMN) selection; receiving broadcasted system information; cell selection and/or re-selection; monitoring and/or receiving a paging for mobile terminated data initiated by 5GC; paging for mobile terminated data area managed by 5GC; and/or DRX for CN paging configured via NAS. In an RRC_Inactive state, a wireless device may perform at least one of: receiving broadcasted system information; cell selection and/or re-selection; monitoring and/or receiving a RAN and/or CN paging initiated by an NG-RAN and/or a 5GC; RAN-based notification area (RNA) managed by an NG-RAN; and/or DRX for a RAN and/or CN paging configured by NG-RAN/NAS. In an RRC_Idle state of a wireless device, a base station (e.g., NG-RAN) may keep a 5GC-NG-RAN connection (e.g., both C/U-planes) for the wireless device; and/or store a wireless device AS context for the wireless device. In an RRC_Connected state of a wireless device, a base station (e.g., NG-RAN) may perform at least one of: establishment of 5GC-NG-RAN connection (both C/U-planes) for the wireless device; storing a UE AS context for the wireless device; send (e.g., transmit) and/or receive of unicast data to and/or from the wireless device; and/or network-controlled mobility based on measurement results received from the wireless device. In an RRC_Connected state of a wireless device, an NG-RAN may know a cell to which the wireless device belongs.

System information (SI) may be divided into minimum SI and other SI. The minimum SI may be periodically broadcast. The minimum SI may comprise basic information required for initial access and/or information for acquiring any other SI broadcast periodically and/or provisioned on-demand (e.g., scheduling information). The other SI may either be broadcast, and/or be provisioned in a dedicated manner, such as either triggered by a network and/or upon request from a wireless device. A minimum SI may be transmitted via two different downlink channels using different messages (e.g., MasterlnformationBlock and SystemInformationBlockType1). Another SI may be transmitted via SystemInformationBlockType2. For a wireless device in an RRC_Connected state, dedicated RRC signaling may be used for the request and delivery of the other SI. For the wireless device in the RRC_Idle state and/or in the RRC_Inactive state, the request may trigger a random access procedure.

A wireless device may report its radio access capability information, which may be static. A base station may request one or more indications of capabilities for a wireless device to report based on band information. A temporary capability restriction request may be sent by the wireless device (e.g., if allowed by a network) to signal the limited availability of some capabilities (e.g., due to hardware sharing, interference, and/or overheating) to the base station. The base station may confirm or reject the request. The temporary capability restriction may be transparent to 5GC (e.g., static capabilities may be stored in 5GC).

A wireless device may have an RRC connection with a network, for example, if CA is configured. At RRC connection establishment, re-establishment, and/or handover procedures, a serving cell may provide NAS mobility information. At RRC connection re-establishment and/or handover, a serving cell may provide a security input. This serving cell may be referred to as the PCell. SCells may be configured to form together with the PCell a set of serving cells, for example, depending on the capabilities of the wireless device. The configured set of serving cells for the wireless device may comprise a PCell and one or more SCells.

The reconfiguration, addition, and/or removal of SCells may be performed by RRC messaging. At intra-NR handover, RRC may add, remove, and/or reconfigure SCells for usage with the target PCell. Dedicated RRC signaling may be used (e.g., if adding a new SCell) to send all required system information of the SCell (e.g., if in connected mode, wireless devices may not acquire broadcasted system information directly from the SCells).

The purpose of an RRC connection reconfiguration procedure may be to modify an RRC connection, (e.g., to establish, modify, and/or release RBs; to perform handover; to setup, modify, and/or release measurements, for example, to add, modify, and/or release SCells and cell groups). NAS dedicated information may be transferred from the network to the wireless device, for example, as part of the RRC connection reconfiguration procedure. The RRCConnectionReconfiguration message may be a command to modify an RRC connection. One or more RRC messages may convey information for measurement configuration, mobility control, and/or radio resource configuration (e.g., RBs, MAC main configuration, and/or physical channel configuration), which may comprise any associated dedicated NAS information and/or security configuration. The wireless device may perform an SCell release, for example, if the received RRC Connection Reconfiguration message includes the sCellToReleaseList. The wireless device may perform SCell additions or modification, for example, if the received RRC Connection Reconfiguration message includes the sCellToAddModList.

An RRC connection establishment, reestablishment, and/or resume procedure may be to establish, reestablish, and/or resume an RRC connection, respectively. An RRC connection establishment procedure may comprise SRB1 establishment. The RRC connection establishment procedure may be used to transfer the initial NAS dedicated information and/or message from a wireless device to an E-UTRAN. The RRCConnectionReestablishment message may be used to re-establish SRB1.

A measurement report procedure may be used to transfer measurement results from a wireless device to an NG-RAN. The wireless device may initiate a measurement report procedure, for example, after successful security activation. A measurement report message may be used to send (e.g., transmit) measurement results.

The wireless device 110 may comprise at least one communication interface 310 (e.g., a wireless modem, an antenna, and/or the like), at least one processor 314, and at least one set of program code instructions 316 that may be stored in non-transitory memory 315 and executable by the at least one processor 314. The wireless device 110 may further comprise at least one of at least one speaker and/or microphone 311, at least one keypad 312, at least one display and/or touchpad 313, at least one power source 317, at least one global positioning system (GPS) chipset 318, and/or other peripherals 319.

The processor 314 of the wireless device 110, the processor 321A of the base station 1 120A, and/or the processor 321B of the base station 2 120B may comprise at least one of a general-purpose processor, a digital signal processor (DSP), a controller, a microcontroller, an application specific integrated circuit (ASIC), a field programmable gate array (FPGA) and/or other programmable logic device, discrete gate and/or transistor logic, discrete hardware components, and/or the like. The processor 314 of the wireless device 110, the processor 321A in base station 1 120A, and/or the processor 321B in base station 2 120B may perform at least one of signal coding and/or processing, data processing, power control, input/output processing, and/or any other functionality that may enable the wireless device 110, the base station 1 120A and/or the base station 2 120B to operate in a wireless environment.

The processor 314 of the wireless device 110 may be connected to and/or in communication with the speaker and/or microphone 311, the keypad 312, and/or the display and/or touchpad 313. The processor 314 may receive user input data from and/or provide user output data to the speaker and/or microphone 311, the keypad 312, and/or the display and/or touchpad 313. The processor 314 in the wireless device 110 may receive power from the power source 317 and/or may be configured to distribute the power to the other components in the wireless device 110. The power source 317 may comprise at least one of one or more dry cell batteries, solar cells, fuel cells, and/or the like. The processor 314 may be connected to the GPS chipset 318. The GPS chipset 318 may be configured to provide geographic location information of the wireless device 110.

The processor 314 of the wireless device 110 may further be connected to and/or in communication with other peripherals 319, which may comprise one or more software and/or hardware modules that may provide additional features and/or functionalities. For example, the peripherals 319 may comprise at least one of an accelerometer, a satellite transceiver, a digital camera, a universal serial bus (USB) port, a hands-free headset, a frequency modulated (FM) radio unit, a media player, an Internet browser, and/or the like.

The communication interface 320A of the base station 1, 120A, and/or the communication interface 320B of the base station 2, 120B, may be configured to communicate with the communication interface 310 of the wireless device 110, for example, via a wireless link 330A and/or via a wireless link 330B, respectively. The communication interface 320A of the base station 1, 120A, may communicate with the communication interface 320B of the base station 2, 120B and/or other RAN and/or core network nodes.

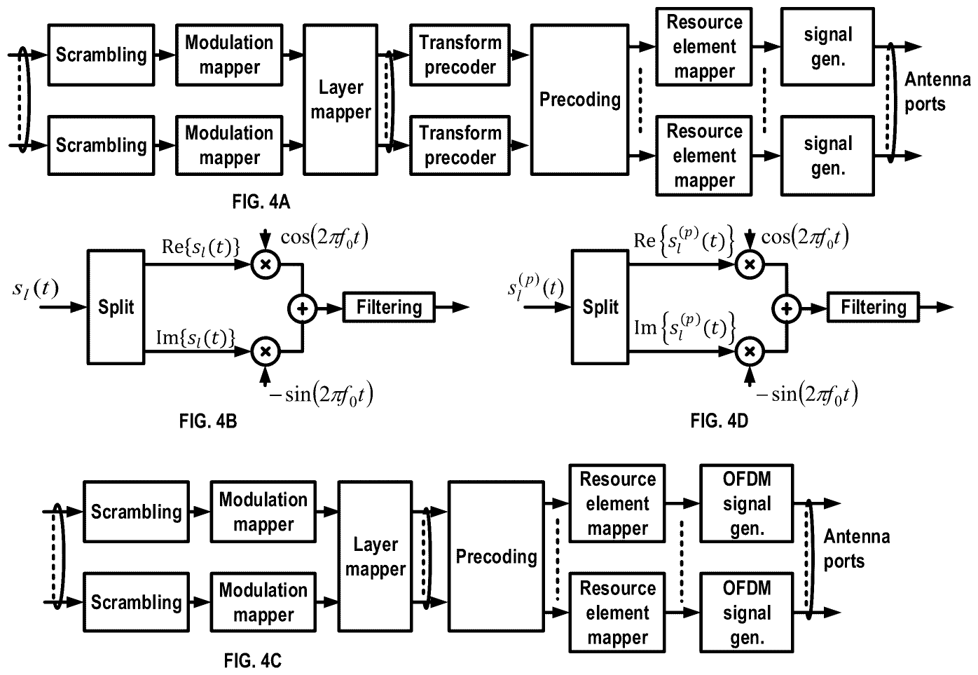

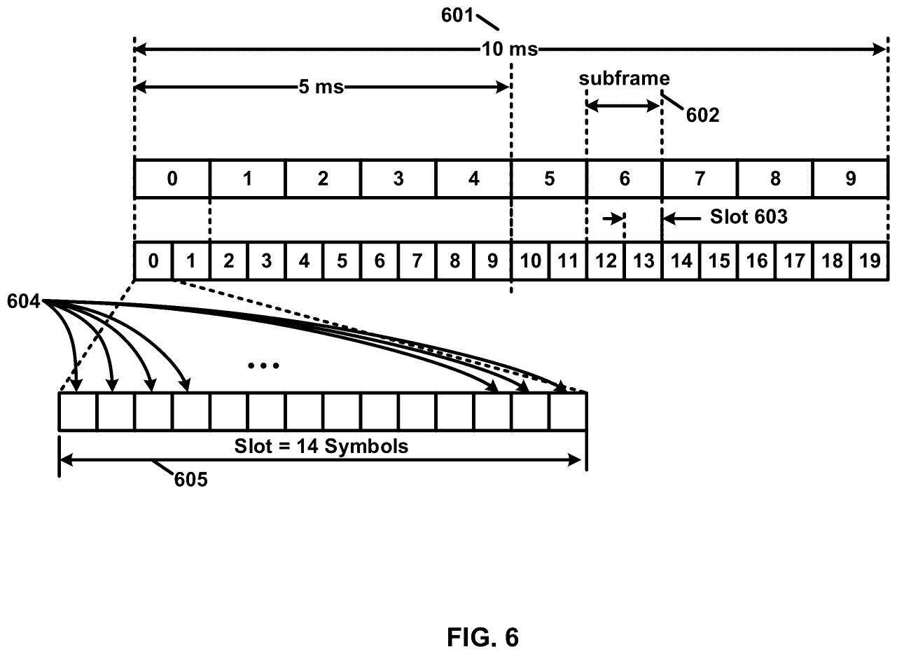

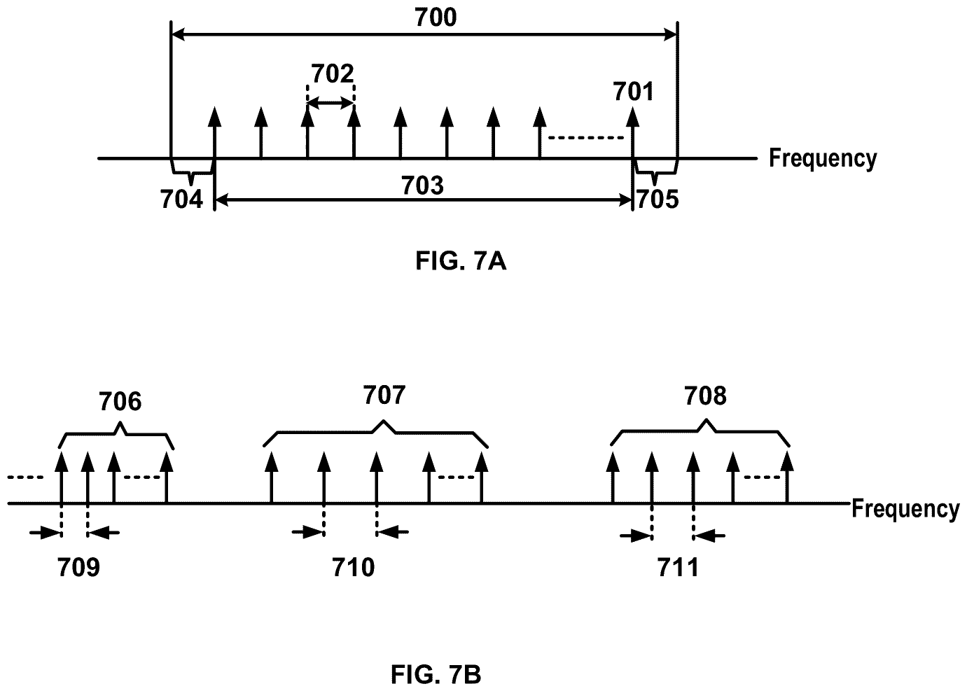

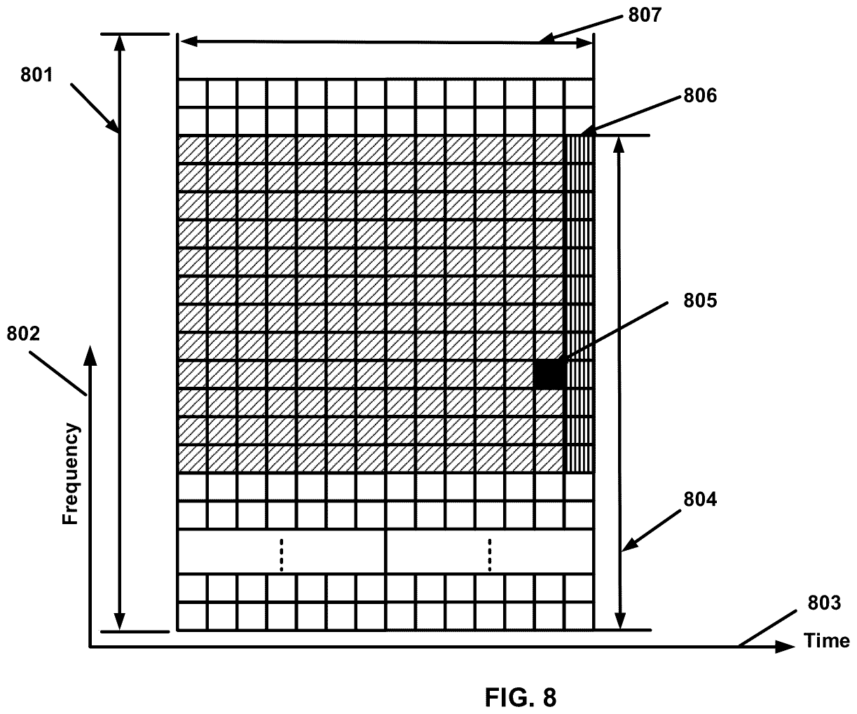

The wireless link 330A and/or the wireless link 330B may comprise at least one of a bi-directional link and/or a directional link. The communication interface 310 of the wireless device 110 may be configured to communicate with the communication interface 320A of the base station 1 120A and/or with the communication interface 320B of the base station 2 120B. The base station 1 120A and the wireless device 110, and/or the base station 2 120B and the wireless device 110, may be configured to send and receive transport blocks, for example, via the wireless link 330A and/or via the wireless link 330B, respectively. The wireless link 330A and/or the wireless link 330B may use at least one frequency carrier. Transceiver(s) may be used. A transceiver may be a device that comprises both a transmitter and a receiver. Transceivers may be used in devices such as wireless devices, base stations, relay nodes, computing devices, and/or the like. Radio technology may be implemented in the communication interface 310, 320A, and/or 320B, and the wireless link 330A and/or 330B. The radio technology may comprise one or more elements shown in FIG. 4A, FIG. 4B, FIG. 4C, FIG. 4D, FIG. 6, FIG. 7A, FIG. 7B, FIG. 8, and associated text, described below.

Other nodes in a wireless network (e.g., AMF, UPF, SMF, etc.) may comprise one or more communication interfaces, one or more processors, and memory storing instructions. A node (e.g., wireless device, base station, AMF, SMF, UPF, servers, switches, antennas, and/or the like) may comprise one or more processors, and memory storing instructions that when executed by the one or more processors causes the node to perform certain processes and/or functions. Single-carrier and/or multi-carrier communication operation may be performed. A non-transitory tangible computer readable media may comprise instructions executable by one or more processors to cause operation of single-carrier and/or multi-carrier communications. An article of manufacture may comprise a non-transitory tangible computer readable machine-accessible medium having instructions encoded thereon for enabling programmable hardware to cause a node to enable operation of single-carrier and/or multi-carrier communications. The node may include processors, memory, interfaces, and/or the like.

An interface may comprise at least one of a hardware interface, a firmware interface, a software interface, and/or a combination thereof. The hardware interface may comprise connectors, wires, and/or electronic devices such as drivers, amplifiers, and/or the like. The software interface may comprise code stored in a memory device to implement protocol(s), protocol layers, communication drivers, device drivers, combinations thereof, and/or the like. The firmware interface may comprise a combination of embedded hardware and/or code stored in (and/or in communication with) a memory device to implement connections, electronic device operations, protocol(s), protocol layers, communication drivers, device drivers, hardware operations, combinations thereof, and/or the like.

A communication network may comprise the wireless device 110, the base station 1, 120A, the base station 2, 120B, and/or any other device. The communication network may comprise any number and/or type of devices, such as, for example, computing devices, wireless devices, mobile devices, handsets, tablets, laptops, internet of things (IoT) devices, hotspots, cellular repeaters, computing devices, and/or, more generally, user equipment (e.g., UE). Although one or more of the above types of devices may be referenced herein (e.g., UE, wireless device, computing device, etc.), it should be understood that any device herein may comprise any one or more of the above types of devices or similar devices. The communication network, and any other network referenced herein, may comprise an LTE network, a 5G network, or any other network for wireless communications. Apparatuses, systems, and/or methods described herein may generally be described as implemented on one or more devices (e.g., wireless device, base station, eNB, gNB, computing device, etc.), in one or more networks, but it will be understood that one or more features and steps may be implemented on any device and/or in any network. As used throughout, the term “base station” may comprise one or more of: a base station, a node, a Node B, a gNB, an eNB, an ng-eNB, a relay node (e.g., an integrated access and backhaul (IAB) node), a donor node (e.g., a donor eNB, a donor gNB, etc.), an access point (e.g., a WiFi access point), a computing device, a device capable of wirelessly communicating, or any other device capable of sending and/or receiving signals. As used throughout, the term “wireless device” may comprise one or more of: a UE, a handset, a mobile device, a computing device, a node, a device capable of wirelessly communicating, or any other device capable of sending and/or receiving signals. Any reference to one or more of these terms/devices also considers use of any other term/device mentioned above.

FIG. 4A, FIG. 4B, FIG. 4C and FIG. 4D show examples of uplink and downlink signal transmission. FIG. 4A shows an example uplink transmitter for at least one physical channel. A baseband signal representing a physical uplink shared channel may perform one or more functions. The one or more functions may comprise at least one of: scrambling (e.g., by Scrambling); modulation of scrambled bits to generate complex-valued symbols (e.g., by a Modulation mapper); mapping of the complex-valued modulation symbols onto one or several transmission layers (e.g., by a Layer mapper); transform precoding to generate complex-valued symbols (e.g., by a Transform precoder); precoding of the complex-valued symbols (e.g., by a Precoder); mapping of precoded complex-valued symbols to resource elements (e.g., by a Resource element mapper); generation of complex-valued time-domain Single Carrier-Frequency Division Multiple Access (SC-FDMA) or CP-OFDM signal for an antenna port (e.g., by a signal gen.); and/or the like. A SC-FDMA signal for uplink transmission may be generated, for example, if transform precoding is enabled. A CP-OFDM signal for uplink transmission may be generated by FIG. 4A, for example, if transform precoding is not enabled. These functions are shown as examples and other mechanisms may be implemented.

FIG. 4B shows an example of modulation and up-conversion to the carrier frequency of a complex-valued SC-FDMA or CP-OFDM baseband signal for an antenna port and/or for the complex-valued Physical Random Access CHannel (PRACH) baseband signal. Filtering may be performed prior to transmission.

FIG. 4C shows an example of downlink transmissions. The baseband signal representing a downlink physical channel may perform one or more functions. The one or more functions may comprise: scrambling of coded bits in a codeword to be transmitted on a physical channel (e.g., by Scrambling); modulation of scrambled bits to generate complex-valued modulation symbols (e.g., by a Modulation mapper); mapping of the complex-valued modulation symbols onto one or several transmission layers (e.g., by a Layer mapper); precoding of the complex-valued modulation symbols on a layer for transmission on the antenna ports (e.g., by Precoding); mapping of complex-valued modulation symbols for an antenna port to resource elements (e.g., by a Resource element mapper); generation of complex-valued time-domain OFDM signal for an antenna port (e.g., by an OFDM signal gen.); and/or the like. These functions are shown as examples and other mechanisms may be implemented.

A base station may send (e.g., transmit) a first symbol and a second symbol on an antenna port, to a wireless device. The wireless device may infer the channel (e.g., fading gain, multipath delay, etc.) for conveying the second symbol on the antenna port, from the channel for conveying the first symbol on the antenna port. A first antenna port and a second antenna port may be quasi co-located, for example, if one or more large-scale properties of the channel over which a first symbol on the first antenna port is conveyed may be inferred from the channel over which a second symbol on a second antenna port is conveyed. The one or more large-scale properties may comprise at least one of: delay spread; Doppler spread; Doppler shift; average gain; average delay; and/or spatial receiving (Rx) parameters.

FIG. 4D shows an example modulation and up-conversion to the carrier frequency of the complex-valued OFDM baseband signal for an antenna port. Filtering may be performed prior to transmission.

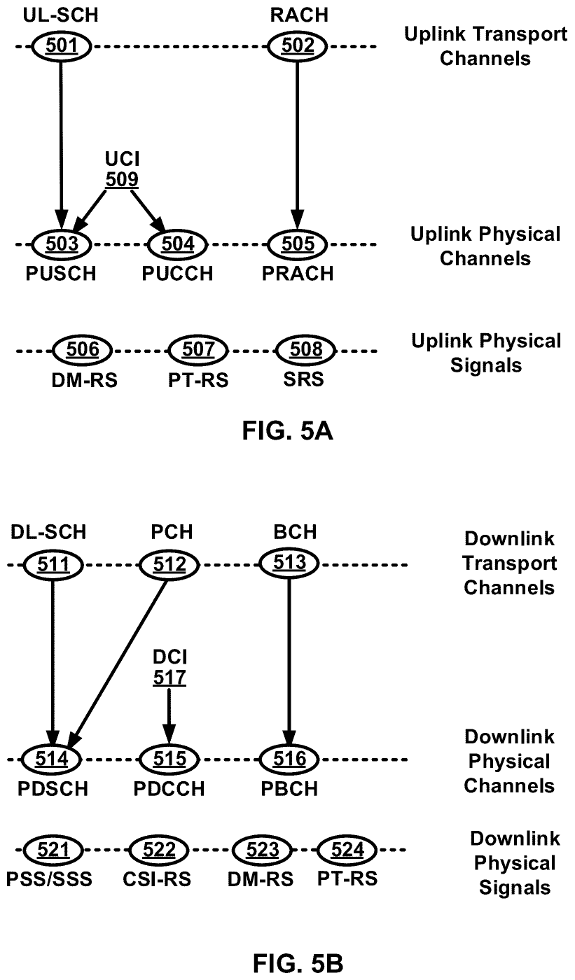

FIG. 5A shows example uplink channel mapping and example uplink physical signals. A physical layer may provide one or more information transfer services to a MAC and/or one or more higher layers. The physical layer may provide the one or more information transfer services to the MAC via one or more transport channels. An information transfer service may indicate how and/or with what characteristics data is transferred over the radio interface.

Uplink transport channels may comprise an Uplink-Shared CHannel (UL-SCH) 501 and/or a Random Access CHannel (RACH) 502. A wireless device may send (e.g., transmit) one or more uplink DM-RSs 506 to a base station for channel estimation, for example, for coherent demodulation of one or more uplink physical channels (e.g., PUSCH 503 and/or PUCCH 504). The wireless device may send (e.g., transmit) to a base station at least one uplink DM-RS 506 with PUSCH 503 and/or PUCCH 504, wherein the at least one uplink DM-RS 506 may be spanning a same frequency range as a corresponding physical channel. The base station may configure the wireless device with one or more uplink DM-RS configurations. At least one DM-RS configuration may support a front-loaded DM-RS pattern. A front-loaded DM-RS may be mapped over one or more OFDM symbols (e.g., 1 or 2 adjacent OFDM symbols). One or more additional uplink DM-RS may be configured to send (e.g., transmit) at one or more symbols of a PUSCH and/or PUCCH. The base station may semi-statically configure the wireless device with a maximum number of front-loaded DM-RS symbols for PUSCH and/or PUCCH. The wireless device may schedule a single-symbol DM-RS and/or double symbol DM-RS based on a maximum number of front-loaded DM-RS symbols, wherein the base station may configure the wireless device with one or more additional uplink DM-RS for PUSCH and/or PUCCH. A new radio network may support, for example, at least for CP-OFDM, a common DM-RS structure for DL and UL, wherein a DM-RS location, DM-RS pattern, and/or scrambling sequence may be same or different.

Whether or not an uplink PT-RS 507 is present may depend on an RRC configuration. A presence of the uplink PT-RS may be wireless device-specifically configured. A presence and/or a pattern of the uplink PT-RS 507 in a scheduled resource may be wireless device-specifically configured by a combination of RRC signaling and/or association with one or more parameters used for other purposes (e.g., Modulation and Coding Scheme (MCS)) which may be indicated by DCI. If configured, a dynamic presence of uplink PT-RS 507 may be associated with one or more DCI parameters comprising at least a MCS. A radio network may support a plurality of uplink PT-RS densities defined in time/frequency domain. If present, a frequency domain density may be associated with at least one configuration of a scheduled bandwidth. A wireless device may assume a same precoding for a DMRS port and a PT-RS port. A number of PT-RS ports may be less than a number of DM-RS ports in a scheduled resource. The uplink PT-RS 507 may be confined in the scheduled time/frequency duration for a wireless device.

A wireless device may send (e.g., transmit) an SRS 508 to a base station for channel state estimation, for example, to support uplink channel dependent scheduling and/or link adaptation. The SRS 508 sent (e.g., transmitted) by the wireless device may allow for the base station to estimate an uplink channel state at one or more different frequencies. A base station scheduler may use an uplink channel state to assign one or more resource blocks of a certain quality (e.g., above a quality threshold) for an uplink PUSCH transmission from the wireless device. The base station may semi-statically configure the wireless device with one or more SRS resource sets. For an SRS resource set, the base station may configure the wireless device with one or more SRS resources. An SRS resource set applicability may be configured by a higher layer (e.g., RRC) parameter. An SRS resource in each of one or more SRS resource sets may be sent (e.g., transmitted) at a time instant, for example, if a higher layer parameter indicates beam management. The wireless device may send (e.g., transmit) one or more SRS resources in different SRS resource sets simultaneously. A new radio network may support aperiodic, periodic, and/or semi-persistent SRS transmissions. The wireless device may send (e.g., transmit) SRS resources, for example, based on one or more trigger types. The one or more trigger types may comprise higher layer signaling (e.g., RRC) and/or one or more DCI formats (e.g., at least one DCI format may be used for a wireless device to select at least one of one or more configured SRS resource sets). An SRS trigger type 0 may refer to an SRS triggered based on a higher layer signaling. An SRS trigger type 1 may refer to an SRS triggered based on one or more DCI formats. The wireless device may be configured to send (e.g., transmit) the SRS 508 after a transmission of PUSCH 503 and corresponding uplink DM-RS 506, for example, if PUSCH 503 and the SRS 508 are transmitted in a same slot.

A base station may semi-statically configure a wireless device with one or more SRS configuration parameters indicating at least one of following: an SRS resource configuration identifier, a number of SRS ports, time domain behavior of SRS resource configuration (e.g., an indication of periodic, semi-persistent, or aperiodic SRS), slot (mini-slot, and/or subframe) level periodicity and/or offset for a periodic and/or aperiodic SRS resource, a number of OFDM symbols in a SRS resource, starting OFDM symbol of a SRS resource, an SRS bandwidth, a frequency hopping bandwidth, a cyclic shift, and/or an SRS sequence ID.

FIG. 5B shows an example downlink channel mapping and downlink physical signals. Downlink transport channels may comprise a Downlink-Shared CHannel (DL-SCH) 511, a Paging CHannel (PCH) 512, and/or a Broadcast CHannel (BCH) 513. A transport channel may be mapped to one or more corresponding physical channels. A UL-SCH 501 may be mapped to a Physical Uplink Shared CHannel (PUSCH) 503. A RACH 502 may be mapped to a PRACH 505. A DL-SCH 511 and a PCH 512 may be mapped to a Physical Downlink Shared CHannel (PDSCH) 514. A BCH 513 may be mapped to a Physical Broadcast CHannel (PBCH) 516.

A radio network may comprise one or more downlink and/or uplink transport channels. The radio network may comprise one or more physical channels without a corresponding transport channel. The one or more physical channels may be used for an Uplink Control Information (UCI) 509 and/or a Downlink Control Information (DCI) 517. A Physical Uplink Control CHannel (PUCCH) 504 may carry UCI 509 from a wireless device to a base station. A Physical Downlink Control CHannel (PDCCH) 515 may carry the DCI 517 from a base station to a wireless device. The radio network (e.g., NR) may support the UCI 509 multiplexing in the PUSCH 503, for example, if the UCI 509 and the PUSCH 503 transmissions may coincide in a slot (e.g., at least in part). The UCI 509 may comprise at least one of a CSI, an Acknowledgement (ACK)/Negative Acknowledgement (NACK), and/or a scheduling request. The DCI 517 via the PDCCH 515 may indicate at least one of following: one or more downlink assignments and/or one or more uplink scheduling grants.

In uplink, a wireless device may send (e.g., transmit) one or more Reference Signals (RSs) to a base station. The one or more RSs may comprise at least one of a Demodulation-RS (DM-RS) 506, a Phase Tracking-RS (PT-RS) 507, and/or a Sounding RS (SRS) 508. In downlink, a base station may send (e.g., transmit, unicast, multicast, and/or broadcast) one or more RSs to a wireless device. The one or more RSs may comprise at least one of a Primary Synchronization Signal (PSS)/Secondary Synchronization Signal (SSS) 521, a CSI-RS 522, a DM-RS 523, and/or a PT-RS 524.

In a time domain, an SS/PBCH block may comprise one or more OFDM symbols (e.g., 4 OFDM symbols numbered in increasing order from 0 to 3) within the SS/PBCH block. An SS/PBCH block may comprise the PSS/SSS 521 and/or the PBCH 516. In the frequency domain, an SS/PBCH block may comprise one or more contiguous subcarriers (e.g., 240 contiguous subcarriers with the subcarriers numbered in increasing order from 0 to 239) within the SS/PBCH block. The PSS/SSS 521 may occupy, for example, 1 OFDM symbol and 127 subcarriers. The PBCH 516 may span across, for example, 3 OFDM symbols and 240 subcarriers. A wireless device may assume that one or more SS/PBCH blocks transmitted with a same block index may be quasi co-located, for example, with respect to Doppler spread, Doppler shift, average gain, average delay, and/or spatial Rx parameters. A wireless device may not assume quasi co-location for other SS/PBCH block transmissions. A periodicity of an SS/PBCH block may be configured by a radio network (e.g., by an RRC signaling). One or more time locations in which the SS/PBCH block may be sent may be determined by sub-carrier spacing. A wireless device may assume a band-specific sub-carrier spacing for an SS/PBCH block, for example, unless a radio network has configured the wireless device to assume a different sub-carrier spacing.

The downlink CSI-RS 522 may be used for a wireless device to acquire channel state information. A radio network may support periodic, aperiodic, and/or semi-persistent transmission of the downlink CSI-RS 522. A base station may semi-statically configure and/or reconfigure a wireless device with periodic transmission of the downlink CSI-RS 522. A configured CSI-RS resources may be activated and/or deactivated. For semi-persistent transmission, an activation and/or deactivation of a CSI-RS resource may be triggered dynamically. A CSI-RS configuration may comprise one or more parameters indicating at least a number of antenna ports. A base station may configure a wireless device with 32 ports, or any other number of ports. A base station may semi-statically configure a wireless device with one or more CSI-RS resource sets. One or more CSI-RS resources may be allocated from one or more CSI-RS resource sets to one or more wireless devices. A base station may semi-statically configure one or more parameters indicating CSI RS resource mapping, for example, time-domain location of one or more CSI-RS resources, a bandwidth of a CSI-RS resource, and/or a periodicity. A wireless device may be configured to use the same OFDM symbols for the downlink CSI-RS 522 and the Control Resource Set (CORESET), for example, if the downlink CSI-RS 522 and the CORESET are spatially quasi co-located and resource elements associated with the downlink CSI-RS 522 are the outside of PRBs configured for the CORESET. A wireless device may be configured to use the same OFDM symbols for downlink CSI-RS 522 and SS/PBCH blocks, for example, if the downlink CSI-RS 522 and SS/PBCH blocks are spatially quasi co-located and resource elements associated with the downlink CSI-RS 522 are outside of the PRBs configured for the SS/PBCH blocks.

A wireless device may send (e.g., transmit) one or more downlink DM-RSs 523 to a base station for channel estimation, for example, for coherent demodulation of one or more downlink physical channels (e.g., PDSCH 514). A radio network may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., 1 or 2 adjacent OFDM symbols). A base station may semi-statically configure a wireless device with a maximum number of front-loaded DM-RS symbols for PDSCH 514. A DM-RS configuration may support one or more DM-RS ports. A DM-RS configuration may support at least 8 orthogonal downlink DM-RS ports, for example, for single user-MIMO. ADM-RS configuration may support 12 orthogonal downlink DM-RS ports, for example, for multiuser-MIMO. A radio network may support, for example, at least for CP-OFDM, a common DM-RS structure for DL and UL, wherein a DM-RS location, DM-RS pattern, and/or scrambling sequence may be the same or different.

Whether or not the downlink PT-RS 524 is present may depend on an RRC configuration. A presence of the downlink PT-RS 524 may be wireless device-specifically configured. A presence and/or a pattern of the downlink PT-RS 524 in a scheduled resource may be wireless device-specifically configured, for example, by a combination of RRC signaling and/or an association with one or more parameters used for other purposes (e.g., MCS) which may be indicated by the DCI. If configured, a dynamic presence of the downlink PT-RS 524 may be associated with one or more DCI parameters comprising at least MCS. A radio network may support a plurality of PT-RS densities in a time/frequency domain. If present, a frequency domain density may be associated with at least one configuration of a scheduled bandwidth. A wireless device may assume the same precoding for a DMRS port and a PT-RS port. A number of PT-RS ports may be less than a number of DM-RS ports in a scheduled resource. The downlink PT-RS 524 may be confined in the scheduled time/frequency duration for a wireless device.

FIG. 6 shows an example transmission time and reception time, as well as an example frame structure, for a carrier. A multicarrier OFDM communication system may include one or more carriers, for example, ranging from 1 to 32 carriers (such as for carrier aggregation) or ranging from 1 to 64 carriers (such as for dual connectivity). Different radio frame structures may be supported (e.g., for FDD and/or for TDD duplex mechanisms). FIG. 6 shows an example frame timing. Downlink and uplink transmissions may be organized into radio frames 601. Radio frame duration may be 10 milliseconds (ms). A 10 ms radio frame 601 may be divided into ten equally sized subframes 602, each with a 1 ms duration. Subframe(s) may comprise one or more slots (e.g., slots 603 and 605) depending on subcarrier spacing and/or CP length. For example, a subframe with 15 kHz, 30 kHz, 60 kHz, 120 kHz, 240 kHz and 480 kHz subcarrier spacing may comprise one, two, four, eight, sixteen and thirty-two slots, respectively. In FIG. 6, a subframe may be divided into two equally sized slots 603 with 0.5 ms duration. For example, 10 subframes may be available for downlink transmission and 10 subframes may be available for uplink transmissions in a 10 ms interval. Other subframe durations such as, for example, 0.5 ms, 1 ms, 2 ms, and 5 ms may be supported. Uplink and downlink transmissions may be separated in the frequency domain. Slot(s) may include a plurality of OFDM symbols 604. The number of OFDM symbols 604 in a slot 605 may depend on the cyclic prefix length. A slot may be 14 OFDM symbols for the same subcarrier spacing of up to 480 kHz with normal CP. A slot may be 12 OFDM symbols for the same subcarrier spacing of 60 kHz with extended CP. A slot may comprise downlink, uplink, and/or a downlink part and an uplink part, and/or alike.

FIG. 7A shows example sets of OFDM subcarriers. A base station may communicate with a wireless device using a carrier having an example channel bandwidth 700. Arrow(s) in the example may depict a subcarrier in a multicarrier OFDM system. The OFDM system may use technology such as OFDM technology, SC-FDMA technology, and/or the like. An arrow 701 shows a subcarrier transmitting information symbols. A subcarrier spacing 702, between two contiguous subcarriers in a carrier, may be any one of 15 kHz, 30 kHz, 60 kHz, 120 kHz, 240 kHz, or any other frequency. Different subcarrier spacing may correspond to different transmission numerologies. A transmission numerology may comprise at least: a numerology index; a value of subcarrier spacing; and/or a type of cyclic prefix (CP). A base station may send (e.g., transmit) to and/or receive from a wireless device via a number of subcarriers 703 in a carrier. A bandwidth occupied by a number of subcarriers 703 (e.g., transmission bandwidth) may be smaller than the channel bandwidth 700 of a carrier, for example, due to guard bands 704 and 705. Guard bands 704 and 705 may be used to reduce interference to and from one or more neighbor carriers. A number of subcarriers (e.g., transmission bandwidth) in a carrier may depend on the channel bandwidth of the carrier and/or the subcarrier spacing. A transmission bandwidth, for a carrier with a 20 MHz channel bandwidth and a 15 kHz subcarrier spacing, may be in number of 1024 subcarriers.

A base station and a wireless device may communicate with multiple component carriers (CCs), for example, if configured with CA. Different component carriers may have different bandwidth and/or different subcarrier spacing, for example, if CA is supported. A base station may send (e.g., transmit) a first type of service to a wireless device via a first component carrier. The base station may send (e.g., transmit) a second type of service to the wireless device via a second component carrier. Different types of services may have different service requirements (e.g., data rate, latency, reliability), which may be suitable for transmission via different component carriers having different subcarrier spacing and/or different bandwidth.

FIG. 7B shows examples of component carriers. A first component carrier may comprise a first number of subcarriers 706 having a first subcarrier spacing 709. A second component carrier may comprise a second number of subcarriers 707 having a second subcarrier spacing 710. A third component carrier may comprise a third number of subcarriers 708 having a third subcarrier spacing 711. Carriers in a multicarrier OFDM communication system may be contiguous carriers, non-contiguous carriers, or a combination of both contiguous and non-contiguous carriers.

FIG. 8 shows an example of OFDM radio resources. A carrier may have a transmission bandwidth 801. A resource grid may be in a structure of frequency domain 802 and time domain 803. A resource grid may comprise a first number of OFDM symbols in a subframe and a second number of resource blocks, starting from a common resource block indicated by higher-layer signaling (e.g., RRC signaling), for a transmission numerology and a carrier. In a resource grid, a resource element 805 may comprise a resource unit that may be identified by a subcarrier index and a symbol index. A subframe may comprise a first number of OFDM symbols 807 that may depend on a numerology associated with a carrier. A subframe may have 14 OFDM symbols for a carrier, for example, if a subcarrier spacing of a numerology of a carrier is 15 kHz. A subframe may have 28 OFDM symbols, for example, if a subcarrier spacing of a numerology is 30 kHz. A subframe may have 56 OFDM symbols, for example, if a subcarrier spacing of a numerology is 60 kHz. A subcarrier spacing of a numerology may comprise any other frequency. A second number of resource blocks comprised in a resource grid of a carrier may depend on a bandwidth and a numerology of the carrier.

A resource block 806 may comprise 12 subcarriers. Multiple resource blocks may be grouped into a Resource Block Group (RBG) 804. A size of a RBG may depend on at least one of: a RRC message indicating a RBG size configuration; a size of a carrier bandwidth; and/or a size of a bandwidth part of a carrier. A carrier may comprise multiple bandwidth parts. A first bandwidth part of a carrier may have a different frequency location and/or a different bandwidth from a second bandwidth part of the carrier.

A base station may send (e.g., transmit), to a wireless device, a downlink control information comprising a downlink or uplink resource block assignment. A base station may send (e.g., transmit) to and/or receive from, a wireless device, data packets (e.g., transport blocks). The data packets may be scheduled on and transmitted via one or more resource blocks and one or more slots indicated by parameters in downlink control information and/or RRC message(s). A starting symbol relative to a first slot of the one or more slots may be indicated to the wireless device. A base station may send (e.g., transmit) to and/or receive from, a wireless device, data packets. The data packets may be scheduled for transmission on one or more RBGs and in one or more slots.

A base station may send (e.g., transmit), to a wireless device, downlink control information comprising a downlink assignment. The base station may send (e.g., transmit) the DCI via one or more PDCCHs. The downlink assignment may comprise parameters indicating at least one of a modulation and coding format; resource allocation; and/or HARQ information related to the DL-SCH. The resource allocation may comprise parameters of resource block allocation; and/or slot allocation. A base station may allocate (e.g., dynamically) resources to a wireless device, for example, via a Cell-Radio Network Temporary Identifier (C-RNTI) on one or more PDCCHs. The wireless device may monitor the one or more PDCCHs, for example, in order to find possible allocation if its downlink reception is enabled. The wireless device may receive one or more downlink data packets on one or more PDSCH scheduled by the one or more PDCCHs, for example, if the wireless device successfully detects the one or more PDCCHs.

A base station may allocate Configured Scheduling (CS) resources for down link transmission to a wireless device. The base station may send (e.g., transmit) one or more RRC messages indicating a periodicity of the CS grant. The base station may send (e.g., transmit) DCI via a PDCCH addressed to a Configured Scheduling-RNTI (CS-RNTI) activating the CS resources. The DCI may comprise parameters indicating that the downlink grant is a CS grant. The CS grant may be implicitly reused according to the periodicity defined by the one or more RRC messages. The CS grant may be implicitly reused, for example, until deactivated.

A base station may send (e.g., transmit), to a wireless device via one or more PDCCHs, downlink control information comprising an uplink grant. The uplink grant may comprise parameters indicating at least one of a modulation and coding format; a resource allocation; and/or HARQ information related to the UL-SCH. The resource allocation may comprise parameters of resource block allocation; and/or slot allocation. The base station may dynamically allocate resources to the wireless device via a C-RNTI on one or more PDCCHs. The wireless device may monitor the one or more PDCCHs, for example, in order to find possible resource allocation. The wireless device may send (e.g., transmit) one or more uplink data packets via one or more PUSCH scheduled by the one or more PDCCHs, for example, if the wireless device successfully detects the one or more PDCCHs.

The base station may allocate CS resources for uplink data transmission to a wireless device. The base station may transmit one or more RRC messages indicating a periodicity of the CS grant. The base station may send (e.g., transmit) DCI via a PDCCH addressed to a CS-RNTI to activate the CS resources. The DCI may comprise parameters indicating that the uplink grant is a CS grant. The CS grant may be implicitly reused according to the periodicity defined by the one or more RRC message, The CS grant may be implicitly reused, for example, until deactivated.

A base station may send (e.g., transmit) DCI and/or control signaling via a PDCCH. The DCI may comprise a format of a plurality of formats. The DCI may comprise downlink and/or uplink scheduling information (e.g., resource allocation information, HARQ related parameters, MCS), request(s) for CSI (e.g., aperiodic CQI reports), request(s) for an SRS, uplink power control commands for one or more cells, one or more timing information (e.g., TB transmission/reception timing, HARQ feedback timing, etc.), and/or the like. The DCI may indicate an uplink grant comprising transmission parameters for one or more transport blocks. The DCI may indicate a downlink assignment indicating parameters for receiving one or more transport blocks. The DCI may be used by the base station to initiate a contention-free random access at the wireless device. The base station may send (e.g., transmit) DCI comprising a slot format indicator (SFI) indicating a slot format. The base station may send (e.g., transmit) DCI comprising a preemption indication indicating the PRB(s) and/or OFDM symbol(s) in which a wireless device may assume no transmission is intended for the wireless device. The base station may send (e.g., transmit) DCI for group power control of the PUCCH, the PUSCH, and/or an SRS. DCI may correspond to an RNTI. The wireless device may obtain an RNTI after or in response to completing the initial access (e.g., C-RNTI). The base station may configure an RNTI for the wireless (e.g., CS-RNTI, TPC-CS-RNTI, TPC-PUCCH-RNTI, TPC-PUSCH-RNTI, TPC-SRS-RNTI, etc.). The wireless device may determine (e.g., compute) an RNTI (e.g., the wireless device may determine the RA-RNTI based on resources used for transmission of a preamble). An RNTI may have a pre-configured value (e.g., P-RNTI or SI-RNTI). The wireless device may monitor a group common search space which may be used by the base station for sending (e.g., transmitting) DCIs that are intended for a group of wireless devices. A group common DCI may correspond to an RNTI which is commonly configured for a group of wireless devices. The wireless device may monitor a wireless device-specific search space. A wireless device specific DCI may correspond to an RNTI configured for the wireless device.

A communications system (e.g., an NR system) may support a single beam operation and/or a multi-beam operation. In a multi-beam operation, a base station may perform a downlink beam sweeping to provide coverage for common control channels and/or downlink SS blocks, which may comprise at least a PSS, a SSS, and/or PBCH. A wireless device may measure quality of a beam pair link using one or more RSs. One or more SS blocks, or one or more CSI-RS resources (e.g., which may be associated with a CSI-RS resource index (CRI)), and/or one or more DM-RSs of a PBCH, may be used as an RS for measuring a quality of a beam pair link. The quality of a beam pair link may be based on a reference signal received power (RSRP) value, a reference signal received quality (RSRQ) value, and/or a CSI value measured on RS resources. The base station may indicate whether an RS resource, used for measuring a beam pair link quality, is quasi-co-located (QCLed) with DM-RSs of a control channel. An RS resource and DM-RSs of a control channel may be called QCLed, for example, if channel characteristics from a transmission on an RS to a wireless device, and that from a transmission on a control channel to a wireless device, are similar or the same under a configured criterion. In a multi-beam operation, a wireless device may perform an uplink beam sweeping to access a cell.

A wireless device may be configured to monitor a PDCCH on one or more beam pair links simultaneously, for example, depending on a capability of the wireless device. This monitoring may increase robustness against beam pair link blocking. A base station may send (e.g., transmit) one or more messages to configure the wireless device to monitor the PDCCH on one or more beam pair links in different PDCCH OFDM symbols. A base station may send (e.g., transmit) higher layer signaling (e.g., RRC signaling) and/or a MAC CE comprising parameters related to the Rx beam setting of the wireless device for monitoring the PDCCH on one or more beam pair links. The base station may send (e.g., transmit) an indication of a spatial QCL assumption between an DL RS antenna port(s) (e.g., a cell-specific CSI-RS, a wireless device-specific CSI-RS, an SS block, and/or a PBCH with or without DM-RSs of the PBCH) and/or DL RS antenna port(s) for demodulation of a DL control channel. Signaling for beam indication for a PDCCH may comprise MAC CE signaling, RRC signaling, DCI signaling, and/or specification-transparent and/or implicit method, and/or any combination of signaling methods.

A base station may indicate spatial QCL parameters between DL RS antenna port(s) and DM-RS antenna port(s) of a DL data channel, for example, for reception of a unicast DL data channel. The base station may send (e.g., transmit) DCI (e.g., downlink grants) comprising information indicating the RS antenna port(s). The information may indicate RS antenna port(s) that may be QCL-ed with the DM-RS antenna port(s). A different set of DM-RS antenna port(s) for a DL data channel may be indicated as QCL with a different set of the RS antenna port(s).

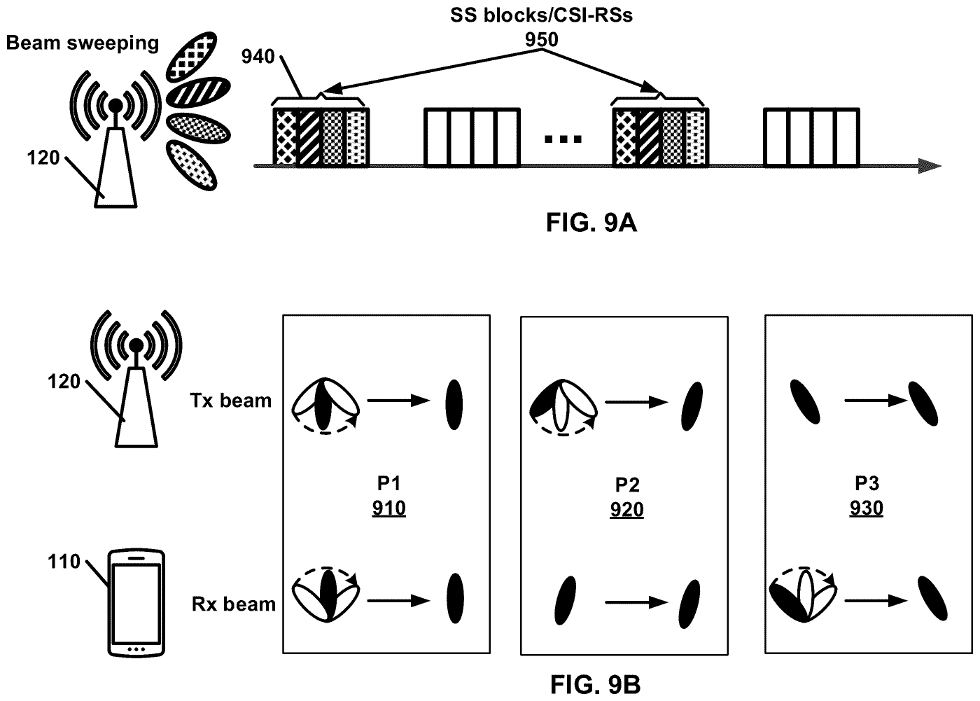

FIG. 9A shows an example of beam sweeping in a DL channel. In an RRC_INACTIVE state or RRC_IDLE state, a wireless device may assume that SS blocks form an SS burst 940, and an SS burst set 950. The SS burst set 950 may have a given periodicity. A base station 120 may send (e.g., transmit) SS blocks in multiple beams, together forming a SS burst 940, for example, in a multi-beam operation. One or more SS blocks may be sent (e.g., transmitted) on one beam. If multiple SS bursts 940 are transmitted with multiple beams, SS bursts together may form SS burst set 950.

A wireless device may use CSI-RS for estimating a beam quality of a link between a wireless device and a base station, for example, in the multi beam operation. A beam may be associated with a CSI-RS. A wireless device may (e.g., based on a RSRP measurement on CSI-RS) report a beam index, which may be indicated in a CRI for downlink beam selection and/or associated with an RSRP value of a beam. A CSI-RS may be sent (e.g., transmitted) on a CSI-RS resource, which may comprise at least one of: one or more antenna ports and/or one or more time and/or frequency radio resources. A CSI-RS resource may be configured in a cell-specific way such as by common RRC signaling, or in a wireless device-specific way such as by dedicated RRC signaling and/or L1/L2 signaling. Multiple wireless devices covered by a cell may measure a cell-specific CSI-RS resource. A dedicated subset of wireless devices covered by a cell may measure a wireless device-specific CSI-RS resource.

A CSI-RS resource may be sent (e.g., transmitted) periodically, using aperiodic transmission, or using a multi-shot or semi-persistent transmission. In a periodic transmission in FIG. 9A, a base station 120 may send (e.g., transmit) configured CSI-RS resources 940 periodically using a configured periodicity in a time domain. In an aperiodic transmission, a configured CSI-RS resource may be sent (e.g., transmitted) in a dedicated time slot. In a multi-shot and/or semi-persistent transmission, a configured CSI-RS resource may be sent (e.g., transmitted) within a configured period. Beams used for CSI-RS transmission may have a different beam width than beams used for SS-blocks transmission.

FIG. 9B shows an example of a beam management procedure, such as in an example new radio network. The base station 120 and/or the wireless device 110 may perform a downlink L1/L2 beam management procedure. One or more of the following downlink L1/L2 beam management procedures may be performed within one or more wireless devices 110 and one or more base stations 120. A P1 procedure 910 may be used to enable the wireless device 110 to measure one or more Transmission (Tx) beams associated with the base station 120, for example, to support a selection of a first set of Tx beams associated with the base station 120 and a first set of Rx beam(s) associated with the wireless device 110. A base station 120 may sweep a set of different Tx beams, for example, for beamforming at a base station 120 (such as shown in the top row, in a counter-clockwise direction). A wireless device 110 may sweep a set of different Rx beams, for example, for beamforming at a wireless device 110 (such as shown in the bottom row, in a clockwise direction). A P2 procedure 920 may be used to enable a wireless device 110 to measure one or more Tx beams associated with a base station 120, for example, to possibly change a first set of Tx beams associated with a base station 120. A P2 procedure 920 may be performed on a possibly smaller set of beams (e.g., for beam refinement) than in the P1 procedure 910. A P2 procedure 920 may be a special example of a P1 procedure 910. A P3 procedure 930 may be used to enable a wireless device 110 to measure at least one Tx beam associated with a base station 120, for example, to change a first set of Rx beams associated with a wireless device 110.

A wireless device 110 may send (e.g., transmit) one or more beam management reports to a base station 120. In one or more beam management reports, a wireless device 110 may indicate one or more beam pair quality parameters comprising one or more of: a beam identification; an RSRP; a Precoding Matrix Indicator (PMI), Channel Quality Indicator (CQI), and/or Rank Indicator (RI) of a subset of configured beams. Based on one or more beam management reports, the base station 120 may send (e.g., transmit) to a wireless device 110 a signal indicating that one or more beam pair links are one or more serving beams. The base station 120 may send (e.g., transmit) the PDCCH and the PDSCH for a wireless device 110 using one or more serving beams.

A communications network (e.g., a new radio network) may support a Bandwidth Adaptation (BA). Receive and/or transmit bandwidths that may be configured for a wireless device using a BA may not be large. Receive and/or transmit bandwidth may not be as large as a bandwidth of a cell. Receive and/or transmit bandwidths may be adjustable. A wireless device may change receive and/or transmit bandwidths, for example, to reduce (e.g., shrink) the bandwidth(s) at (e.g., during) a period of low activity such as to save power. A wireless device may change a location of receive and/or transmit bandwidths in a frequency domain, for example, to increase scheduling flexibility. A wireless device may change a subcarrier spacing, for example, to allow different services.

A Bandwidth Part (BWP) may comprise a subset of a total cell bandwidth of a cell. A base station may configure a wireless device with one or more BWPs, for example, to achieve a BA. A base station may indicate, to a wireless device, which of the one or more (configured) BWPs is an active BWP.

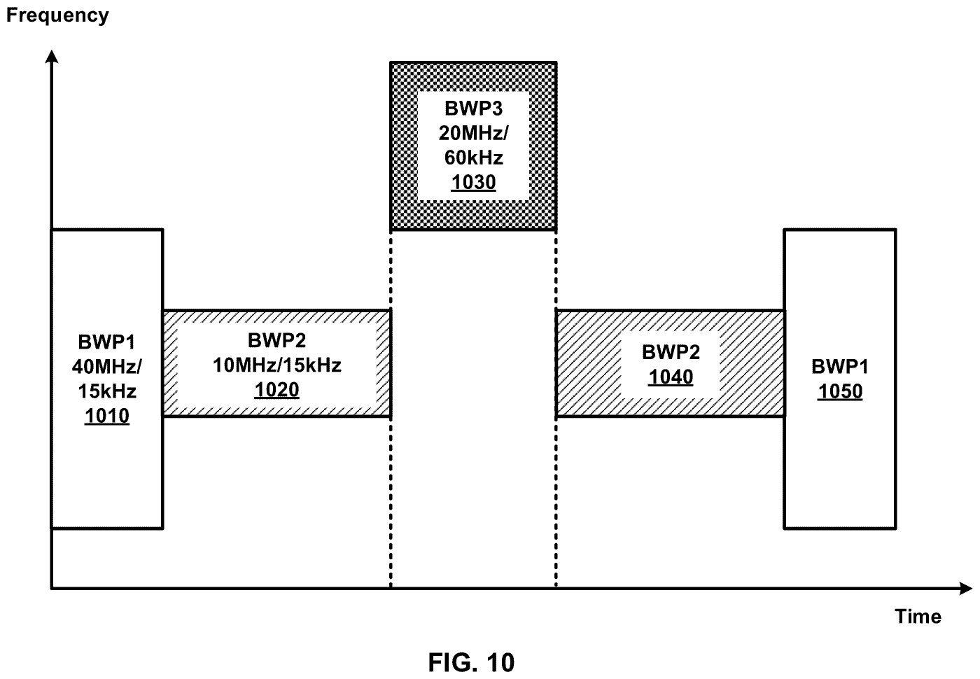

FIG. 10 shows an example of BWP configurations. BWPs may be configured as follows: BWP1 (1010 and 1050) with a width of 40 MHz and subcarrier spacing of 15 kHz; BWP2 (1020 and 1040) with a width of 10 MHz and subcarrier spacing of 15 kHz; BWP3 1030 with a width of 20 MHz and subcarrier spacing of 60 kHz. Any number of BWP configurations may comprise any other width and subcarrier spacing combination.

A wireless device, configured for operation in one or more BWPs of a cell, may be configured by one or more higher layers (e.g., RRC layer). The wireless device may be configured for a cell with: a set of one or more BWPs (e.g., at most four BWPs) for reception (e.g., a DL BWP set) in a DL bandwidth by at least one parameter DL-BWP; and a set of one or more BWPs (e.g., at most four BWPs) for transmissions (e.g., UL BWP set) in an UL bandwidth by at least one parameter UL-BWP.

A base station may configure a wireless device with one or more UL and DL BWP pairs, for example, to enable BA on the PCell. To enable BA on SCells (e.g., for CA), a base station may configure a wireless device at least with one or more DL BWPs (e.g., there may be none in an UL).

An initial active DL BWP may comprise at least one of a location and number of contiguous PRBs, a subcarrier spacing, or a cyclic prefix, for example, for a CORESETs for at least one common search space. For operation on the PCell, one or more higher layer parameters may indicate at least one initial UL BWP for a random access procedure. If a wireless device is configured with a secondary carrier on a primary cell, the wireless device may be configured with an initial BWP for random access procedure on a secondary carrier.

A wireless device may expect that a center frequency for a DL BWP may be same as a center frequency for a UL BWP, for example, for unpaired spectrum operation. A base station may semi-statically configure a wireless device for a cell with one or more parameters, for example, for a DL BWP or an UL BWP in a set of one or more DL BWPs or one or more UL BWPs, respectively. The one or more parameters may indicate one or more of following: a subcarrier spacing; a cyclic prefix; a number of contiguous PRBs; an index in the set of one or more DL BWPs and/or one or more UL BWPs; a link between a DL BWP and an UL BWP from a set of configured DL BWPs and UL BWPs; a DCI detection to a PDSCH reception timing; a PDSCH reception to a HARQ-ACK transmission timing value; a DCI detection to a PUSCH transmission timing value; and/or an offset of a first PRB of a DL bandwidth or an UL bandwidth, respectively, relative to a first PRB of a bandwidth.

For a DL BWP in a set of one or more DL BWPs on a PCell, a base station may configure a wireless device with one or more control resource sets for at least one type of common search space and/or one wireless device-specific search space. A base station may not configure a wireless device without a common search space on a PCell, or on a PSCell, in an active DL BWP. For an UL BWP in a set of one or more UL BWPs, a base station may configure a wireless device with one or more resource sets for one or more PUCCH transmissions.

DCI may comprise a BWP indicator field. The BWP indicator field value may indicate an active DL BWP, from a configured DL BWP set, for one or more DL receptions. The BWP indicator field value may indicate an active UL BWP, from a configured UL BWP set, for one or more UL transmissions.

For a PCell, a base station may semi-statically configure a wireless device with a default DL BWP among configured DL BWPs. If a wireless device is not provided a default DL BWP, a default BWP may be an initial active DL BWP.

A base station may configure a wireless device with a timer value for a PCell. A wireless device may start a timer (e.g., a BWP inactivity timer), for example, if a wireless device detects DCI indicating an active DL BWP, other than a default DL BWP, for a paired spectrum operation, and/or if a wireless device detects DCI indicating an active DL BWP or UL BWP, other than a default DL BWP or UL BWP, for an unpaired spectrum operation. The wireless device may increment the timer by an interval of a first value (e.g., the first value may be 1 millisecond, 0.5 milliseconds, or any other time duration), for example, if the wireless device does not detect DCI at (e.g., during) the interval for a paired spectrum operation or for an unpaired spectrum operation. The timer may expire at a time that the timer is equal to the timer value. A wireless device may switch to the default DL BWP from an active DL BWP, for example, if the timer expires.

A base station may semi-statically configure a wireless device with one or more BWPs. A wireless device may switch an active BWP from a first BWP to a second BWP, for example, after or in response to receiving DCI indicating the second BWP as an active BWP, and/or after or in response to an expiry of BWP inactivity timer (e.g., the second BWP may be a default BWP). FIG. 10 shows an example of three BWPs configured, BWP1 (1010 and 1050), BWP2 (1020 and 1040), and BWP3 (1030). BWP2 (1020 and 1040) may be a default BWP. BWP1 (1010) may be an initial active BWP. A wireless device may switch an active BWP from BWP1 1010 to BWP2 1020, for example, after or in response to an expiry of the BWP inactivity timer. A wireless device may switch an active BWP from BWP2 1020 to BWP3 1030, for example, after or in response to receiving DCI indicating BWP3 1030 as an active BWP. Switching an active BWP from BWP3 1030 to BWP2 1040 and/or from BWP2 1040 to BWP1 1050 may be after or in response to receiving DCI indicating an active BWP, and/or after or in response to an expiry of BWP inactivity timer.

Wireless device procedures on a secondary cell may be same as on a primary cell using the timer value for the secondary cell and the default DL BWP for the secondary cell, for example, if a wireless device is configured for a secondary cell with a default DL BWP among configured DL BWPs and a timer value. A wireless device may use an indicated DL BWP and an indicated UL BWP on a secondary cell as a respective first active DL BWP and first active UL BWP on a secondary cell or carrier, for example, if a base station configures a wireless device with a first active DL BWP and a first active UL BWP on a secondary cell or carrier.

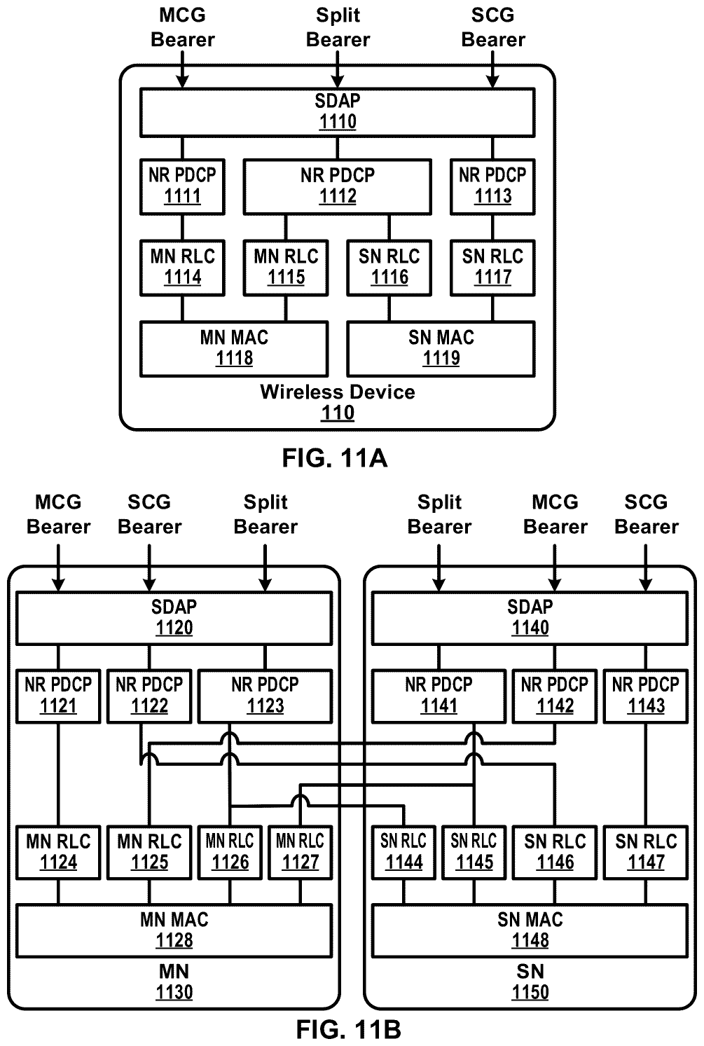

FIG. 11A and FIG. 11B show packet flows using a multi connectivity (e.g., dual connectivity, multi connectivity, tight interworking, and/or the like). FIG. 11A shows an example of a protocol structure of a wireless device 110 (e.g., UE) with CA and/or multi connectivity. FIG. 11B shows an example of a protocol structure of multiple base stations with CA and/or multi connectivity. The multiple base stations may comprise a master node, MN 1130 (e.g., a master node, a master base station, a master gNB, a master eNB, and/or the like) and a secondary node, SN 1150 (e.g., a secondary node, a secondary base station, a secondary gNB, a secondary eNB, and/or the like). A master node 1130 and a secondary node 1150 may co-work to communicate with a wireless device 110.

If multi connectivity is configured for a wireless device 110, the wireless device 110, which may support multiple reception and/or transmission functions in an RRC connected state, may be configured to utilize radio resources provided by multiple schedulers of a multiple base stations. Multiple base stations may be inter-connected via a non-ideal or ideal backhaul (e.g., Xn interface, X2 interface, and/or the like). A base station involved in multi connectivity for a certain wireless device may perform at least one of two different roles: a base station may act as a master base station or act as a secondary base station. In multi connectivity, a wireless device may be connected to one master base station and one or more secondary base stations. A master base station (e.g., the MN 1130) may provide a master cell group (MCG) comprising a primary cell and/or one or more secondary cells for a wireless device (e.g., the wireless device 110). A secondary base station (e.g., the SN 1150) may provide a secondary cell group (SCG) comprising a primary secondary cell (PSCell) and/or one or more secondary cells for a wireless device (e.g., the wireless device 110).

In multi connectivity, a radio protocol architecture that a bearer uses may depend on how a bearer is setup. Three different types of bearer setup options may be supported: an MCG bearer, an SCG bearer, and/or a split bearer. A wireless device may receive and/or send (e.g., transmit) packets of an MCG bearer via one or more cells of the MCG. A wireless device may receive and/or send (e.g., transmit) packets of an SCG bearer via one or more cells of an SCG. Multi-connectivity may indicate having at least one bearer configured to use radio resources provided by the secondary base station. Multi-connectivity may or may not be configured and/or implemented.

A wireless device (e.g., wireless device 110) may send (e.g., transmit) and/or receive: packets of an MCG bearer via an SDAP layer (e.g., SDAP 1110), a PDCP layer (e.g., NR PDCP 1111), an RLC layer (e.g., MN RLC 1114), and a MAC layer (e.g., MN MAC 1118); packets of a split bearer via an SDAP layer (e.g., SDAP 1110), a PDCP layer (e.g., NR PDCP 1112), one of a master or secondary RLC layer (e.g., MN RLC 1115, SN RLC 1116), and one of a master or secondary MAC layer (e.g., MN MAC 1118, SN MAC 1119); and/or packets of an SCG bearer via an SDAP layer (e.g., SDAP 1110), a PDCP layer (e.g., NR PDCP 1113), an RLC layer (e.g., SN RLC 1117), and a MAC layer (e.g., MN MAC 1118).

A master base station (e.g., MN 1130) and/or a secondary base station (e.g., SN 1150) may send (e.g., transmit) and/or receive: packets of an MCG bearer via a master or secondary node SDAP layer (e.g., SDAP 1120, SDAP 1140), a master or secondary node PDCP layer (e.g., NR PDCP 1121, NR PDCP 1142), a master node RLC layer (e.g., MN RLC 1124, MN RLC 1125), and a master node MAC layer (e.g., MN MAC 1128); packets of an SCG bearer via a master or secondary node SDAP layer (e.g., SDAP 1120, SDAP 1140), a master or secondary node PDCP layer (e.g., NR PDCP 1122, NR PDCP 1143), a secondary node RLC layer (e.g., SN RLC 1146, SN RLC 1147), and a secondary node MAC layer (e.g., SN MAC 1148); packets of a split bearer via a master or secondary node SDAP layer (e.g., SDAP 1120, SDAP 1140), a master or secondary node PDCP layer (e.g., NR PDCP 1123, NR PDCP 1141), a master or secondary node RLC layer (e.g., MN RLC 1126, SN RLC 1144, SN RLC 1145, MN RLC 1127), and a master or secondary node MAC layer (e.g., MN MAC 1128, SN MAC 1148).

In multi connectivity, a wireless device may configure multiple MAC entities, such as one MAC entity (e.g., MN MAC 1118) for a master base station, and other MAC entities (e.g., SN MAC 1119) for a secondary base station. In multi-connectivity, a configured set of serving cells for a wireless device may comprise two subsets: an MCG comprising serving cells of a master base station, and SCGs comprising serving cells of a secondary base station. For an SCG, one or more of following configurations may be used. At least one cell of an SCG may have a configured UL CC and at least one cell of a SCG, named as primary secondary cell (e.g., PSCell, PCell of SCG, PCell), and may be configured with PUCCH resources. If an SCG is configured, there may be at least one SCG bearer or one split bearer. After or upon detection of a physical layer problem or a random access problem on a PSCell, or a number of NR RLC retransmissions has been reached associated with the SCG, or after or upon detection of an access problem on a PSCell associated with (e.g., during) a SCG addition or an SCG change: an RRC connection re-establishment procedure may not be triggered, UL transmissions towards cells of an SCG may be stopped, a master base station may be informed by a wireless device of a SCG failure type, a DL data transfer over a master base station may be maintained (e.g., for a split bearer). An NR RLC acknowledged mode (AM) bearer may be configured for a split bearer. A PCell and/or a PSCell may not be de-activated. A PSCell may be changed with a SCG change procedure (e.g., with security key change and a RACH procedure). A bearer type change between a split bearer and a SCG bearer, and/or simultaneous configuration of a SCG and a split bearer, may or may not be supported.

With respect to interactions between a master base station and a secondary base stations for multi-connectivity, one or more of the following may be used. A master base station and/or a secondary base station may maintain RRM measurement configurations of a wireless device. A master base station may determine (e.g., based on received measurement reports, traffic conditions, and/or bearer types) to request a secondary base station to provide additional resources (e.g., serving cells) for a wireless device. After or upon receiving a request from a master base station, a secondary base station may create and/or modify a container that may result in a configuration of additional serving cells for a wireless device (or decide that the secondary base station has no resource available to do so). For a wireless device capability coordination, a master base station may provide (e.g., all or a part of) an AS configuration and wireless device capabilities to a secondary base station. A master base station and a secondary base station may exchange information about a wireless device configuration such as by using RRC containers (e.g., inter-node messages) carried via Xn messages. A secondary base station may initiate a reconfiguration of the secondary base station existing serving cells (e.g., PUCCH towards the secondary base station). A secondary base station may decide which cell is a PSCell within a SCG. A master base station may or may not change content of RRC configurations provided by a secondary base station. A master base station may provide recent (and/or the latest) measurement results for SCG cell(s), for example, if an SCG addition and/or an SCG SCell addition occurs. A master base station and secondary base stations may receive information of SFN and/or subframe offset of each other from an OAM and/or via an Xn interface (e.g., for a purpose of DRX alignment and/or identification of a measurement gap). Dedicated RRC signaling may be used for sending required system information of a cell as for CA, for example, if adding a new SCG SCell, except for an SFN acquired from an MIB of a PSCell of a SCG.

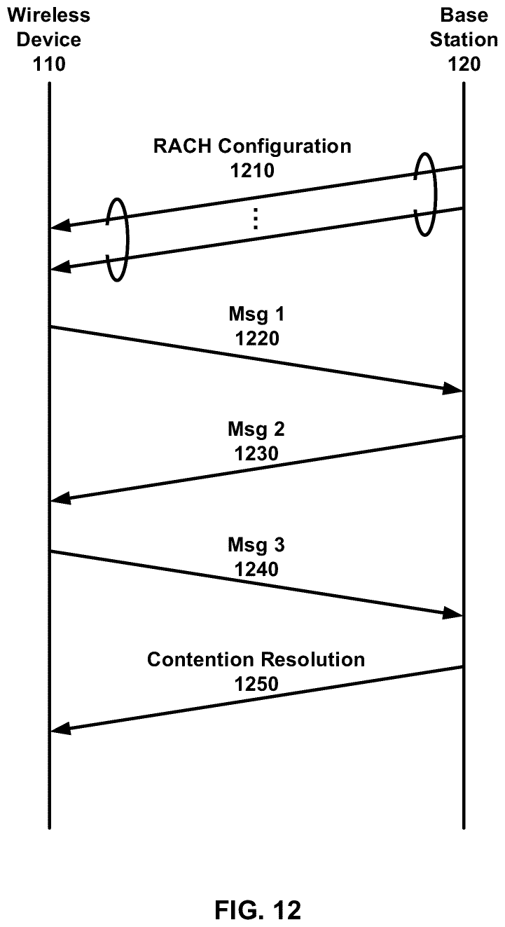

FIG. 12 shows an example of a random access procedure. One or more events may trigger a random access procedure. For example, one or more events may be at least one of following: initial access from RRC_IDLE, RRC connection re-establishment procedure, handover, DL or UL data arrival in (e.g., during) a state of RRC_CONNECTED (e.g., if UL synchronization status is non-synchronized), transition from RRC_Inactive, and/or request for other system information. A PDCCH order, a MAC entity, and/or a beam failure indication may initiate a random access procedure.

A random access procedure may comprise or be one of at least a contention based random access procedure and/or a contention free random access procedure. A contention based random access procedure may comprise one or more Msg 1 1220 transmissions, one or more Msg2 1230 transmissions, one or more Msg3 1240 transmissions, and contention resolution 1250. A contention free random access procedure may comprise one or more Msg 1 1220 transmissions and one or more Msg2 1230 transmissions. One or more of Msg 1 1220, Msg 2 1230, Msg 3 1240, and/or contention resolution 1250 may be transmitted in the same step. A two-step random access procedure, for example, may comprise a first transmission (e.g., Msg A) and a second transmission (e.g., Msg B). The first transmission (e.g., Msg A) may comprise transmitting, by a wireless device (e.g., wireless device 110) to a base station (e.g., base station 120), one or more messages indicating an equivalent and/or similar contents of Msg1 1220 and Msg3 1240 of a four-step random access procedure. The second transmission (e.g., Msg B) may comprise transmitting, by the base station (e.g., base station 120) to a wireless device (e.g., wireless device 110) after or in response to the first message, one or more messages indicating an equivalent and/or similar content of Msg2 1230 and contention resolution 1250 of a four-step random access procedure.

A base station may send (e.g., transmit, unicast, multicast, broadcast, etc.), to a wireless device, a RACH configuration 1210 via one or more beams. The RACH configuration 1210 may comprise one or more parameters indicating at least one of following: an available set of PRACH resources for a transmission of a random access preamble, initial preamble power (e.g., random access preamble initial received target power), an RSRP threshold for a selection of a SS block and corresponding PRACH resource, a power-ramping factor (e.g., random access preamble power ramping step), a random access preamble index, a maximum number of preamble transmissions, preamble group A and group B, a threshold (e.g., message size) to determine the groups of random access preambles, a set of one or more random access preambles for a system information request and corresponding PRACH resource(s) (e.g., if any), a set of one or more random access preambles for a beam failure recovery procedure and corresponding PRACH resource(s) (e.g., if any), a time window to monitor RA response(s), a time window to monitor response(s) on a beam failure recovery procedure, and/or a contention resolution timer.

The Msg1 1220 may comprise one or more transmissions of a random access preamble. For a contention based random access procedure, a wireless device may select an SS block with an RSRP above the RSRP threshold. If random access preambles group B exists, a wireless device may select one or more random access preambles from a group A or a group B, for example, depending on a potential Msg3 1240 size. If a random access preambles group B does not exist, a wireless device may select the one or more random access preambles from a group A. A wireless device may select a random access preamble index randomly (e.g., with equal probability or a normal distribution) from one or more random access preambles associated with a selected group. If a base station semi-statically configures a wireless device with an association between random access preambles and SS blocks, the wireless device may select a random access preamble index randomly with equal probability from one or more random access preambles associated with a selected SS block and a selected group.

A wireless device may initiate a contention free random access procedure, for example, based on a beam failure indication from a lower layer. A base station may semi-statically configure a wireless device with one or more contention free PRACH resources for a beam failure recovery procedure associated with at least one of SS blocks and/or CSI-RSs. A wireless device may select a random access preamble index corresponding to a selected SS block or a CSI-RS from a set of one or more random access preambles for a beam failure recovery procedure, for example, if at least one of the SS blocks with an RSRP above a first RSRP threshold amongst associated SS blocks is available, and/or if at least one of CSI-RSs with a RSRP above a second RSRP threshold amongst associated CSI-RSs is available.

A wireless device may receive, from a base station, a random access preamble index via PDCCH or RRC for a contention free random access procedure. The wireless device may select a random access preamble index, for example, if a base station does not configure a wireless device with at least one contention free PRACH resource associated with SS blocks or CSI-RS. The wireless device may select the at least one SS block and/or select a random access preamble corresponding to the at least one SS block, for example, if a base station configures the wireless device with one or more contention free PRACH resources associated with SS blocks and/or if at least one SS block with a RSRP above a first RSRP threshold amongst associated SS blocks is available. The wireless device may select the at least one CSI-RS and/or select a random access preamble corresponding to the at least one CSI-RS, for example, if a base station configures a wireless device with one or more contention free PRACH resources associated with CSI-RSs and/or if at least one CSI-RS with a RSRP above a second RSRP threshold amongst the associated CSI-RSs is available.

A wireless device may perform one or more Msg1 1220 transmissions, for example, by sending (e.g., transmitting) the selected random access preamble. The wireless device may determine a PRACH occasion from one or more PRACH occasions corresponding to a selected SS block, for example, if the wireless device selects an SS block and is configured with an association between one or more PRACH occasions and/or one or more SS blocks. The wireless device may determine a PRACH occasion from one or more PRACH occasions corresponding to a selected CSI-RS, for example, if the wireless device selects a CSI-RS and is configured with an association between one or more PRACH occasions and one or more CSI-RSs. The wireless device may send (e.g., transmit), to a base station, a selected random access preamble via a selected PRACH occasions. The wireless device may determine a transmit power for a transmission of a selected random access preamble at least based on an initial preamble power and a power-ramping factor. The wireless device may determine an RA-RNTI associated with a selected PRACH occasion in which a selected random access preamble is sent (e.g., transmitted). The wireless device may not determine an RA-RNTI for a beam failure recovery procedure. The wireless device may determine an RA-RNTI at least based on an index of a first OFDM symbol, an index of a first slot of a selected PRACH occasions, and/or an uplink carrier index for a transmission of Msg1 1220.

A wireless device may receive, from a base station, a random access response, Msg 2 1230. The wireless device may start a time window (e.g., ra-ResponseWindow) to monitor a random access response. For a beam failure recovery procedure, the base station may configure the wireless device with a different time window (e.g., bfr-ResponseWindow) to monitor response to on a beam failure recovery request. The wireless device may start a time window (e.g., ra-ResponseWindow or bfr-ResponseWindow) at a start of a first PDCCH occasion, for example, after a fixed duration of one or more symbols from an end of a preamble transmission. If the wireless device sends (e.g., transmits) multiple preambles, the wireless device may start a time window at a start of a first PDCCH occasion after a fixed duration of one or more symbols from an end of a first preamble transmission. The wireless device may monitor a PDCCH of a cell for at least one random access response identified by a RA-RNTI, or for at least one response to a beam failure recovery request identified by a C-RNTI, at a time that a timer for a time window is running.

A wireless device may determine that a reception of random access response is successful, for example, if at least one random access response comprises a random access preamble identifier corresponding to a random access preamble sent (e.g., transmitted) by the wireless device. The wireless device may determine that the contention free random access procedure is successfully completed, for example, if a reception of a random access response is successful. The wireless device may determine that a contention free random access procedure is successfully complete, for example, if a contention free random access procedure is triggered for a beam failure recovery request and if a PDCCH transmission is addressed to a C-RNTI. The wireless device may determine that the random access procedure is successfully completed, and may indicate a reception of an acknowledgement for a system information request to upper layers, for example, if at least one random access response comprises a random access preamble identifier. The wireless device may stop sending (e.g., transmitting) remaining preambles (if any) after or in response to a successful reception of a corresponding random access response, for example, if the wireless device has signaled multiple preamble transmissions.

The wireless device may perform one or more Msg 3 1240 transmissions, for example, after or in response to a successful reception of random access response (e.g., for a contention based random access procedure). The wireless device may adjust an uplink transmission timing, for example, based on a timing advanced command indicated by a random access response. The wireless device may send (e.g., transmit) one or more transport blocks, for example, based on an uplink grant indicated by a random access response. Subcarrier spacing for PUSCH transmission for Msg3 1240 may be provided by at least one higher layer (e.g., RRC) parameter. The wireless device may send (e.g., transmit) a random access preamble via a PRACH, and Msg3 1240 via PUSCH, on the same cell. A base station may indicate an UL BWP for a PUSCH transmission of Msg3 1240 via system information block. The wireless device may use HARQ for a retransmission of Msg 3 1240.

Multiple wireless devices may perform Msg 1 1220, for example, by sending (e.g., transmitting) the same preamble to a base station. The multiple wireless devices may receive, from the base station, the same random access response comprising an identity (e.g., TC-RNTI). Contention resolution (e.g., comprising the wireless device 110 receiving contention resolution 1250) may be used to increase the likelihood that a wireless device does not incorrectly use an identity of another wireless device. The contention resolution 1250 may be based on, for example, a C-RNTI on a PDCCH, and/or a wireless device contention resolution identity on a DL-SCH. If a base station assigns a C-RNTI to a wireless device, the wireless device may perform contention resolution (e.g., comprising receiving contention resolution 1250), for example, based on a reception of a PDCCH transmission that is addressed to the C-RNTI. The wireless device may determine that contention resolution is successful, and/or that a random access procedure is successfully completed, for example, after or in response to detecting a C-RNTI on a PDCCH. If a wireless device has no valid C-RNTI, a contention resolution may be addressed by using a TC-RNTI. If a MAC PDU is successfully decoded and a MAC PDU comprises a wireless device contention resolution identity MAC CE that matches or otherwise corresponds with the CCCH SDU sent (e.g., transmitted) in Msg3 1240, the wireless device may determine that the contention resolution (e.g., comprising contention resolution 1250) is successful and/or the wireless device may determine that the random access procedure is successfully completed.

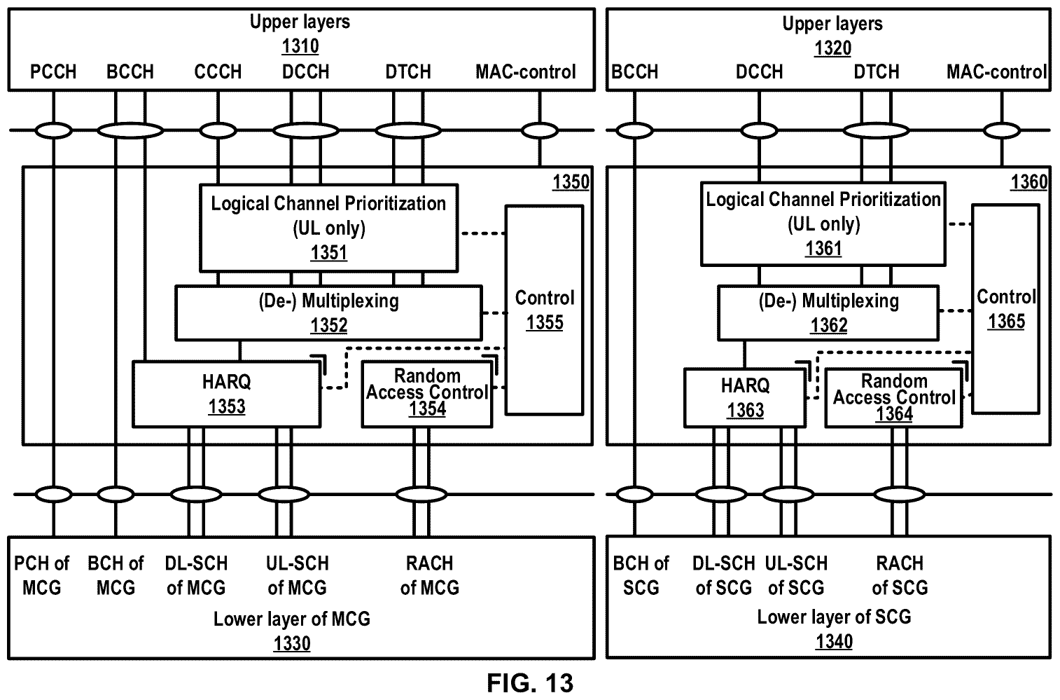

FIG. 13 shows an example structure for MAC entities. A wireless device may be configured to operate in a multi-connectivity mode. A wireless device in RRC_CONNECTED with multiple Rx/Tx may be configured to utilize radio resources provided by multiple schedulers that may be located in a plurality of base stations. The plurality of base stations may be connected via a non-ideal or ideal backhaul over the Xn interface. A base station in a plurality of base stations may act as a master base station or as a secondary base station. A wireless device may be connected to and/or in communication with, for example, one master base station and one or more secondary base stations. A wireless device may be configured with multiple MAC entities, for example, one MAC entity for a master base station, and one or more other MAC entities for secondary base station(s). A configured set of serving cells for a wireless device may comprise two subsets: an MCG comprising serving cells of a master base station, and one or more SCGs comprising serving cells of a secondary base station(s). FIG. 13 shows an example structure for MAC entities in which a MCG and a SCG are configured for a wireless device.

At least one cell in a SCG may have a configured UL CC. A cell of the at least one cell may comprise a PSCell or a PCell of a SCG, or a PCell. A PSCell may be configured with PUCCH resources. There may be at least one SCG bearer, or one split bearer, for a SCG that is configured. After or upon detection of a physical layer problem or a random access problem on a PSCell, after or upon reaching a number of RLC retransmissions associated with the SCG, and/or after or upon detection of an access problem on a PSCell associated with (e.g., during) a SCG addition or a SCG change: an RRC connection re-establishment procedure may not be triggered, UL transmissions towards cells of a SCG may be stopped, and/or a master base station may be informed by a wireless device of a SCG failure type and DL data transfer over a master base station may be maintained.

A MAC sublayer may provide services such as data transfer and radio resource allocation to upper layers (e.g., 1310 or 1320). A MAC sublayer may comprise a plurality of MAC entities (e.g., 1350 and 1360). A MAC sublayer may provide data transfer services on logical channels. To accommodate different kinds of data transfer services, multiple types of logical channels may be defined. A logical channel may support transfer of a particular type of information. A logical channel type may be defined by what type of information (e.g., control or data) is transferred. BCCH, PCCH, CCCH and/or DCCH may be control channels, and DTCH may be a traffic channel. A first MAC entity (e.g., 1310) may provide services on PCCH, BCCH, CCCH, DCCH, DTCH, and/or MAC control elements. A second MAC entity (e.g., 1320) may provide services on BCCH, DCCH, DTCH, and/or MAC control elements.

A MAC sublayer may expect from a physical layer (e.g., 1330 or 1340) services such as data transfer services, signaling of HARQ feedback, and/or signaling of scheduling request or measurements (e.g., CQI). In dual connectivity, two MAC entities may be configured for a wireless device: one for a MCG and one for a SCG. A MAC entity of a wireless device may handle a plurality of transport channels. A first MAC entity may handle first transport channels comprising a PCCH of a MCG, a first BCH of the MCG, one or more first DL-SCHs of the MCG, one or more first UL-SCHs of the MCG, and/or one or more first RACHs of the MCG. A second MAC entity may handle second transport channels comprising a second BCH of a SCG, one or more second DL-SCHs of the SCG, one or more second UL-SCHs of the SCG, and/or one or more second RACHs of the SCG.

If a MAC entity is configured with one or more SCells, there may be multiple DL-SCHs, multiple UL-SCHs, and/or multiple RACHs per MAC entity. There may be one DL-SCH and/or one UL-SCH on an SpCell. There may be one DL-SCH, zero or one UL-SCH, and/or zero or one RACH for an SCell. A DL-SCH may support receptions using different numerologies and/or TTI duration within a MAC entity. A UL-SCH may support transmissions using different numerologies and/or TTI duration within the MAC entity.

A MAC sublayer may support different functions. The MAC sublayer may control these functions with a control (e.g., Control 1355 and/or Control 1365) element. Functions performed by a MAC entity may comprise one or more of: mapping between logical channels and transport channels (e.g., in uplink or downlink), multiplexing (e.g., (De-) Multiplexing 1352 and/or (De-) Multiplexing 1362) of MAC SDUs from one or different logical channels onto transport blocks (TBs) to be delivered to the physical layer on transport channels (e.g., in uplink), demultiplexing (e.g., (De-) Multiplexing 1352 and/or (De-) Multiplexing 1362) of MAC SDUs to one or different logical channels from transport blocks (TBs) delivered from the physical layer on transport channels (e.g., in downlink), scheduling information reporting (e.g., in uplink), error correction through HARQ in uplink and/or downlink (e.g., 1363), and logical channel prioritization in uplink (e.g., Logical Channel Prioritization 1351 and/or Logical Channel Prioritization 1361). A MAC entity may handle a random access process (e.g., Random Access Control 1354 and/or Random Access Control 1364).

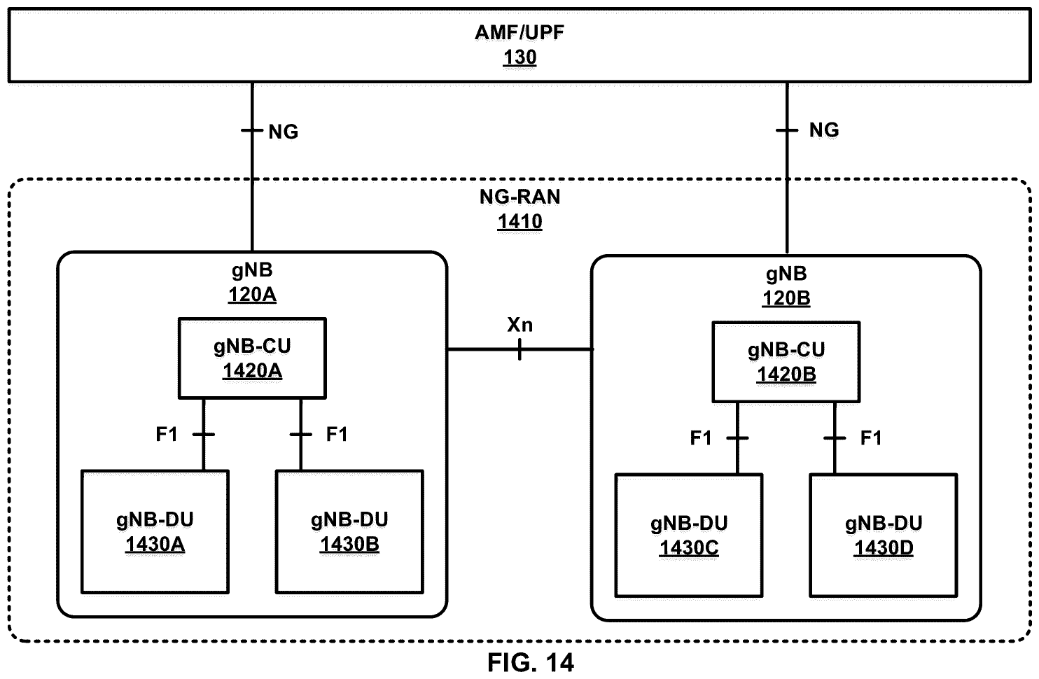

FIG. 14 shows an example of a RAN architecture comprising one or more base stations. A protocol stack (e.g., RRC, SDAP, PDCP, RLC, MAC, and/or PHY) may be supported at a node. A base station (e.g., gNB 120A and/or 120B) may comprise a base station central unit (CU) (e.g., gNB-CU 1420A or 1420B) and at least one base station distributed unit (DU) (e.g., gNB-DU 1430A, 1430B, 1430C, and/or 1430D), for example, if a functional split is configured. Upper protocol layers of a base station may be located in a base station CU, and lower layers of the base station may be located in the base station DUs. An F1 interface (e.g., CU-DU interface) connecting a base station CU and base station DUs may be an ideal or non-ideal backhaul. F1-C may provide a control plane connection over an F1 interface, and F1-U may provide a user plane connection over the F1 interface. An Xn interface may be configured between base station CUs.

A base station CU may comprise an RRC function, an SDAP layer, and/or a PDCP layer. Base station DUs may comprise an RLC layer, a MAC layer, and/or a PHY layer. Various functional split options between a base station CU and base station DUs may be possible, for example, by locating different combinations of upper protocol layers (e.g., RAN functions) in a base station CU and different combinations of lower protocol layers (e.g., RAN functions) in base station DUs. A functional split may support flexibility to move protocol layers between a base station CU and base station DUs, for example, depending on service requirements and/or network environments.

Functional split options may be configured per base station, per base station CU, per base station DU, per wireless device, per bearer, per slice, and/or with other granularities. In a per base station CU split, a base station CU may have a fixed split option, and base station DUs may be configured to match a split option of a base station CU. In a per base station DU split, a base station DU may be configured with a different split option, and a base station CU may provide different split options for different base station DUs. In a per wireless device split, a base station (e.g., a base station CU and at least one base station DUs) may provide different split options for different wireless devices. In a per bearer split, different split options may be utilized for different bearers. In a per slice splice, different split options may be used for different slices.

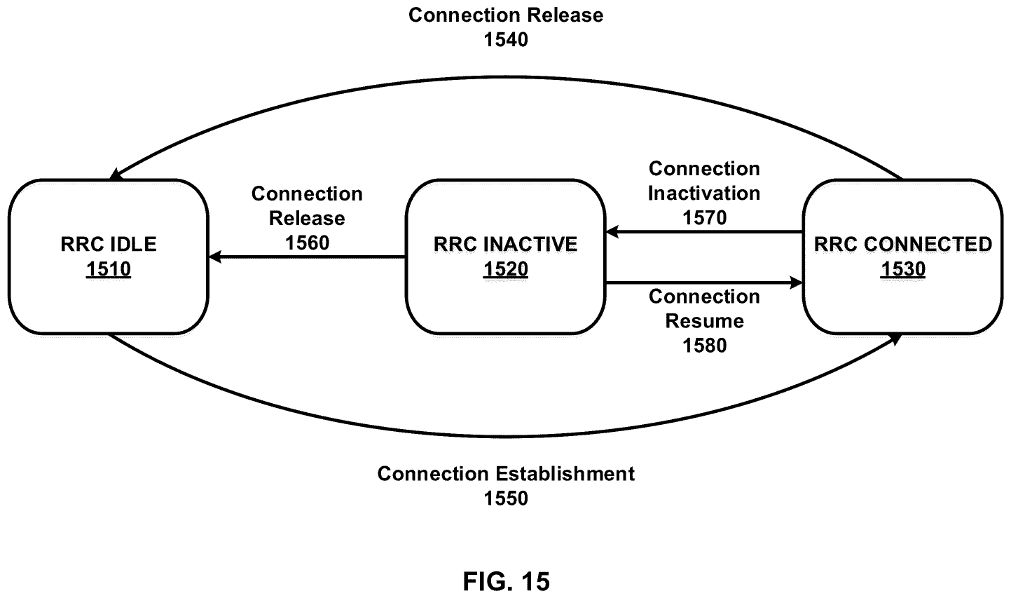

FIG. 15 shows example RRC state transitions of a wireless device. A wireless device may be in at least one RRC state among an RRC connected state (e.g., RRC Connected 1530, RRC_Connected, etc.), an RRC idle state (e.g., RRC Idle 1510, RRC_Idle, etc.), and/or an RRC inactive state (e.g., RRC Inactive 1520, RRC_Inactive, etc.). In an RRC connected state, a wireless device may have at least one RRC connection with at least one base station (e.g., gNB and/or eNB), which may have a context of the wireless device (e.g., UE context). A wireless device context (e.g., UE context) may comprise at least one of an access stratum context, one or more radio link configuration parameters, bearer (e.g., data radio bearer (DRB), signaling radio bearer (SRB), logical channel, QoS flow, PDU session, and/or the like) configuration information, security information, PHY/MAC/RLC/PDCP/SDAP layer configuration information, and/or the like configuration information for a wireless device. In an RRC idle state, a wireless device may not have an RRC connection with a base station, and a context of the wireless device may not be stored in a base station. In an RRC inactive state, a wireless device may not have an RRC connection with a base station. A context of a wireless device may be stored in a base station, which may comprise an anchor base station (e.g., a last serving base station).

A wireless device may transition an RRC state (e.g., UE RRC state) between an RRC idle state and an RRC connected state in both ways (e.g., connection release 1540 or connection establishment 1550; and/or connection reestablishment) and/or between an RRC inactive state and an RRC connected state in both ways (e.g., connection inactivation 1570 or connection resume 1580). A wireless device may transition its RRC state from an RRC inactive state to an RRC idle state (e.g., connection release 1560).

An anchor base station may be a base station that may keep a context of a wireless device (e.g., UE context) at least at (e.g., during) a time period that the wireless device stays in a RAN notification area (RNA) of an anchor base station, and/or at (e.g., during) a time period that the wireless device stays in an RRC inactive state. An anchor base station may comprise a base station that a wireless device in an RRC inactive state was most recently connected to in a latest RRC connected state, and/or a base station in which a wireless device most recently performed an RNA update procedure. An RNA may comprise one or more cells operated by one or more base stations. A base station may belong to one or more RNAs. A cell may belong to one or more RNAs.

A wireless device may transition, in a base station, an RRC state (e.g., UE RRC state) from an RRC connected state to an RRC inactive state. The wireless device may receive RNA information from the base station. RNA information may comprise at least one of an RNA identifier, one or more cell identifiers of one or more cells of an RNA, a base station identifier, an IP address of the base station, an AS context identifier of the wireless device, a resume identifier, and/or the like.

An anchor base station may broadcast a message (e.g., RAN paging message) to base stations of an RNA to reach to a wireless device in an RRC inactive state. The base stations receiving the message from the anchor base station may broadcast and/or multicast another message (e.g., paging message) to wireless devices in their coverage area, cell coverage area, and/or beam coverage area associated with the RNA via an air interface.

A wireless device may perform an RNA update (RNAU) procedure, for example, if the wireless device is in an RRC inactive state and moves into a new RNA. The RNAU procedure may comprise a random access procedure by the wireless device and/or a context retrieve procedure (e.g., UE context retrieve). A context retrieve procedure may comprise: receiving, by a base station from a wireless device, a random access preamble; and requesting and/or receiving (e.g., fetching), by a base station, a context of the wireless device (e.g., UE context) from an old anchor base station. The requesting and/or receiving (e.g., fetching) may comprise: sending a retrieve context request message (e.g., UE context request message) comprising a resume identifier to the old anchor base station and receiving a retrieve context response message comprising the context of the wireless device from the old anchor base station.

A wireless device in an RRC inactive state may select a cell to camp on based on at least a measurement result for one or more cells, a cell in which a wireless device may monitor an RNA paging message, and/or a core network paging message from a base station. A wireless device in an RRC inactive state may select a cell to perform a random access procedure to resume an RRC connection and/or to send (e.g., transmit) one or more packets to a base station (e.g., to a network). The wireless device may initiate a random access procedure to perform an RNA update procedure, for example, if a cell selected belongs to a different RNA from an RNA for the wireless device in an RRC inactive state. The wireless device may initiate a random access procedure to send (e.g., transmit) one or more packets to a base station of a cell that the wireless device selects, for example, if the wireless device is in an RRC inactive state and has one or more packets (e.g., in a buffer) to send (e.g., transmit) to a network. A random access procedure may be performed with two messages (e.g., 2-stage or 2-step random access) and/or four messages (e.g., 4-stage or 4-step random access) between the wireless device and the base station.

A base station receiving one or more uplink packets from a wireless device in an RRC inactive state may request and/or receive (e.g., fetch) a context of a wireless device (e.g., UE context), for example, by sending (e.g., transmitting) a retrieve context request message for the wireless device to an anchor base station of the wireless device based on at least one of an AS context identifier, an RNA identifier, a base station identifier, a resume identifier, and/or a cell identifier received from the wireless device. A base station may send (e.g., transmit) a path switch request for a wireless device to a core network entity (e.g., AMF, MME, and/or the like), for example, after or in response to requesting and/or receiving (e.g., fetching) a context. A core network entity may update a downlink tunnel endpoint identifier for one or more bearers established for the wireless device between a user plane core network entity (e.g., UPF, S-GW, and/or the like) and a RAN node (e.g., the base station), such as by changing a downlink tunnel endpoint identifier from an address of the anchor base station to an address of the base station).

A base station may communicate with a wireless device via a wireless network using one or more technologies, such as new radio technologies (e.g., NR, 5G, etc.). The one or more radio technologies may comprise at least one of: multiple technologies related to physical layer; multiple technologies related to medium access control layer; and/or multiple technologies related to radio resource control layer. Enhancing the one or more radio technologies may improve performance of a wireless network. System throughput, and/or data rate of transmission, may be increased. Battery consumption of a wireless device may be reduced. Latency of data transmission between a base station and a wireless device may be improved. Network coverage of a wireless network may be improved. Transmission efficiency of a wireless network may be improved.

Two or more component carriers (CCs) may be aggregated, for example, in a carrier aggregation (CA). A wireless device may simultaneously receive and/or transmit on one or more CCs, for example, depending on capabilities of the wireless device. The CA may be supported for contiguous CCs. The CA may be supported for non-contiguous CCs.

A wireless device may have one RRC connection with a network, for example, if configured with CA. At (e.g., during) an RRC connection establishment, re-establishment and/or handover, a cell providing a NAS mobility information may be a serving cell. At (e.g., during) an RRC connection re-establishment and/or handover procedure, a cell providing a security input may be a serving cell. The serving cell may be referred to as a primary cell (PCell). A base station may send (e.g., transmit), to a wireless device, one or more messages comprising configuration parameters of a plurality of one or more secondary cells (SCells), for example, depending on capabilities of the wireless device.

A base station and/or a wireless device may use an activation and/or deactivation mechanism of an SCell for an efficient battery consumption, for example, if the base station and/or the wireless device is configured with CA. A base station may activate or deactivate at least one of the one or more SCells, for example, if the wireless device is configured with one or more SCells. The SCell may be deactivated, for example, after or upon configuration of an SCell.

A wireless device may activate and/or deactivate an SCell, for example, after or in response to receiving an SCell activation and/or deactivation MAC CE. A base station may send (e.g., transmit), to a wireless device, one or more messages comprising an sCellDeactivationTimer timer. The wireless device may deactivate an SCell, for example, after or in response to an expiry of the sCellDeactivationTimer timer.

A wireless device may activate an SCell, for example, if the wireless device receives an SCell activation/deactivation MAC CE activating an SCell. The wireless device may perform operations (e.g., after or in response to the activating the SCell) that may comprise: SRS transmissions on the SCell; CQI, PMI, RI, and/or CRI reporting for the SCell on a PCell; PDCCH monitoring on the SCell; PDCCH monitoring for the SCell on the PCell; and/or PUCCH transmissions on the SCell.

The wireless device may start and/or restart a timer (e.g., an sCellDeactivationTimer timer) associated with the SCell, for example, after or in response to activating the SCell. The wireless device may start the timer (e.g., sCellDeactivationTimer timer) in the slot, for example, if the SCell activation/deactivation MAC CE has been received. The wireless device may initialize and/or re-initialize one or more suspended configured uplink grants of a configured grant Type 1 associated with the SCell according to a stored configuration, for example, after or in response to activating the SCell. The wireless device may trigger a PHR, for example, after or in response to activating the SCell.

The wireless device may deactivate the activated SCell, for example, if the wireless device receives an SCell activation/deactivation MAC CE deactivating an activated SCell. The wireless device may deactivate the activated SCell, for example, if a timer (e.g., an sCellDeactivationTimer timer) associated with an activated SCell expires. The wireless device may stop the timer (e.g., sCellDeactivationTimer timer) associated with the activated SCell, for example, after or in response to deactivating the activated SCell. The wireless device may clear one or more configured downlink assignments and/or one or more configured uplink grant Type 2 associated with the activated SCell, for example, after or in response to the deactivating the activated SCell. The wireless device may suspend one or more configured uplink grant Type 1 associated with the activated SCell, for example, after or in response to deactivating the activated SCell. The wireless device may flush HARQ buffers associated with the activated SCell.

A wireless device may not perform certain operations, for example, if an SCell is deactivated. The wireless device may not perform one or more of the following operations if an SCell is deactivated: transmitting SRS on the SCell; reporting CQI, PMI, RI, and/or CRI for the SCell on a PCell; transmitting on UL-SCH on the SCell; transmitting on a RACH on the SCell; monitoring at least one first PDCCH on the SCell; monitoring at least one second PDCCH for the SCell on the PCell; and/or transmitting a PUCCH on the SCell.

A wireless device may restart a timer (e.g., an sCellDeactivationTimer timer) associated with the activated SCell, for example, if at least one first PDCCH on an activated SCell indicates an uplink grant or a downlink assignment. A wireless device may restart a timer (e.g., an sCellDeactivationTimer timer) associated with the activated SCell, for example, if at least one second PDCCH on a serving cell (e.g. a PCell or an SCell configured with PUCCH, such as a PUCCH SCell) scheduling the activated SCell indicates an uplink grant and/or a downlink assignment for the activated SCell. A wireless device may abort the ongoing random access procedure on the SCell, for example, if an SCell is deactivated and/or if there is an ongoing random access procedure on the SCell.

A base station may configure a wireless device with uplink (UL) bandwidth parts (BWPs) and downlink (DL) BWPs, for example, to enable bandwidth adaptation (BA) for a PCell. The base station may configure the wireless device with at least DL BWP(s) (e.g., an SCell may not have UL BWPS) to enable BA for an SCell, for example, if CA is configured. For the PCell, a first initial BWP may be a first BWP used for initial access. For the SCell, a second initial BWP may be a second BWP configured for the wireless device to first operate on the SCell if the SCell is activated.

A first DL and a first UL may switch BWP independently, for example, in paired spectrum (e.g., FDD). A second DL and a second UL may switch BWP simultaneously, for example, in unpaired spectrum (e.g., TDD). Switching between configured BWPs may be based on DCI and/or an inactivity timer. An expiry of the inactivity timer associated with a cell may switch an active BWP to a default BWP, for example, if the inactivity timer is configured for a serving cell. The default BWP may be configured by the network.

One UL BWP for each uplink carrier and one DL BWP may be active at a time in an active serving cell, for example, in FDD systems configured with BA. One DL/UL BWP pair may be active at a time in an active serving cell, for example, in TDD systems. Operating on the one UL BWP and the one DL BWP (and/or the one DL/UL pair) may enable a wireless device to use a reasonable amount of power (e.g., reasonable battery consumption). BWPs other than the one UL BWP and the one DL BWP that the wireless device may be configured with may be deactivated. The wireless device may refrain from monitoring a PDCCH, and/or may refrain from transmitting via a PUCCH, PRACH and/or UL-SCH, for example, on deactivated BWPs.

A serving cell may be configured with a first number (e.g., four) of BWPs. A wireless device and/or a base station may have one active BWP at any point in time, for example, for an activated serving cell. A BWP switching for a serving cell may be used to activate an inactive BWP and/or deactivate an active BWP. The BWP switching may be controlled by a PDCCH indicating a downlink assignment or an uplink grant. The BWP switching may be controlled by an inactivity timer (e.g., bandwidthpartlnactivityTimer). The BWP switching may be controlled by a MAC entity, for example, based on initiating a random access procedure. A BWP may be initially active without receiving a PDCCH indicating a downlink assignment or an uplink grant, for example, based on an addition of an SpCell or an activation of an SCell. The active BWP for a serving cell may be indicated by an RRC message and/or a PDCCH message (e.g., PDCCH order). A DL BWP may be paired with an UL BWP, and/or BWP switching may be common for both UL and DL, for example, for unpaired spectrum.

A MAC entity may use operations on an active BWP for an activated serving cell configured with a BWP, such as one or more of: transmitting via an UL-SCH; transmitting via a RACH; monitoring a PDCCH; transmitting via a PUCCH; receiving via a DL-SCH; initializing and/or reinitializing suspended configured uplink grants of configured grant Type 1 according to a stored configuration, if any and/or to start in a symbol based on a procedure. On an inactive BWP for each activated serving cell configured with a BWP, a MAC entity: may refrain from transmitting via an UL-SCH, may refrain from transmitting via a RACH, may refrain from monitoring a PDCCH, may refrain from transmitting via a PUCCH, may refrain from transmitting an SRS, may refrain from receiving via a DL-SCH, may clear any configured downlink assignment and configured uplink grant of configured grant Type 2, and/or may suspend any configured uplink grant of configured Type 1.

A MAC entity may perform a random access procedure (e.g., based on an initiation of the random access procedure) on an active DL BWP and the active UL BWP, for example, if PRACH resources are configured for the active UL BWP. A MAC entity may switch to an initial DL BWP and an initial UL BWP, for example, if PRACH resources are not configured for an active UL BWP (e.g., based on initiation of a random access procedure). The MAC entity may perform the random access procedure on the initial DL BWP and the initial UL BWP, for example, based on the BWP switching.

A wireless device may perform BWP switching to a BWP indicated by a PDCCH, for example, if a MAC entity receives a PDCCH (e.g., a PDCCH order) for a BWP switching of a serving cell, for example, if a random access procedure associated with this serving cell is not ongoing. A wireless device may determine whether to switch a BWP or ignore the PDCCH for the BWP switching, for example, if a MAC entity received a PDCCH for a BWP switching while a random access procedure is ongoing in the MAC entity. The MAC entity may stop the ongoing Random Access procedure and initiate a second Random Access procedure on a new activated BWP, for example, if the MAC entity decides to perform the BWP switching. The MAC entity may continue with the ongoing Random Access procedure on the active BWP, for example if the MAC decides to ignore the PDCCH for the BWP switching. A wireless device may perform the BWP switching to a BWP indicated by the PDCCH, for example, if a MAC entity receives a PDCCH for a BWP switching addressed to a C-RNTI for a successful completion of a Random Access procedure.

The MAC entity may start or restart the BWP-InactivityTimer associated with the active DL BWP for a variety of reasons. The MAC entity may start or restart the BWP-InactivityTimer associated with the active DL BWP, for example, if one or more of the following occur: a BWP-InactivityTimer is configured for an activated serving sell, if a Default-DL-BWP is configured and an active DL BWP is not a BWP indicated by the Default-DL-BWP, if the Default-DL-BWP is not configured and the active DL BWP is not the initial BWP; and/or if one or more of the following occur: if a PDCCH addressed to C-RNTI or CS-RNTI indicating downlink assignment or uplink grant is received on the active BWP, and/or if there is not an ongoing random access procedure associated with the activated serving cell.

The MAC entity may start or restart the BWP-InactivityTimer associated with the active DL BWP, for example, if one or more of the following occur: if a BWP-InactivityTimer is configured for an activated serving cell, if a Default-DL-BWP is configured and an active DL BWP is not a BWP indicated by the Default-DL-BWP, and/or if the Default-DL-BWP is not configured and the active DL BWP is not the initial BWP; and/or if one or more of the following occur: if a MAC-PDU is transmitted in a configured uplink grant or received in a configured downlink assignment, and/or if there is not an ongoing random access procedure associated with the activated serving cell.

The MAC entity may start or restart the BWP-InactivityTimer associated with the active DL BWP, for example, if one or more of the following occur: if a BWP-InactivityTimer is configured for an activated serving cell, if a Default-DL-BWP is configured and an active DL BWP is not a BWP indicated by the Default-DL-BWP, and/or if the Default-DL-BWP is not configured and the active DL BWP is not the initial BWP; and/or if one or more of the following occur: if a PDCCH addressed to C-RNTI or CS-RNTI indicating downlink assignment or uplink grant is received on the active BWP, if a MAC-PDU is transmitted in a configured uplink grant or received in a configured downlink assignment, and/or if an ongoing random access procedure associated with the activated Serving Cell is successfully completed in response to receiving the PDCCH addressed to a C-RNTI.

The MAC entity may start or restart the BWP-InactivityTimer associated with the active DL BWP based on switching the active BWP. For example, the MAC entity may start or restart the BWP-InactivityTimer associated with the active DL BWP if a PDCCH for BWP switching is received and the wireless device switches an active DL BWP to the DL BWP, and/or if one or more of the following occur: if a default downlink BWP is configured and the DL BWP is not the default downlink BWP, and/or if a default downlink BWP is not configured and the DL BWP is not the initial downlink BWP.

The MAC entity may stop the BWP-InactivityTimer associated with an active DL BWP of the activated serving cell, for example, if one or more of the following occur: if BWP-InactivityTimer is configured for an activated serving cell, if the Default-DL-BWP is configured and the active DL BWP is not the BWP indicated by the Default-DL-BWP, and/or if the Default-DL-BWP is not configured and the active DL BWP is not the initial BWP; and/or if a random access procedure is initiated. The MAC entity may stop a second BWP-InactivityTimer associated with a second active DL BWP of an SpCell, for example, if the activated Serving Cell is an SCell (other than a PSCell).

The MAC entity may perform BWP switching to a BWP indicated by the Default-DL-BWP, for example, if one or more of the following occur: if a BWP-InactivityTimer is configured for an activated serving cell, if the Default-DL-BWP is configured and the active DL BWP is not the BWP indicated by the Default-DL-BWP, if the Default-DL-BWP is not configured and the active DL BWP is not the initial BWP, if BWP-InactivityTimer associated with the active DL BWP expires, and/or if the Default-DL-BWP is configured. The MAC entity may perform BWP switching to the initial DL BWP, for example, if the MAC entity may refrain from performing BWP switching to a BWP indicated by the Default-DL-BWP.

A wireless device may be configured for operation in BWPs of a serving cell. The wireless device may be configured by higher layers for the serving cell for a set of (e.g., four) bandwidth parts (BWPs) for receptions by the wireless device (e.g., DL BWP set) in a DL bandwidth by a parameter (e.g., DL-BWP). The wireless device may be configured with a set of (e.g., four) BWPs for transmissions by the wireless device (e.g., UL BWP set) in an UL bandwidth by a parameter (e.g., UL-BWP) for the serving cell. An initial active DL BWP may be determined, for example, by: a location and number of contiguous PRBs; a subcarrier spacing; and/or a cyclic prefix (e.g., for the control resource set for a Type0-PDCCH common search space). A wireless device may be provided (e.g., by a higher layer) a parameter (e.g., initial-UL-BWP) for an initial active UL BWP for a random access procedure, for example, for operation on a primary cell. The wireless device may be provided (e.g., by a higher layer) a parameter (e.g., Active-BWP-DL-Pcell) for first active DL BWP for receptions, for example, if a wireless device has a dedicated BWP configuration. The wireless device may be provided (e.g., by a higher layer) a parameter (e.g., Active-BWP-UL-Pcell) for a first active UL BWP for transmissions on a primary cell, for example, if a wireless device has a dedicated BWP configuration.

The wireless device may be configured with a variety of parameters for a DL BWP and/or for an UL BWP in a set of DL BWPs and/or UL BWPs, respectively, for a serving cell. The wireless device may be configured with one or more of: a subcarrier spacing (e.g., provided by higher layer parameter DL-BWP-mu or UL-BWP-mu), a cyclic prefix (e.g., provided by higher layer parameter DL-BWP-CP or UL-BWP-CP), a PRB offset with respect to the PRB (e.g., determined by higher layer parameters offset-pointA-low-scs and ref-scs) and a number of contiguous PRBs (e.g., provided by higher layer parameter DL-BWP-BW or UL-BWP-BW), an index in the set of DL BWPs or UL BWPs (e.g., by respective higher layer parameters DL-BWP-index or UL-BWP-index), a DCI format 1_0 or DCI format 1_1 detection to a PDSCH reception timing values (e.g., provided by higher layer parameter DL-data-time-domain), a PDSCH reception to a HARQ-ACK transmission timing values (e.g., provided by higher layer parameter DL-data-DL-acknowledgement), and/or a DCI 0_0 or DCI 0_1 detection to a PUSCH transmission timing values (e.g., provided by higher layer parameter UL-data-time-domain).

A DL BWP from a set of configured DL BWPs (e.g., with an index provided by higher layer parameter DL-BWP-index) may be paired with an UL BWP from a set of configured UL BWPs (e.g., with an index provided by higher layer parameter UL-BWP-index). A DL BWP from a set of configured DL BWPs may be paired with an UL BWP from a set of configured UL BWPs, for example, if the DL BWP index and the UL BWP index are equal (e.g., for unpaired spectrum operation). A wireless device may not be expected to receive a configuration where the center frequency for a DL BWP is different from the center frequency for an UL BWP, for example, if the DL-BWP-index of the DL BWP is equal to the UL-BWP-index of the UL BWP (e.g., for unpaired spectrum operation).

A wireless device may be configured with CORESETs for every type of common search space and/or for wireless device-specific search space, for example, for a DL BWP in a set of DL BWPs on a primary cell. The wireless device may not be expected to be configured without a common search space on the PCell, or on the PSCell, in the active DL BWP. The wireless device may be configured with control resource sets for PUCCH transmissions, for example, for an UL BWP in a set of UL BWPs. A wireless device may receive a PDCCH message and/or a PDSCH message in a DL BWP, for example, according to a configured subcarrier spacing and/or a CP length for the DL BWP. A wireless device may transmit via a PUCCH and/or via a PUSCH in an UL BWP, for example, according to a configured subcarrier spacing and CP length for the UL BWP.

The BWP indicator field value may indicate an active DL BWP, from the configured DL BWP set, for DL receptions, for example, if a BWP indicator field is configured in DCI format 1_1. The BWP indicator field value may indicate the active UL BWP, from the configured UL BWP set, for UL transmissions. A wireless device may be provided (e.g., for the primary cell) with a higher layer parameter (e.g., Default-DL-BWP, or any other a default DL BWP among the configured DL BWPs), for example, if a BWP indicator field is configured in DCI format 0_1. The default BWP may be the initial active DL BWP, for example, if a wireless device is not provided a default DL BWP by higher layer parameter Default-DL-BWP. A wireless device may be expected to detect a DCI format 0_1 indicating active UL BWP change, or a DCI format 11 indicating active DL BWP change, for example, if a corresponding PDCCH is received within first 3 symbols of a slot.

A wireless device may be provided (e.g., for a primary cell) with a higher layer parameter (e.g., Default-DL-BWP, or any other a default DL BWP among the configured DL BWPs). The default DL BWP may be the initial active DL BWP, for example, if a wireless device is not provided a default DL BWP by the higher layer parameter Default-DL-BWP. A wireless device may be provided with a higher layer parameter (e.g., BWP-InactivityTimer) for a timer value for the primary cell. The wireless device may increment the timer, if running, every interval of 1 millisecond for frequency range 1, every 0.5 milliseconds for frequency range 2, or any other interval, for example, if the wireless device may not detect a DCI format 1_1 for paired spectrum operation or, for example, if the wireless device may not detect a DCI format 1_1 or DCI format 0_1 for unpaired spectrum operation during the interval.

Wireless device procedures on the secondary cell may be same as on the primary cell. Wireless device procedures may use the timer value for the secondary cell and the default DL BWP for the secondary cell, for example, if a wireless device is configured for a secondary cell with a higher layer parameter (e.g., Default-DL-BWP) indicating a default DL BWP among the configured DL BWPs and the wireless device is configured with a higher layer parameter (e.g., BWP-InactivityTimer) indicating a timer value. The wireless device may use the indicated DL BWP and the indicated UL BWP on the secondary cell as the respective first active DL BWP and first active UL BWP on the secondary cell or carrier, for example, if a wireless device is configured by a higher layer parameter (e.g., Active-BWP-DL-SCell) for a first active DL BWP and by a higher layer parameter (e.g., Active-BWP-UL-SCell) for a first active UL BWP on a secondary cell or carrier.

A wireless device may not be expected to transmit (e.g., for paired spectrum operation) HARQ-ACK via a PUCCH resource indicated by a DCI format 1_0 or a DCI format 1_1, for example, if the wireless device changes its active UL BWP on a PCell between a time of a detection of the DCI format 1_0 or the DCI format 1_1 and a time of a corresponding HARQ-ACK transmission on the PUCCH.A wireless device may not be expected to monitor a PDCCH if the wireless device performs radio resource management (RRM) measurements over a bandwidth that is not within the active DL BWP for the wireless device.

A base station may send (e.g., transmit) DCI via a PDCCH for at least one of: a scheduling assignment and/or grant; a slot format notification; a preemption indication; and/or a power-control command. The DCI may comprise at least one of: an identifier of a DCI format; a downlink scheduling assignment(s); an uplink scheduling grant(s); a slot format indicator; a preemption indication; a power-control for PUCCH/PUSCH; and/or a power-control for SRS.

A downlink scheduling assignment DCI may comprise parameters indicating at least one of: an identifier of a DCI format; a PDSCH resource indication; a transport format; HARQ information; control information related to multiple antenna schemes; and/or a command for power control of the PUCCH. An uplink scheduling grant DCI may comprise parameters indicating at least one of: an identifier of a DCI format; a PUSCH resource indication; a transport format; HARQ related information; and/or a power control command of the PUSCH.

Different types of control information may correspond to different DCI message sizes. Supporting multiple beams, spatial multiplexing in the spatial domain, and/or noncontiguous allocation of RBs in the frequency domain, may require a larger scheduling message, in comparison with an uplink grant allowing for frequency-contiguous allocation. DCI may be categorized into different DCI formats. A DCI format may correspond to a certain message size and/or usage.

A wireless device may monitor (e.g., in common search space or wireless device-specific search space) one or more PDCCH for detecting one or more DCI with one or more DCI format. A wireless device may monitor a PDCCH with a limited set of DCI formats, for example, which may reduce power consumption. The more DCI formats that are to be detected, the more power may be consumed by the wireless device.

The information in the DCI formats for downlink scheduling may comprise at least one of: an identifier of a DCI format; a carrier indicator; an RB allocation; a time resource allocation; a bandwidth part indicator; a HARQ process number; one or more MCS; one or more NDI; one or more RV; MIMO related information; a downlink assignment index (DAI); a TPC for PUCCH; an SRS request; and/or padding (e.g., if necessary). The MIMO related information may comprise at least one of: a PMI; precoding information; a transport block swap flag; a power offset between PDSCH and a reference signal; a reference-signal scrambling sequence; a number of layers; antenna ports for the transmission; and/or a transmission configuration indication (TCI).

The information in the DCI formats used for uplink scheduling may comprise at least one of: an identifier of a DCI format; a carrier indicator; a bandwidth part indication; a resource allocation type; an RB allocation; a time resource allocation; an MCS; an NDI; a phase rotation of the uplink DMRS; precoding information; a CSI request; an SRS request; an uplink index/DAI; a TPC for PUSCH; and/or padding (e.g., if necessary).

A base station may perform CRC scrambling for DCI, for example, before transmitting the DCI via a PDCCH. The base station may perform CRC scrambling by binarily adding multiple bits of at least one wireless device identifier (e.g., C-RNTI, CS-RNTI, TPC-CS-RNTI, TPC-PUCCH-RNTI, TPC-PUSCH-RNTI, SP CSI C-RNTI, and/or TPC-SRS-RNTI) on the CRC bits of the DCI. The wireless device may check the CRC bits of the DCI, for example, if detecting the DCI. The wireless device may receive the DCI, for example, if the CRC is scrambled by a sequence of bits that is the same as the at least one wireless device identifier.

A base station may send (e.g., transmit) one or more PDCCH in different CORESETs, for example, to support a wide bandwidth operation. A base station may transmit one or more RRC messages comprising configuration parameters of one or more CORESETs. A CORESET may comprise at least one of: a first OFDM symbol; a number of consecutive OFDM symbols; a set of resource blocks; and/or a CCE-to-REG mapping. A base station may send (e.g., transmit) a PDCCH in a dedicated CORESET for particular purpose, for example, for beam failure recovery confirmation. A wireless device may monitor a PDCCH for detecting DCI in one or more configured CORESETs, for example, to reduce the power consumption.

A base station and/or a wireless device may have multiple antennas, for example, to support a transmission with high data rate (such as in an NR system). A wireless device may perform one or more beam management procedures, as shown in FIG. 9B, for example, if configured with multiple antennas.

A wireless device may perform a downlink beam management based on one or more CSI-RSs and/or one or more SS blocks. In a beam management procedure, a wireless device may measure a channel quality of a beam pair link. The beam pair link may comprise a transmitting beam from a base station and a receiving beam at the wireless device. A wireless device may measure the multiple beam pair links between the base station and the wireless device, for example, if the wireless device is configured with multiple beams associated with multiple CSI-RSs and/or SS blocks.

A wireless device may send (e.g., transmit) one or more beam management reports to a base station. The wireless device may indicate one or more beam pair quality parameters, for example, in a beam management report. The one or more beam pair quality parameters may comprise at least one or more beam identifications; RSRP; and/or PMI, CQI, and/or RI of at least a subset of configured multiple beams.

A base station and/or a wireless device may perform a downlink beam management procedure on one or multiple Transmission and Receiving Point (TRPs), such as shown in FIG. 9B. Based on a wireless device's beam management report, a base station may send (e.g., transmit), to the wireless device, a signal indicating that a new beam pair link is a serving beam. The base station may transmit PDCCH and/or PDSCH to the wireless device using the serving beam.

A wireless device and/or a base station may trigger a beam failure recovery mechanism. A wireless device may trigger a beam failure recovery (BFR) procedure, for example, if at least a beam failure occurs. A beam failure may occur if a quality of beam pair link(s) of at least one PDCCH falls below a threshold. The threshold comprise be an RSRP value (e.g., −140 dbm, −110 dbm, or any other value) and/or a SINR value (e.g., −3 dB, −1 dB, or any other value), which may be configured in a RRC message.

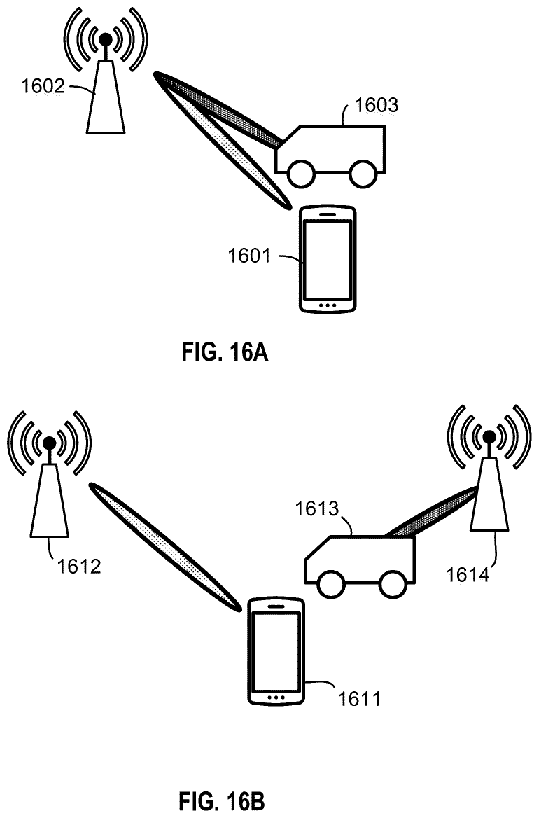

FIG. 16A shows an example of a first beam failure event. A base station 1602 may send (e.g., transmit) a PDCCH from a transmission (Tx) beam to a receiving (Rx) beam of a wireless device 1601 from a TRP. The base station 1602 and the wireless device 1601 may start a beam failure recovery procedure on the TRP, for example, if the PDCCH on the beam pair link (e.g., between the Tx beam of the base station 1602 and the Rx beam of the wireless device 1601) have a lower-than-threshold RSRP and/or SINR value due to the beam pair link being blocked (e.g., by a moving vehicle 1603, a building, or any other obstruction).

FIG. 16B shows an example of a second beam failure event. A base station may send (e.g., transmit) a PDCCH from a beam to a wireless device 1611 from a first TRP 1614. The base station and the wireless device 1611 may start a beam failure recovery procedure on a new beam on a second TRP 1612, for example, if the PDCCH on the beam is blocked (e.g., by a moving vehicle 1613, building, or any other obstruction).

A wireless device may measure a quality of beam pair links using one or more RSs. The one or more RSs may comprise one or more SS blocks and/or one or more CSI-RS resources. A CSI-RS resource may be determined by a CSI-RS resource index (CRI). A quality of beam pair links may be indicated by, for example, an RSRP value, a reference signal received quality (e.g., RSRQ) value, and/or a CSI (e.g., SINR) value measured on RS resources. A base station may indicate whether an RS resource, used for measuring beam pair link quality, is QCLed (Quasi-Co-Located) with DM-RSs of a PDCCH. The RS resource and the DM-RSs of the PDCCH may be QCLed, for example, if the channel characteristics from a transmission on an RS to a wireless device, and that from a transmission on a PDCCH to the wireless device, are similar or same under a configured criterion. The RS resource and the DM-RSs of the PDCCH may be QCLed, for example, if Doppler shift and/or Doppler shift of the channel from a transmission on an RS to a wireless device, and that from a transmission on a PDCCH to the wireless device, are the same.

A wireless device may monitor a PDCCH on M beams (e.g. 2, 4, 8) pair links simultaneously, where M≥1 and the value of M may depend at least on capability of the wireless device. Monitoring a PDCCH may comprise detecting DCI via the PDCCH transmitted on common search spaces and/or wireless device specific search spaces. Monitoring multiple beam pair links may increase robustness against beam pair link blocking. A base station may send (e.g., transmit) one or more messages comprising parameters indicating a wireless device to monitor PDCCH on different beam pair link(s) in different OFDM symbols.

A base station may send (e.g., transmit) one or more RRC messages and/or MAC CEs comprising parameters indicating Rx beam setting of a wireless device for monitoring PDCCH on multiple beam pair links. A base station may send (e.g., transmit) an indication of a spatial QCL between DL RS antenna port(s) and DL RS antenna port(s) for demodulation of DL control channel. The indication may comprise a parameter in a MAC CE, an RRC message, DCI, and/or any combinations of these signaling.

A base station may indicate spatial QCL parameters between DL RS antenna port(s) and DM-RS antenna port(s) of DL data channel, for example, for reception of data packet on a PDSCH. A base station may send (e.g., transmit) DCI comprising parameters indicating the RS antenna port(s) are QCLed with DM-RS antenna port(s).

A wireless device may measure a beam pair link quality based on CSI-RSs QCLed with DM-RS for PDCCH, for example, if a base station sends (e.g., transmits) a signal indicating QCL parameters between CSI-RS and DM-RS for PDCCH. The wireless device may start a BFR procedure, for example, if multiple contiguous beam failures occur.

A wireless device may send (e.g., transmit) a BFR signal on an uplink physical channel to a base station, for example, if starting a BFR procedure. The base station may send (e.g., transmit) DCI via a PDCCH in a CORESET, for example, after or in response to receiving the BFR signal on the uplink physical channel. The wireless may determine that the BFR procedure is successfully completed, for example, after or in response to receiving the DCI via the PDCCH in the CORESET.

A base station may send (e.g., transmit) one or more messages comprising configuration parameters of an uplink physical channel, or signal, for transmitting a beam failure recovery request. The uplink physical channel or signal may be based on one of: a contention-free PRACH (BFR-PRACH), which may be a resource orthogonal to resources of other PRACH transmissions; a PUCCH (e.g., BFR-PUCCH); and/or a contention-based PRACH resource (e.g., CF-PRACH). Combinations of these candidate signals and/or channels may be configured by the base station. A wireless device may autonomously select a first resource for transmitting the BFR signal, for example, if the wireless device is configured with multiple resources for a BFR signal. The wireless device may select a BFR-PRACH resource for transmitting a BFR signal, for example, if the wireless device is configured with the BFR-PRACH resource, a BFR-PUCCH resource, and/or a CF-PRACH resource. The base station may send (e.g., transmit) a message to the wireless device indicating a resource for transmitting the BFR signal, for example, if the wireless device is configured with a BFR-PRACH resource, a BFR-PUCCH resource, and/or a CF-PRACH resource.

A base station may send (e.g., transmit) a response to a wireless device, for example, after receiving one or more BFR signals. The response may comprise the CRI associated with the candidate beam that the wireless device may indicate in the one or multiple BFR signals.

A base station may configure a wireless device with one or more TCI-States using and/or via higher layer signaling. A number (e.g., quantity, plurality, etc.) of the one or more TCI-States may depend on a capability of the wireless device. The wireless device may use the one or more TCI-States to decode a PDSCH based on a detected PDCCH. Each of the one or more TCI-States state may include one RS set TCI-RS-SetConfig. The one RS set TCI-RS-SetConfig may contain one or more parameters. The one or more parameters may be used, for example, to configure quasi co-location relationship between one or more reference signals in the RS set and the DM-RS port group of the PDSCH. The one RS set may contain a reference to either one or two DL RSs and an associated quasi co-location type (QCL-Type) for each one as configured by the higher layer parameter QCL-Type. QCL-Types associated with two DL RSs may not necessarily be the same, for example, if the one RS set contains a reference to the two DL RSs. The references of the two DL RSs may be, for example, to a same DL RS or to different DL RSs. The QCL-Types indicated to the wireless device may be based on a higher layer parameter QCL-Type. The higher layer parameter QCL-Type may take one or a combination of the following types: QCL-TypeA′: {Doppler shift, Doppler spread, average delay, delay spread}, QCL-TypeB′: {Doppler shift, Doppler spread}, QCL-TypeC′: {average delay, Doppler shift} and QCL-TypeD′: {Spatial Rx parameter}.

A wireless device may receive an activation command. The activation command may be used to map one or more TCI states to one or more codepoints of a TCI field in DCI. The wireless device may assume that one or more antenna ports of one DM-RS port group of a PDSCH of a serving cell are spatially quasi co-located with an SSB, for example, (i) before the wireless device receives the activation command and/or (ii) after the wireless device receives a higher layer configuration of TCI-States. The SSB may be determined in an initial access procedure with respect to one or more of a Doppler shift, a Doppler spread, an average delay, a delay spread, and spatial Rx parameters, where applicable.

A wireless device may be configured by a base station, with a higher layer parameter TCI-PresentInDCI. If the higher layer parameter TCI-PresentInDCI is set as ‘Enabled’ for a CORESET scheduling a PDSCH, the wireless device may assume that a TCI field is present in a DL DCI of a PDCCH transmitted on the CORESET. If the higher layer parameter TCI-PresentInDCI is set as ‘Disabled’ for a CORESET scheduling a PDSCH or if the PDSCH is scheduled by a DCI format 1_0 the wireless device may assume, for determining PDSCH antenna port quasi co-location, that a TCI state for the PDSCH is identical to the TCI state applied for the CORESET used for the PDCCH transmission.

The wireless device may use one or more TCI-States according to a value of a TCI field in a detected PDCCH with DCI for determining PDSCH antenna port quasi co-location if the higher layer parameter TCI-PresentInDCI is set as ‘Enabled’. The wireless device may assume that antenna ports of one DM-RS port group of a PDSCH of a serving cell are quasi co-located with one or more RS(s) in an RS set with respect to QCL type parameter(s) given by the indicated TCI state if a time offset between the reception of the DL DCI and the corresponding PDSCH is equal to or greater than a threshold Threshold-Sched-Offset. The threshold may be based on, for example, wireless device capability. The wireless device may assume that antenna ports of one DM-RS port group of a PDSCH of a serving cell are quasi co-located based on a TCI state used for PDCCH quasi co-location indication of the lowest CORESET-ID in the latest slot in which one or more CORESETs are configured for the wireless device, if (i) the offset between reception of the DL DCI and the corresponding PDSCH is less than a threshold Threshold-Sched-Offset and/or if (ii) the higher layer parameter TCI-PresentInDCI=‘Enabled’ or the higher layer parameter TCI-PresentInDCI=‘Disabled’. The wireless device may obtain the other QCL assumptions from the indicated TCI states for its scheduled PDSCH, irrespective of a time offset between the reception of the DL DCI and the corresponding PDSCH, if all configured TCI states do not contain QCL-TypeD′.

A base station and/or a wireless device may perform one or more beam management procedures, for example, if the base station and/or the wireless device are configured with multiple beams (e.g., in system such as in an NR system). The wireless device may perform a BFR procedure (e.g., send one or more BFR signals), for example, if one or more beam pair links between the base station and the wireless device fail.

A wireless device may receive one or more RRC messages that comprise BFR parameters. The one or more RRC messages may comprise one or more of an RRC connection reconfiguration message, an RRC connection reestablishment message, and/or an RRC connection setup message. The wireless device may detect at least one beam failure according to at least one of BFR parameters and trigger a BFR procedure. The wireless device may start a first timer, if configured, in response to detecting the at least one beam failure. The wireless device may select a beam (e.g., a selected beam) in response to detecting the at least one beam failure. The selected beam may be a beam with good channel quality (e.g., determined based on RSRP, SINR, or BLER, etc.) from a set of candidate beams. The set of candidate beams may be identified by a set of reference signals (e.g., SSBs, or CSI-RSs). The wireless device may transmit at least a first BFR signal to a base station in response to selecting the selected beam. The at least first BFR signal may be associated with the selected beam. The at least first BFR signal may be, for example, a preamble transmitted on a PRACH resource, or an SR signal transmitted on a PUCCH resource, or a beam indication transmitted on a PUCCH/PUSCH resource. The wireless device may transmit the at least first BFR signal with a transmission beam corresponding to a receiving beam associated with the selected beam. The wireless device, may, for example, determine transmission beam by using the RF and/or digital beamforming parameters corresponding to the receiving beam. The wireless device may start a response window in response to transmitting the at least first BFR signal. The response window may be tracked using, for example, a timer with a value configured by the base station. The wireless device may monitor a PDCCH in a first CORESET while the response window is running. The first CORESET may be associated with the BFR procedure. The wireless device may monitor the PDCCH in the first CORESET in condition of transmitting the at least first BFR signal. The wireless device may receive a first DCI via the PDCCH in the first CORESET while the response window is running. The wireless device may consider the BFR procedure successfully completed if the wireless device receives the first DCI via the PDCCH in the first CORESET before the response window expires. The wireless device may stop the first timer, if configured, if the BFR procedure is successfully completed.

The wireless device may increment a transmission number if a response window expires and if the wireless device does not receive a DCI. The transmission number is initialized, for example, to a first number (e.g., 0) before a BFR procedure is triggered. If the transmission number indicates a number less than a configured maximum transmission number, the wireless device may repeat one or more actions comprising at least one of: a BFR signal transmission, starting a response window, monitoring a PDCCH, and incrementing the transmission number if no response received during the response window is running. If the transmission number indicates a number equal or greater than the configured maximum transmission number, the wireless device may determine that the BFR procedure was unsuccessful.

A wireless device may trigger an SR for requesting a UL-SCH resource, for example, if the wireless device has a new transmission. A base station may transmit, to a wireless device, at least one message comprising parameters indicating zero, one, or more SR configurations. An SR configuration may comprise a set of PUCCH resources for SRs on one or more BWPs, and/or one or more cells. A PUCCH resource (e.g., at most one PUCCH resource) for an SR may be configured on a BWP (e.g., one BWP). Each SR configuration may correspond to one or more logical channels. Each logical channel may be mapped to zero or one SR configuration configured by the at least one message. An SR configuration of a logical channel (LCH) that triggers a buffer status report (BSR) may be considered, for example, as a corresponding SR configuration for a triggered SR.

The at least one message may further comprise, for each SR configuration, one or more parameters indicating at least one of: an SR prohibit timer, a maximum number of SR transmissions, a parameter indicating a periodicity and an offset of an SR transmission, and/or a PUCCH resource. The SR prohibit timer may be, for example, a duration during which the wireless device may be not allowed to transmit the SR. The maximum number of SR transmission may be, for example, a maximum number of SR transmissions that are allowed for the wireless device.

A PUCCH resource may be identified by one or more of at least: a frequency location (e.g., a starting PRB), a PUCCH format associated with an initial cyclic shift of a base sequence, and a time domain location (e.g., a starting symbol index). A PUCCH format may be, for example, one of a PUCCH format 0, a PUCCH format 1, a PUCCH format 2, a PUCCH format 3, and/or a PUCCH format 4. A PUCCH format 0 may occupy 1 or 2 OFDM symbols and is less than or equal to 2 bits. A PUCCH format 1 may occupy between 4 and 14 OFDM symbols and is less than or equal to 2 bits. A PUCCH format 2 may occupy 1 or 2 OFDM symbols and is greater than 2 bits. A PUCCH format 3 may occupy between 4 and 14 OFDM symbols and is greater than 2 bits. A PUCCH format 4 may occupy between 4 and 14 OFDM symbols and is greater than 2 bits.

A PUCCH format for an SR transmission may be a PUCCH format 0, or a PUCCH format 1. A wireless device may transmit a PUCCH in a PUCCH resource for a corresponding SR configuration, for example, only if the wireless device transmits a positive SR. For a positive SR transmission using PUCCH format 0, a wireless device may transmit a PUCCH by setting a cyclic shift to a first value (e.g., 0). For a positive SR transmission using PUCCH format 1, a wireless device may transmit a PUCCH by setting a first bit, before BPSK modulation on a sequence, to a first value (e.g., 0).

An SR may be multiplexed, for example, with a HARQ-ACK or a CSI on a PUCCH format. A wireless device may decide a cyclic shift of a base sequence based on the initial cyclic shift and a first cyclic shift based on one or more values of one or more HARQ-ACK bits, if a positive SR is multiplexed with an HARQ-ACK. A wireless device may decide a cyclic shift of the base sequence based on the initial cyclic shift and a second cyclic shift based on one or more values of the one or more HARQ-ACK bits, if a negative SR is multiplexed with HARQ-ACK. The first cyclic shift may be different from the second cyclic shift.

A wireless device may maintain an SR transmission counter (e.g., an SR_COUNTER) associated with an SR configuration. A wireless device may set the SR_COUNTER of the SR configuration to a first value (e.g., 0) if an SR of an SR configuration is triggered, and there are no other SRs pending corresponding to the same SR configuration.

A wireless device may consider a triggered SR pending until it is cancelled. All pending SR(s) may be cancelled, for example, if one or more UL grants accommodate all pending data available for transmission.

A wireless device may determine one or more PUCCH resources on an active BWP as valid PUCCH resources at a time of an SR transmission occasion. A wireless device may transmit a PUCCH in a PUCCH resource associated with an SR configuration if the wireless device transmits a positive SR. A wireless device may transmit the PUCCH using PUCCH format 0, or PUCCH format 1, according to a PUCCH configuration.

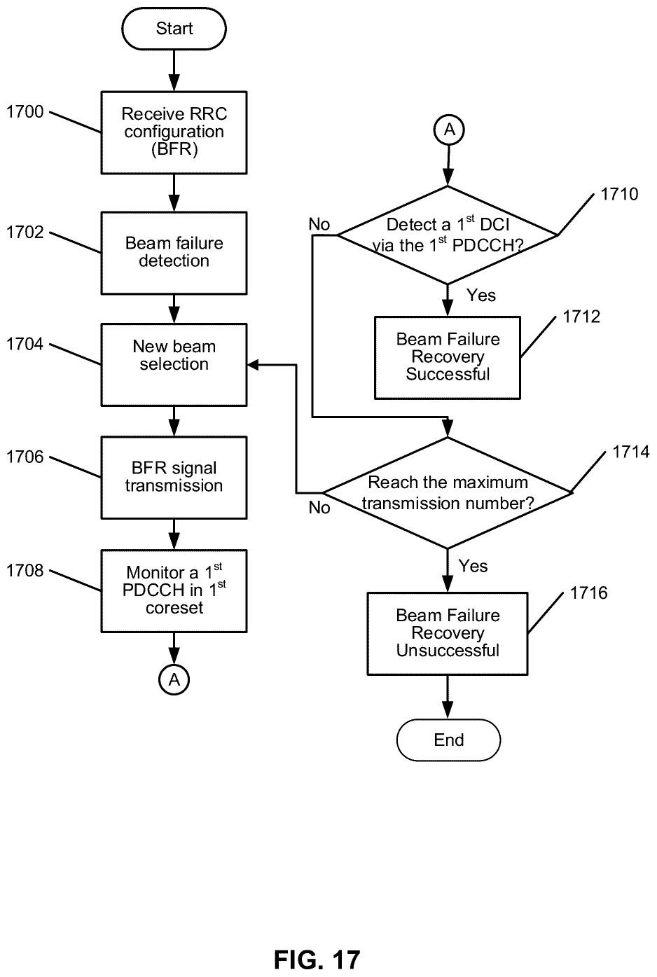

FIG. 17 shows an example of a BFR procedure. In some communication systems, a wireless device may stop a BWP inactivity timer if a random access procedure is initiated, and/or the wireless device may restart the BWP inactivity timer if the random access procedure is successfully completed (e.g., based on or in response to receiving DCI addressed to a C-RNTI of the wireless device). At step 1700, a wireless device may receive one or more RRC messages comprising BFR parameters. At step 1702, the wireless device may detect at least one beam failure according to at least one BFR parameter. The wireless device may start a first timer, if configured, based on detecting the at least one beam failure. At step 1704, the wireless device may select a beam (e.g., a selected beam) based on detecting the at least one beam failure. The selected beam may be a beam with good channel quality (e.g., based on RSRP, SINR, and/or BLER) that may be selected from a set of candidate beams. The candidate beams may be indicated by a set of reference signals (e.g., SSBs, or CSI-RSs). At step 1706, the wireless device may send (e.g., transmit) at least a first BFR signal to a base station, for example, based on selecting the beam (e.g., selected beam). The at least first BFR signal may be associated with the selected beam. The wireless device may send (e.g., transmit) the at least first BFR signal with a transmission beam corresponding to a receiving beam associated with the selected beam. The at least first BFR signal may be a preamble sent (e.g., transmitted) via a PRACH resource, an SR signal sent (e.g., transmitted) via a PUCCH resource, a beam failure recovery signal sent (e.g., transmitted) via a PUCCH resource, and/or a beam report sent (e.g., transmitted) via a PUCCH and/or PUSCH resource. At step 1708, the wireless device may start a response window, for example, based on sending (e.g., transmitting) the at least first BFR signal. The response window may be associated with a timer with a value configured by the base station. The wireless device may monitor a PDCCH in a first CORESET, for example, if the response window is running. The first CORESET may be configured by the BFR parameters (e.g., RRC). The first CORESET may be associated with the BFR procedure. The wireless device may monitor the PDCCH in the first CORESET in condition of transmitting the at least first BFR signal.

At step 1710, the wireless device may detect (e.g., receive) a first DCI via the PDCCH in the first CORESET, for example, if the response window is running. At step 1712, the wireless device may determine that the BFR procedure has successfully completed, for example, if the wireless device receives the first DCI via the PDCCH in the first CORESET before the response window expires. The wireless device may stop the first timer, if configured, based on the BFR procedure successfully being completed. The wireless device may stop the response window, for example, based on the BFR procedure successfully being completed. If the response window expires, and the wireless device does not receive the DCI (e.g., at step 1710), the wireless device may, at step 1714, increment a transmission number. The transmission number may be initialized to a first number (e.g., 0) before the BFR procedure is triggered. At step 1714, if the transmission number indicates a number less than the configured maximum transmission number, the wireless device may repeat one or more actions (e.g., at step 1704). The one or more actions to be repeated may comprise at least one of a BFR signal transmission, starting the response window, monitoring the PDCCH, and/or incrementing the transmission number, for example, if no response received during the response window is running. At step 1716, if the transmission number indicates a number equal or greater than the configured maximum transmission number, the wireless device may declare the BFR procedure is unsuccessfully completed.

A MAC entity of a wireless device may be configured by an RRC message, for example, for a beam failure recovery procedure. The beam failure recovery procedure may be used for indicating to a serving base station of a new synchronization signal block (SSB) and/or CSI-RS, for example, if a beam failure is detected. The beam failure may be detected on one or more serving SSB(s) and/or CSI-RS(s) of the serving base station. The beam failure may be detected by counting a beam failure instance indication from a lower layer of the wireless device (e.g., PHY layer) to the MAC entity.

An RRC message may configure a wireless device with one or more parameters (e.g., in BeamFailureRecoveryConfig) for a beam failure detection and recovery procedure. The one or more parameters may comprise one or more of: beamFailurelnstanceMaxCount for a beam failure detection, beamFailureDetectionTimer for the beam failure detection, an RSRP threshold (e.g., beamFailureCandidateBeamThreshold) for a beam failure recovery, preamblePowerRampingStep for the beam failure recovery, preambleReceivedTargetPower for the beam failure recovery, preambleTxMax for the beam failure recovery, and/or ra-ResponseWindow. The ra-ResponseWindow may be a time window to monitor one or more responses for the beam failure recovery using a contention-free RA preamble.

A wireless device may use at least one wireless device variable for a beam failure detection. BFI_COUNTER may be one of the at least one wireless device variable. The BFI_COUNTER may be a counter for a beam failure instance indication. The BFI_COUNTER may be initially set to zero. The wireless device may start or restart beamFailureDetectionTimer, for example, if a MAC entity of a wireless device receives a beam failure instance indication from a lower layer (e.g., PHY) of the wireless device. The wireless device may increment BFI_COUNTER, for example, in addition to starting or restarting the beamFailureDetectionTimer. The wireless device may initiate a random access procedure (e.g., on an SpCell) based on the BFI_COUNTER being equal to beamFailurelnstanceMaxCount+1. The wireless device may use the one or more parameters in the BeamFailureRecoveryConfig, for example, based on the initiating the random access procedure. The wireless device may set the BFI_COUNTER to zero, for example, if the beamFailureDetectionTimer expires. The wireless device may determine that the beam failure recovery procedure has successfully completed, for example, if the random access procedure is successfully completed.

A MAC entity may start ra-ResponseWindow at a first PDCCH occasion from the end of the transmitting the contention-free random access preamble, for example, if a MAC entity of a wireless device sends (e.g., transmits) a contention-free random access preamble for a BFR procedure). The ra-ResponseWindow may be configured in BeamFailureRecoveryConfig. The wireless device may monitor at least one PDCCH (e.g., of an SpCell) for a response to the beam failure recovery request, for example, if the ra-ResponseWindow is running. The beam failure recovery request may be identified by a C-RNTI. The wireless device may determine that a random access procedure has successfully completed, for example, if a MAC entity of a wireless device receives, from a lower layer of the wireless device, a notification of a reception of at least one PDCCH transmission, and if the at least one PDCCH transmission is addressed to a C-RNTI, and/or if a contention-free random access preamble for a beam failure recovery request is transmitted by the MAC entity.

A wireless device may initiate a contention-based random access preamble for a beam failure recovery request. A MAC entity of the wireless device may start ra-ContentionResolutionTimer, for example, if the wireless device transmits Msg3. The ra-ContentionResolutionTimer may be configured by RRC. Based on the starting the ra-ContentionResolutionTimer, the wireless device may monitor at least one PDCCH if the ra-ContentionResolutionTimer is running. The wireless device may consider the random access procedure successfully completed, for example, if the MAC entity receives, from a lower layer of the wireless device, a notification of a reception of the at least one PDCCH transmission, if a C-RNTI MAC-CE is included in the Msg3, if a random access procedure is initiated for a beam failure recovery, and/or the at least one PDCCH transmission is addressed to a C-RNTI of the wireless device. The wireless device may stop the ra-ContentionResolutionTimer, for example, based on the random access procedure being successfully completed. The wireless device may determine that the beam failure recovery has successfully completed, for example, if a random access procedure of a beam failure recovery is successfully completed.

A wireless device may be configured (e.g., for a serving cell) with a first set of periodic CSI-RS resource configuration indexes by a higher layer parameter (e.g., Beam-Failure-Detection-RS-ResourceConfig). The wireless device may be configured with a second set of CSI-RS resource configuration indexes and/or SS/PBCH block indexes by a higher layer parameter (e.g., Candidate-Beam-RS-List). The first set of CSI-RS resource configuration indexes and/or SS/PBCH block indexes and/or the second set of CSI-RS resource configuration indexes and/or SS/PBCH block indexes may be used for radio link quality measurements on the serving cell. The wireless device may determine a first set to include SS/PBCH block indexes and periodic CSI-RS resource configuration indexes, for example, if a wireless device is not provided with higher layer parameter Beam-Failure-Detection-RS-ResourceConfig. The SS/PBCH block indexes and the periodic CSI-RS resource configuration indexes may comprise the same values as one or more RS indexes in one or more RS sets. The one or more RS indexes in the one or more RS sets may be indicated by one or more TCI states. The one or more TCI states may be used for respective control resource sets for which the wireless device may be configured to monitor a PDCCH. The wireless device may expect a single port RS in the first set.

A first threshold (e.g., Qout,LR) may correspond to a first default value of a first higher layer parameter (e.g., RLM-IS-OOS-thresholdConfig). A second threshold (e.g., Qin,LR) may correspond to a second default value of a higher layer parameter (e.g., Beam-failure-candidate-beam-threshold). A physical layer in the wireless device may compare a first radio link quality according to the first set of periodic CSI-RS resource configurations with the first threshold. For the first set, the wireless device may assess the first radio link quality based on periodic CSI-RS resource configurations or SS/PBCH blocks. The periodic CSI-RS resource configurations and/or the SS/PBCH blocks may be associated (e.g., quasi co-located) with at least one DM-RS of a PDCCH that may be monitored by the wireless device. The wireless device may apply the second threshold to a first L1-RSRP for SS/PBCH blocks. The wireless device may apply the second threshold to a second L1-RSRP for periodic CSI-RS resources, for example after scaling a respective CSI-RS reception power with a value provided by a higher layer parameter (e.g., Pc_SS).

A physical layer in a wireless device may, for example, in slots for which the first radio link quality according to the first set is assessed, provide an indication to higher layers (e.g., MAC layer). The wireless device may provide an indication to higher layers, for example, if the first radio link quality for all corresponding resource configurations in the first set is less than the first threshold. The wireless device may use the corresponding resource configurations in the first set to assess the first radio link quality. The physical layer may inform the higher layers (e.g., MAC, RRC), for example, if the first radio link quality is less than the first threshold with a first periodicity. The first periodicity may be determined by a maximum of the shortest periodicity of periodic CSI-RS configurations or SS/PBCH blocks in the first set and a time value (e.g., 2 ms or any other duration). Based on a request from higher layers (e.g., MAC layer), a wireless device may provide to higher layers the periodic CSI-RS configuration indexes and/or the SS/PBCH block indexes from the second set. The wireless device may provide, to higher layers, corresponding L1-RSRP measurements that may be greater than or equal to the second threshold.

A wireless device may be configured with one CORESET, for example, by a higher layer parameter (e.g., Beam-failure-Recovery-Response-CORESET). The wireless device may be configured with an associated search space that may be provided by a higher layer parameter (e.g., search-space-config). The associated search space may be used for monitoring a PDCCH in the one control resource set. The wireless device may receive from higher layers (e.g., MAC layer), by a parameter (e.g., Beam-failure-recovery-request-RACH-Resource), a configuration for a PRACH transmission. For the PRACH transmission in slot n and based on antenna port quasi co-location parameters associated with periodic CSI-RS configuration or SS/PBCH block with a first RS index, the wireless device may monitor the PDCCH for detection of a DCI format starting from a slot (e.g., slot n+4) within a window. The window may be configured by a higher layer parameter (e.g., Beam-failure-recovery-request-window). The DCI format may be CRC scrambled by a C-RNTI. For a PDSCH reception, the wireless device may use the antenna port quasi-collocation parameters (e.g., as for monitoring the PDCCH) until the wireless device receives, by higher layers, an activation for a TCI state or a parameter (e.g., TCI-StatesPDCCH).

A base station and/or a wireless device may perform a PRACH-based BFR procedure. The base station and/or the wireless device may perform a PRACH-based BFR procedure, for example, if at least one beam failure instance is identified, and/or if a beam correspondence exists between the base station and the wireless device. A wireless device may send (e.g., transmit) an uplink signal, using a transmission beam corresponding to a receiving beam for receiving a downlink signal from the base station, for example, if a beam correspondence exists. The wireless device may determine RF and/or digital beamforming parameters for receiving the downlink signal, for example, if the wireless device identifies the receiving beam. The wireless device may determine the transmission beam by using the RF and/or digital beamforming parameters corresponding to the receiving beam. Beamforming parameters (e.g., beam weight factors on antenna elements, or other parameters) corresponding to the transmission beam may be same as beamforming parameters corresponding to the receiving beam. Transceiver design may be simplified, for example, if the base station need not necessarily indicate the transmission beam used for a downlink transmission or an uplink transmission, which may reduce signaling overhead. A wireless device may, for example, avoid uplink beam sweeping such as to help a base station find a proper uplink beam, which may reduce the power consumption of the wireless device. The proper beam may be in the direction of the wireless device (e.g., from the base station). Beam correspondence may exist, for example, in a TDD case, if transmission and reception share a same set of physical antenna elements, and/or if transmission and reception have a same or similar beam width.

A beam correspondence may not exist, for example, if a physical antenna for transmission is separated from a physical antenna for reception, and/or if the beam widths corresponding to transmission and reception are different. A wireless device may not determine a transmission beam based on a receiving beam, for example, if a beam correspondence does not exist. A base station may, for example, explicitly indicate a transmission beam for PUCCH and/or PUSCH transmission via an RRC message, a MAC CE, and/or DCI. A base station and/or a wireless device may not perform a PRACH-based BFR procedure if, for example, at least one beam failure instance is identified and/or if a beam correspondence does not exist.

In some PRACH-based BFR procedures, even if a beam correspondence does not exist, a wireless device may still determine a transmission beam for PRACH preamble transmission based on a receiving beam for receiving a downlink signal. The base station may not detect the PRACH preamble because the base station, determining that no beam correspondence exists, may not expect an uplink transmission on the transmission beam used for transmission of the PRACH preamble. The PRACH-based BFR procedure may result in an unsuccessful beam failure recovery, for example, if the base station may not detect the PRACH preamble. An unsuccessful beam failure recovery may lead to a radio link failure.

A wireless device may send (e.g., transmit) a PUCCH signal to a base station indicating that a BFR procedure is triggered, for example, if at least one beam failure instance is identified and/or if beam correspondence does not exist. A transmission beam for the PUCCH signal may be indicated by an RRC message, a MAC CE, and/or DCI. HARQ may not be supported in existing PUCCH transmission. A wireless device may send (e.g., transmit), for example, a CSI report to a base station via a PUCCH resource. The base station may not send (e.g., transmit) a response to the wireless device to confirm reception of the CSI report, for example, even if the base station receives the CSI report. A wireless device may send (e.g., transmit), for example, a HARQ-ACK feedback to a base station via a PUCCH resource. The base station may not send (e.g., transmit) a response to the wireless device to confirm reception of the HARQ-ACK feedback. For a BFR procedure, a wireless device may expect a response from a base station after the wireless device sends (e.g., transmits) a PUCCH signal to the base station. The wireless device may determine to repeat transmission of the PUCCH signal, for example, if no response is received from the base station. A mechanism for a base station's response to a PUCCH signal transmission may be used to avoid repeated transmissions. The base station's confirmation may ensure that the wireless device and the base station interact properly to complete the BFR procedure. An SR-based BFR procedure, and/or an SR-like BFR procedure, may be enhanced, for example, if beam correspondence does not exist.

An SR configuration may correspond to at least one logical channel in at least some SR configurations. An SR configuration may be associated with multiple parameters corresponding to at least one of: an SR prohibit timer, a maximum number of SR transmissions, a parameter indicating a periodicity, offset of the SR transmissions, and/or a PUCCH resource.

An SR configuration for a BFR procedure may be different, for example, from an SR configuration associated with at least one logical channel. A wireless device may send (e.g., transmit) a pending SR, for example, up to any first number of times (e.g., up to 64 times or any other value) for the SR configuration associated with the at least one logical channel. A wireless device may send (e.g., transmit) an SR, for example, up to any second number of times (e.g., up to 200 times or any other value) for the SR configuration for the BFR procedure considering that beam correspondence may not exist. The first number of times may be less than, equal to, or greater than the second number of times. A response window for a BFR procedure, for example, may be shorter than a response window for an SR for requesting an UL-SCH resource. A response timer associated with the BFR procedure, for example, may be a first number of slots (e.g., up to 80 or any other number of slots) subject to a first configuration. An SR prohibit timer for an SR configuration for requesting an UL-SCH resource, for example, may be a second number of slots (e.g., up to 128 ms or any other value of time of number of slots) subject to second configuration. An SR configuration for a BFR procedure may be separately or independently configured from an SR configuration for requesting an UL-SCH resource. An SR procedure triggered by the BFR procedure may, for example, be different from an SR procedure for requesting UL-SCH resource (e.g., BSR triggered).

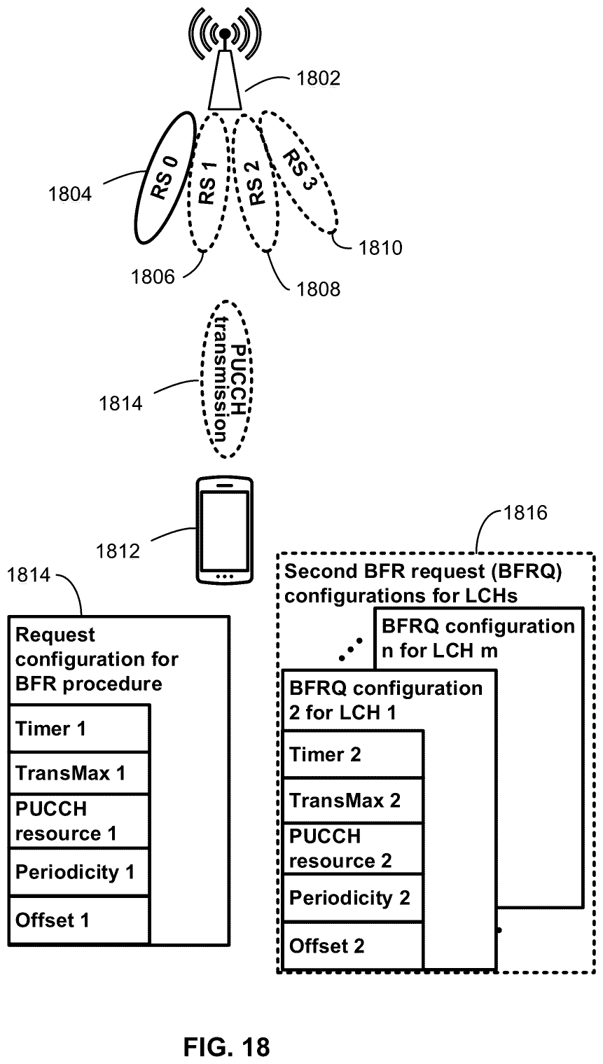

FIG. 18 shows an example of a PUCCH-based BFR procedure. A base station 1802 may transmit at least one message, comprising parameters indicating a first set of RSs (e.g., RS 0 1804) and a second set of RSs (e.g., RS 1 1806, RS 2 1808, and RS 3 1810), to a wireless device 1812. The at least one message may be an RRC message (e.g., an RRC connection reconfiguration message, an RRC connection reestablishment message, and/or an RRC connection setup message). The first set of RSs may identify one or more beams QCLed with a beam on which the base station 1802 transmits PDCCH and/or PDSCH signals. The second set of RSs may identify one or more candidate beams from which the wireless device 1812 may select a candidate beam with quality better than a first threshold, for example, if the one or more beams associated with the first set of RSs fail. Each RS in the first set and/or second set of RSs may be an SSB, or a CSI-RS. The first threshold may be a configured value based on one or more of a BLER, a SINR, and/or an L1-RSRP. One or more beams associated with the first set of RSs may fail, for example, if one or more measurements on the first set of RSs is worse than a configured second threshold (e.g., RSRP, and/or BLER).

The at least one message transmitted by the base station 1802 may comprise configuration parameters. The configuration parameters may indicate, for example, a first request (e.g., a scheduling request, a beam failure request, and/or a beam request) configuration 1814, and/or at least a second SR configuration 1816. The first request configuration 1814 may be associated with at least one of: a first PUCCH resource, a first timer with a first value, a first transmission number, a first periodicity for a transmission of the first request, and/or a first offset for a transmission of the first request. The at least second SR configuration 1816 may be associated with at least one of: a second PUCCH resource, a second timer with a second value, a second transmission number, a second periodicity, and/or a second offset. The at least second SR configuration may be associated with at least one logical channel.

The first value for the first timer may be different from the second value of the second timer. The first transmission number may be different from the second transmission number. The first periodicity may be different from the second periodicity. The first offset may be different from the second offset. The first PUCCH resource may be different from the second PUCCH resource. The wireless device may maintain a first counter for the first request configuration. The wireless device may maintain a second counter for each of the at least second SR configuration.

The at least one message may comprise parameters indicating a first CORESET, and at least a second CORESET. The first CORESET may be associated with the first request configuration. The second CORESET may be associated with the second request configuration. The wireless device may monitor a first PDCCH on the first CORESET, for example, if the wireless device transmits a first request on the first PUCCH resource for a BFR procedure. The wireless device may monitor a second PDCCH on the at least second CORESET, for example, if the wireless device transmits a second SR of the at least second SR configuration.

A base station may send (e.g., transmit), to a wireless device, one or more messages comprising configuration parameters of one or more cells. The one or more cells may comprise at least one PCell and/or PSCell, and one or more SCells. An SpCell (e.g., PCell or PSCell) and one or more SCells may operate on different frequencies and/or different bands. An SCell may support a multi-beam operation. In the multi-beam operation, a wireless device may perform one or more beam management procedures (e.g., a beam failure recovery procedure) on the SCell. The wireless device may perform a BFR procedure, for example, if at least one of one or more beam pair links between the SCell and the wireless device fails. Some BFR procedures may result in inefficiencies if there is a beam failure for one of the one or more SCells.

A wireless device may receive one or more RRC messages comprising parameters corresponding to one or more SR configurations. For each of the one or more SR configurations, the parameters may indicate at least one of: an SR prohibit timer, a maximum number of SR transmission, a parameter indicating a periodicity and offset of SR transmission, and/or a PUCCH resource identified by a PUCCH resource index. A wireless device may set a SR_COUNTER to a first value (e.g., 0), if: an SR of an SR configuration triggered (e.g., is pending), for example, after or in response to a BSR being triggered on an LCH corresponding to the SR configuration; and/or if there are no other pending SRs corresponding to the SR configuration.

A wireless device may determine whether there is at least one valid PUCCH resource for a pending SR at the time of an SR transmission occasion. The wireless device may initiate a random access procedure on a PCell, for example, if there is no valid PUCCH resource for the pending SR. The wireless device may cancel the pending SR, for example, if there is no valid PUCCH resource for the pending SR.

A wireless device may determine an SR transmission occasion on the at least one valid PUCCH resource, for example, if there is at least one valid PUCCH resource for a pending SR. The wireless device may determine the SR transmission occasion based on a periodicity and an offset of SR transmission, for example, as may be indicated in one or more RRC messages. The wireless device may wait for another SR transmission occasion, for example, if an SR prohibit timer is running. The wireless device may increment an SR_COUNTER (e.g., by one) and/or instruct a physical layer of the wireless device to signal the SR on the at least one valid PUCCH resource for the SR if: (i) the SR prohibit timer is not running, (ii) the at least one valid PUCCH resource for the SR transmission occasion does not overlap with a measurement gap, (iii) the at least one valid PUCCH resource for the SR transmission occasion does not overlap with an uplink shared channel (UL-SCH) resource, and/or (iv) the SR_COUNTER is less than the maximum number of SR transmission. The physical layer of the wireless device may transmit a PUCCH on the at least one valid PUCCH resource for the SR. The wireless device may monitor a PDCCH for detecting DCI for an uplink grant, for example, after or in response to transmitting the PUCCH. The wireless device may cancel the pending SR, and/or the wireless device may stop the SR prohibit timer, for example, if the wireless device receives one or more uplink grants that may accommodate all pending data available for transmission. The wireless device may cancel the pending SR, and/or the wireless device may stop the SR prohibit timer, for example, any time during the above SR procedure. A wireless device may repeat one or more actions (e.g., if the wireless device does not receive one or more uplink grants which may accommodate all pending data available for transmission) comprising: determining the at least one valid PUCCH resource; determining whether the SR prohibit timer is running; determining whether the SR_COUNTER is less than, equal to, or greater than a maximum number of SR transmission; incrementing the SR_COUNTER; transmitting the SR and/or starting the SR prohibit timer; and/or monitoring a PDCCH for uplink grant. A wireless device may release a PUCCH for one or more serving cells, release an SRS for the one or more serving cells, clear one or more configured downlink assignments and uplink grants, initiate a random access procedure on a PCell, and/or cancel the pending SR, for example, if the SR_COUNTER indicates a number equal to or greater than a maximum number of SR transmissions.

A wireless device may operate, for example, on or using multiple active BWPs simultaneously. A wireless device may perform one or more beam management procedures described herein (e.g., a BFR procedure) on or using one of the multiple active BWPs. The wireless device may perform a BFR procedure, for example, if at least one of one or more beam pair links of the wireless device on the one of the multiple active BWPs fails.

Some or all of the beam procedures described herein (e.g., BFR procedures) may be enhanced, for example, to improve downlink radio efficiency and/or reduce uplink signaling overhead if carrier aggregation (CA) is configured for a wireless device Some or all of the beam procedures described herein (e.g., BFR procedures) may be enhanced to improve downlink radio efficiency and/or reduce uplink signaling overhead if multiple active BWPs are configured for a cell.

A wireless device may determine and/or use at least one valid PUCCH resource for a pending SR of the wireless device. The wireless device may not transmit the pending SR, for example, if the at least one valid PUCCH resource for the pending SR overlaps with an UL-SCH resource corresponding to a TB. The wireless device may transmit the TB via the UL-SCH resource. The wireless device may delay the transmission of the pending SR, for example, until at least one valid PUCCH resource for the pending SR does not overlap with an UL-SCH resource.

A wireless device may delay a transmission of a triggered request (e.g., a scheduling request, a beam failure request, a beam request, a beam failure recovery request, PUCCH-based BFR, and/or the like, etc.) for a PUCCH-based BFR procedure, for example, until at least one valid PUCCH resource for the triggered request does not overlap with an UL-SCH resource. A beam failure recovery timer configured by an RRC message may expire and/or the PUCCH-based BFR procedure may not be successful. Unsuccessful BFR procedure(s) may result in inefficiencies and higher incidences of radio link failure(s) (RLF).

At least one valid PUCCH resource for a transmission occasion of a triggered request for a BFR procedure may overlap with an UL-SCH resource for transmission of at least TB. A base station may transmit one or more acknowledgement (ACK) signals associated with the uplink signal, for example, if the wireless device drops the triggered request and transmits an uplink signal scheduled on the UL-SCH resource. The wireless device may monitor at least one PDCCH in one or more CORESETs for the one or more ACK signals. The at least one PDCCH may fail (e.g., due to a radio link quality less than a threshold) during the BFR procedure. The wireless device may not receive the one or more ACK signals. The wireless device may retransmit the uplink signal, for example, if the wireless device does not receive the one or more ACK signals. Dropped requests, additional monitoring, failed transmissions, and/or retransmissions may result in signaling overhead, transmission latency, and wasted resources. Transmitting an uplink signal via UL-SCH during a BFR procedure, for example, may increase the transmission latency.

PUCCH-based BFR procedures may be enhanced to improve downlink radio efficiency, reduce uplink signaling overhead, and/or reduce a duration of a BFR procedure. A wireless device may, for example in legacy systems, drop an SR transmission and/or perform an UL-SCH transmission, if an SR is triggered and a valid PUCCH resource for the triggered SR overlaps with an UL-SCH resource. An SR-based BFR procedure may be used for a cell (e.g., primary cell (PCell), secondary cell (SCell), etc.). The wireless device may transmit a request (e.g., SR-like, PRACH-based, etc.) via a PUCCH resource for the BFR procedure of an SCell, for example, if the wireless device initiates a beam failure recovery (BFR) procedure for the SCell.

A wireless device may drop a request for a BFR procedure (e.g., the wireless device may not transmit a BFR signal) of the SCell if a PUCCH resource to be used for transmission of the request overlaps with an UL-SCH resource. Dropping the request for the BFR procedure may increase delay for the BFR procedure. Even if the UL-SCH transmission is performed after dropping the request, the wireless device may not receive an ACK/NACK, for the UL-SCH transmission, in the downlink control channels of the SCell (e.g., if the downlink control channels of the SCell has a beam failure). Dropping the request for the BFR procedure and/or failure to receive an ACK/NACK may lead to retransmission of the UL-SCH transmission, which may result in increased uplink interference to other cells and/or other wireless devices, increased resource/signaling overhead, and/or increased latency.

The wireless device may drop an UL-SCH transmission and perform the transmission of a request for a BFR procedure (e.g., SR-like, PRACH-based), even if the request overlaps with an UL-SCH resource. The request for a BFR procedure may, for example, be set to have a higher priority than UL-SCH transmission. By transmitting the request for a BFR procedure and dropping an UL-SCH transmission, the wireless device may reduce uplink interference to other cells and/or to other wireless device, decrease resource signaling overhead, and or decrease latency.

A wireless device may not be capable of transmitting and/or receiving with two different beams at the same time (e.g., such as a legacy device and/or a device that supports 3GPP Release 15 or earlier). The wireless device may not be able to receive a downlink control channel (e.g., PDCCH) with a first beam and a downlink shared channel (e.g., PDSCH) with a second beam, for example, if the first beam and the second beam are different and/or are not QCL-ed. Each CORESET except a dedicated beam failure recovery (BFR) coreset may be configured with a reference signal (RS) associated with a beam. A base station may configure a first CORESET with a first RS associated with a first beam and a second CORESET with a second RS associated with a second beam. The wireless device may monitor for and receive DCI in the first CORESET with the first beam and monitor for and receive DCI in the second CORESET with the second beam. The wireless device may receive the DCI with a high error rate, for example, if the wireless device attempts to receive DCI in the first CORESET with a second beam. The wireless device may not be able to decode the DCI, for example, if a high error rate occurs, which may result in a long delay for a transmission.

A wireless device may monitor and receive a DCI (e.g., beam failure recovery response) via a dedicated BFR CORESET with a candidate beam selected for a BFR procedure. The beam that the wireless device monitors and receives DCI in the dedicated BFR CORESET may change depending on the selected candidate beam. A dedicated BFR coreset that may be different from the other CORESETS may not be preconfigured with a fixed beam. The wireless device and the base station may not know which candidate beam the wireless device will chose, for example, if the wireless device initiates a BFR procedure.

The wireless device may detect a beam failure, for example, if the wireless device is monitoring the first CORESET and the second CORESET. The wireless device may monitor both a dedicated BFR CORESET for a BFR response and other (e.g., old) CORESETS (e.g., the first CORESET and the second CORESET), for example, if the wireless device initiates a BFR procedure based on the detecting the beam failure. The wireless device may not monitor the dedicated BFR CORESET, for example, before the BFR procedure is initiated.

The wireless device may transmit an uplink signal (e.g., a preamble) for a BFR procedure. The uplink signal may be associated with a selected candidate beam. The wireless device may start monitoring the dedicated BFR CORESET with the candidate beam, for example, based on or in response to transmitting the uplink signal. The wireless device may monitor the first CORESET with the first beam and the second CORESET with the second beam, for example, during the BFR procedure.

Problems may occur, for example, if the dedicated BFR CORESET overlaps, in time, with the first CORESET and/or the second CORESET. If the candidate beam is different from the first beam and/or the second beam, the wireless device may not receive DCI in the dedicated BFR CORESET and the first CORESET and/or the second CORESET. The wireless device may apply only one beam at a time (e.g., such as a legacy device and/or a device that supports 3GPP Release 15). The base station may have difficulty determining a behavior of the wireless device, which may result in a lack of synchronization between the base station and the wireless device.

Higher priority may be applied to the dedicated BFR CORESET, for example, which may address the above problem(s). The wireless device may not receive a BFR response, for example, if the wireless device monitors the dedicated BFR CORESET for a BFR response with the first beam of the first CORESET or the second beam of the second CORESET. The wireless device may have already detected a beam failure based on the quality of the first beam and the second beam, which may have been a reason why the wireless device initiated the BFR procedure. Relying on beams (e.g., the first beam and the second beam) that have a beam failure may result in decoding errors. The wireless device may not receive the BFR response, for example, if the first beam and/or the second beam is used to receive the BFR response. Such failure to receive the BFR response may increase the duration of the BFR procedure, which may increase the latency of connection reestablishment between the base station and the wireless device. The wireless device may determine a radio link failure, for example, if the latency increases (e.g., above a threshold). Radio link failure may cause communications between a base station and a wireless device to start/re-start from beginning (e.g., initial random-access, etc.) to establish communications that may take longer (e.g., much longer) than a BFR procedure.

A wireless device may monitor both a dedicated BFR CORESET and an overlapped CORESET (e.g., the first CORESET and/or the second CORESET) with the candidate beam. Such monitoring may help to ensure that the wireless device does not miss a BFR response in the dedicated BFR CORESET, while still allowing the wireless device an opportunity to detect DCI in the overlapped coreset. The wireless device may not be able to receive the DCI in the overlapped CORESET, but the wireless device may still be able to attempt to decode DCI in the overlapped CORESET.

A wireless device may monitor only a dedicated BFR CORESET with the candidate beam, and stop monitoring the overlapped CORESET (e.g., the first CORESET and/or the second CORESET). By monitoring only the dedicated BFR CORESET, the wireless device may be able to avoid missing the BFR response in the dedicated BFR CORESET. By not monitoring the overlapped CORESET, the wireless device may not consume power with the monitoring. Such monitoring of only a dedicated BFR CORESET may conserve battery power for the wireless device.

One or more component carriers (e.g., intra-band cells) may be powered by a single RF chain (e.g., such as a legacy device and/or a device that supports 3GPP Release 15). The wireless device may apply a single TX/RX spatial filter (e.g., beam) at a time for the one or more component carriers. The wireless device may not receive/transmit the first channel/RS and the second channel/RS simultaneously, for example, if a first channel/RS with a first QCL assumption overlaps with a second channel/RS with a second QCL assumption different from the first QCL assumption.

A wireless device may drop a first channel/RS with a first QCL assumption, for example, if the first channel/RS overlaps with a second channel/RS, for a BFR procedure, with a second QCL assumption different from the first QCL assumption. A wireless device may override a first channel/RS with a first QCL assumption, for example, if the first channel/RS overlaps with a second channel/RS, for a BFR procedure, with a second QCL assumption different from the first QCL assumption. Dropping and/or overriding the first channel/RS in favor of the second channel/RS may ensure that the BFR procedure is not delayed.

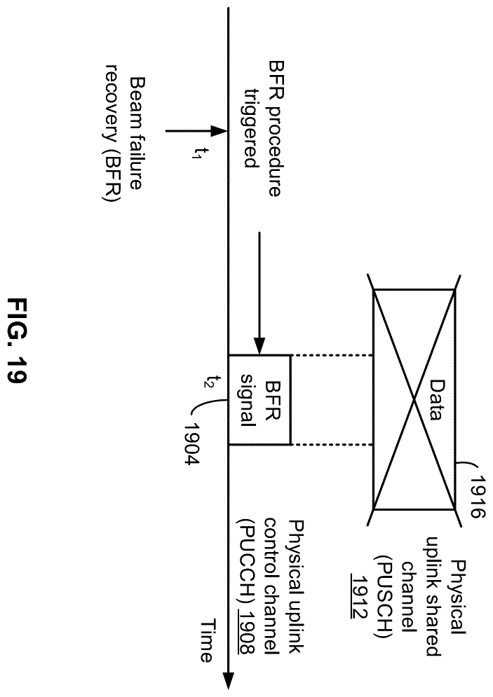

FIG. 19 shows an example BFR procedure by a wireless device. At t₁, a wireless device may detect at least one beam failure according to at least one BFR parameter and initiate a BFR procedure. The wireless device may select a beam based on detecting the at least one beam failure. The selected beam may be a beam with good channel quality (e.g., based on RSRP, SINR, and/or BLER above a threshold value) that may be selected from a set of candidate beams. At t₂, the wireless device may send (e.g., transmit) at least a BFR signal 1904 to a base station, for example, based on selecting the beam (e.g., selected beam). The BFR signal 1904 may be associated with the selected beam. The BFR signal 1904 may be transmitted on a PUCCH resource 1908. The PUCCH resource 1908 may overlap, for example, with an UL-SCH resource. The PUCCH resource 1908 may overlap, for example, with a PUSCH resource 1912 for transmission of a data 1916. The wireless device may drop transmission of the data 1916 scheduled on the PUSCH resource 1912, for example, if the PUCCH resource 1908 of the BFR signal 1904 overlaps with the PUSCH resource 1912 of the data 1916.

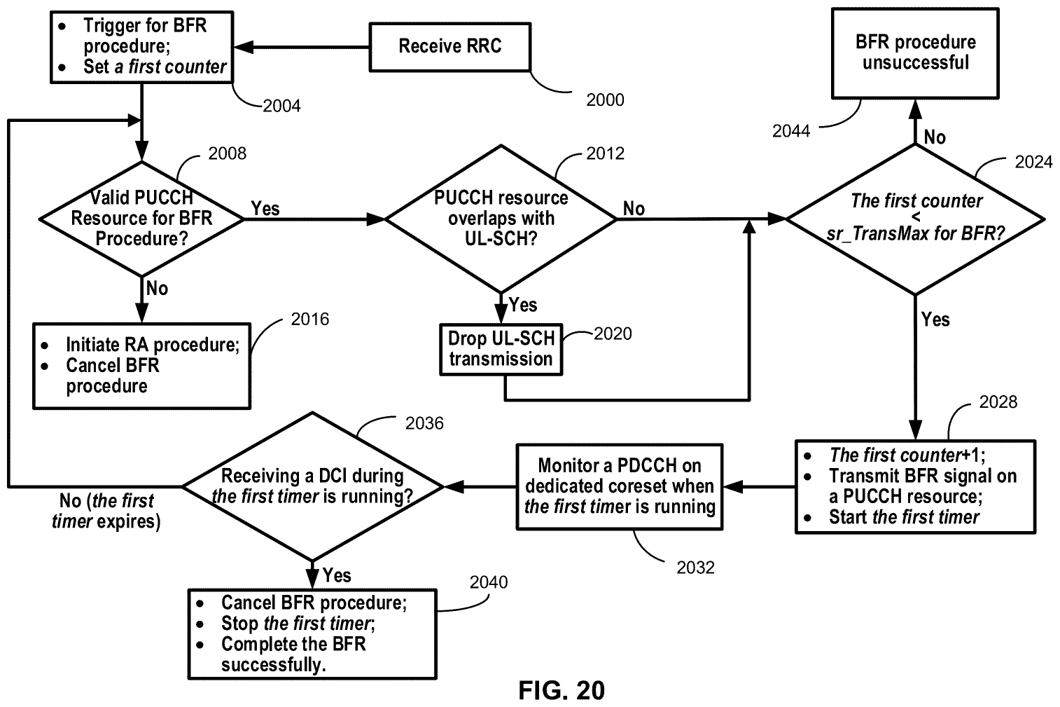

FIG. 20 shows an example BFR procedure at a wireless device. At step 2000, a wireless device may receive one or more RRC messages comprising BFR parameters. The one or more RRC messages may comprise, for example, an RRC message (e.g., RRC connection reconfiguration message, RRC connection reestablishment message, and/or RRC connection setup message). At step 2004, the wireless device may trigger a BFR procedure. The wireless device may trigger a first request for the BFR procedure. The first request may be associated with a first request configuration. The wireless device may initiate the BFR procedure, for example, if the wireless device detects a beam failure. The wireless device may set a first counter to a first value (e.g., 0). The first counter may be, for example, an SR_COUNTER.

At step 2008, the wireless device may determine whether it has a valid PUCCH resource for the first request. At step 2016, the wireless device may cancel the BFR procedure and the wireless device may initiate a random access (RA) procedure. The wireless device may cancel the first request associated with the first request configuration. The wireless device may keep pending a second request (e.g., an SR), that may be associated with the at least a second request configuration, for the BFR procedure, for example, if the first PUCCH resource has been released. The wireless device may initiate a RA procedure for a BFR, or an initial RA procedure, for example, if the wireless device determines no valid PUCCH resource for the first request configuration according to configuration parameters of the first resource configuration. The wireless device may determine no valid PUCCH resource for the first resource configuration, for example, if a PUCCH resource has been released.

At step 2012, the wireless device may determine if the valid PUCCH resource overlaps with a UL-SCH resource. At step 2020, the wireless may drop an uplink transmission scheduled on the UL-SCH if the wireless device determines that the valid PUCCH resource overlaps with the UL-SCH resource.

At step 2024, the wireless device may determine if a value of the first counter is less than a value corresponding to a first transmission number. The first transmission number may be a configured maximum number of SR transmissions (e.g., sr_TransMax for BFR). The first transmission number may be configured by one or more RRC messages. A lower layer (e.g., MAC layer or PHY layer) of the wireless device may indicate a failure of the BFR procedure to a higher layer (e.g., RRC layer) of the wireless device. The wireless device may initiate, for example, an RA procedure for a BFR. The wireless device may, for example, cancel the first request associated with the first request configuration. The wireless device may, for example, keep pending a second request associated with at least a second request configuration.

At step 2028, the wireless device may transit a first BFR signal corresponding to a first request. The wireless device may transmit the first BFR signal, for example, if the valid PUCCH resource does not overlap with a measurement gap. The wireless device may transmit a PUCCH signal on the valid PUCCH resource if transmitting the first BFR signal. The PUCCH signal may comprise, for example, at least one parameter indicating one of: a RS index indicating the candidate beam, and/or a measurement quality (e.g., an RSRP) of a candidate beam. The first BFR signal may be configured with multiple PUCCH resources in at least one message. Each PUCCH resource may be associated with one of a set of RSs (e.g., the second set of RSs as described above with reference to FIG. 18). A wireless device may, for example, select a candidate beam from the second set of RSs. The wireless device may determine the valid PUCCH resource from the multiple PUCCH resources associated with the candidate beam. The wireless device may transmit the PUCCH signal on the valid PUCCH resource. The PUCCH signal may, for example, be a single bit or any number of bits. The bit(s) may be set, for example, to a first value (e.g., one), indicating: a BFR procedure is triggered and/or a candidate beam associated with the PUCCH resource is identified.

Further at step 2028, the wireless device may start a first timer, for example, based on transmitting the first BFR signal. The first timer may be, for example, a beam failure recovery timer. The wireless device may increment the first counter (e.g., by one), for example, based on transmitting the first BFR signal. The wireless device may, for example, increment the first counter by one for every transmission of a BFR signal (e.g., the first BFR signal, a subsequent second BFR signal, etc.). At step 2044, the wireless device may determine that the BFR procedure is unsuccessful, for example, if the wireless device determines that a value of the first counter is greater than or equal to the value corresponding to the first transmission number. The wireless device may not drop an uplink transmission scheduled on the UL-SCH resource, for example, if the first counter indicates a value greater than or equal to the first transmission number. The wireless device may, for example, perform the uplink transmission scheduled on the UL-SCH resource.

At step 2032, the wireless device may monitor a PDCCH. The wireless device may monitor a PDCCH on a dedicated CORESET, for example, while the first timer is running. The wireless device may monitor the PDCCH to detect, for example, DCI. At step 2036, the wireless device may determine if the wireless device has received DCI while the first timer was running. At step 2040, the wireless device may cancel the BFR procedure if the wireless device determines that the wireless device has received the DCI while the first timer was running, wherein the wireless device may determine that the BFR procedure has completed successfully. The wireless device may stop the first timer, and/or the wireless device may reset the first counter, based on or in response to completing the BFR procedure successfully. The wireless device may cancel the first request associated with the first request configuration. The wireless device may cancel a pending second request associated with at least a second request configuration. The one or more uplink grants may accommodate pending data available for transmission. The wireless device may cancel the first request associated with the first request configuration and keep pending a second request (e.g., an SR) associated with the at least a second request configuration, for example, if DCI received on the PDCCH comprises one or more downlink assignments. The wireless device may avoid a RLF, for example, if the BFR procedure completes successfully while the first timer is running. The BFR procedure may return to step 2008, for example, if the wireless device determines that the first timer has expired prior to receiving DCI.

A valid PUCCH resource for a BFR procedure may overlap with, for example, an UL-SCH resource for transmission of a TB. The wireless device may drop an uplink transmission scheduled on an UL-SCH resource, for example, if a valid PUCCH resource for a BFR procedure overlaps with an UL-SCH resource. An ongoing BFR procedure may have a higher priority than, for example, an uplink transmission scheduled on an UL-SCH resource. Dropping a scheduled transmission via an UL-SCH may reduce an uplink interference to other wireless devices and/or in other cells. During a BFR procedure of a serving cell, inter symbol interference to other wireless devices may occur, for example, if the serving cell is used as a timing reference cell. During a BFR procedure of a serving cell, a wireless device may have an incorrect pathloss estimation, for example, if the serving cell is used as a pathloss reference cell. Incorrect pathloss estimation may result in interference to other wireless devices and/or other cells.

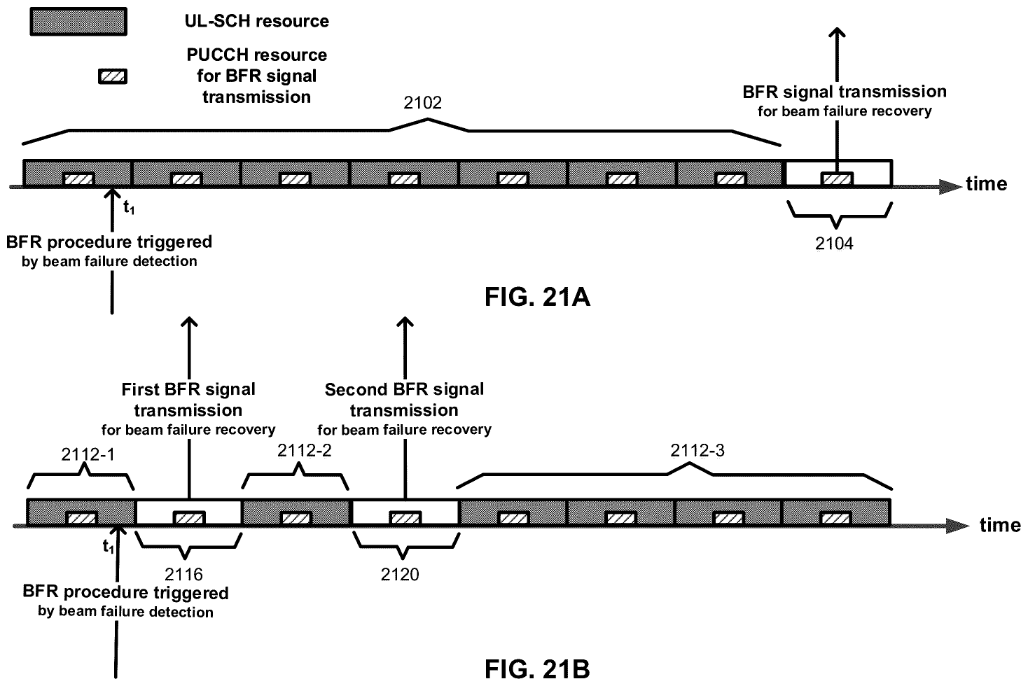

FIG. 21A shows an example of a BFR procedure. A wireless device may receive, from a base station, an uplink grant with a first number of repetitions (e.g., 7, 8, or any other number). The base station may schedule the wireless device on an UL-SCH resource for an uplink transmission 2102. The wireless device may perform the uplink transmission 2102, for example, using the UL-SCH resource with the first number of repetitions. The wireless device may trigger a BFR procedure at time t₁, for example, if the wireless device detects a beam failure. The wireless device may suspend a transmission of a BFR signal until the uplink transmission 2102 is completed, for example, if a request for a PUCCH-based BFR procedure is triggered and a valid PUCCH resource for the BFR procedure overlaps with the UL-SCH resource. The wireless device may transmit, for example, a BFR signal 2104 on the valid PUCCH resource after the uplink transmission 2102 on the resources indicated by the uplink grant with the first number of repetitions. Suspending the transmission of the BFR signal until the uplink transmission 2102 is completed may result in a delay of the PUCCH-based BFR procedure. A delay of the PUCCH-based BFR procedure may result in an RLF.

FIG. 21B shows another example of a BFR procedure. A wireless device may receive, from a base station, an uplink grant with a first number of repetitions (e.g., 7, 8, or any other number). The base station may schedule the wireless device on an UL-SCH resource for an uplink transmission 2112. The wireless device may perform the uplink transmission 2112-1, for example, over the UL-SCH resource. The wireless device may trigger a request for a BFR procedure at time t₁, during an uplink transmission 2112-1, for example, if the wireless device detects a beam failure. The wireless device may drop the uplink transmission scheduled on the UL-SCH resource if the BFR procedure is triggered and a valid PUCCH resource for the BFR procedure overlaps with the UL-SCH resource. The wireless device may, for example, transmit a first BFR signal 2116 on the valid PUCCH resource and drop at least a portion of the uplink transmission 2112 if the BFR procedure is triggered. The wireless device may, for example, resume the uplink transmission 2112, for example, after the first BFR signal 2116 is transmitted, by transmitting an uplink transmission 2112-2. The uplink transmission 2112-2 may be performed during the PUCCH-based BFR procedure, for example, if the valid PUCCH resource does not overlap with the UL-SCH resource. The wireless device may transmit, for example, a second BFR signal 2120 on the valid PUCCH resource and drop at least a portion of the uplink transmission 2112 if the BFR procedure is triggered. The uplink transmission scheduled on the UL-SCH resource may be delayed and/or suspended, for example, at least until the PUCCH-based BFR procedure is completed. The wireless device may resume an uplink transmission 2112-3 scheduled on the UL-SCH resource based on or in response to the PUCCH-based BFR procedure being completed. Dropping the uplink transmission scheduled on the UL-SCH resource may, for example, enable the PUCCH-based BFR procedure to be completed in a timely manner and/or with reduced delay.

A wireless device may report, to a base station via a capability signaling procedures of the wireless device, an RF capability of the wireless device corresponding to reception and/or transmission of signals. The base station may determine whether the wireless device may simultaneously receive/transmit physical channels and/or RSs via different receiving/transmitting beams from one or more component carriers in the downlink/uplink, for example, based on the capability signaling procedures of the wireless device.

A base station may configure one or more component carriers in the same band to a wireless device, for example, using intra-band CA. The one or more component carriers may be powered by a same and a single RF chain. The wireless device may apply a single and/or a same set of TX/RX spatial parameters to the one or more component carriers in the same band at the same time instant. Applying the single and/or the same set of TX/RX spatial parameters may impose limitations on flexibility of multiplexing physical channels (e.g., PDSCH/PUSCH, PDCCH/PUCCH, SRS, PRACH, etc.) and/or RSs (e.g., CSI-RS, SSB, etc.), such as both within and across the one or more component carriers.

A first channel/RS and a second channel/RS may be multiplexed in the same OFDM symbols, for example, if the first channel/RS of a first serving cell (e.g., PCell, BWP) is associated (e.g., QCL-TypeD′) with the second channel/RS of a second serving cell (e.g., SCell, BWP). A wireless device may transmit (or receive) the multiplexed first channel/RS and the second channel/RS simultaneously in uplink (or downlink).

One or more first antenna ports of a first serving cell and one or more second antenna ports of a second serving cell, for example, may not be associated (e.g., QCL-TypeD′). A wireless device may not, for example, infer one or more channel properties of the one or more first antenna ports of the first serving cell from the one or more second antenna ports of the second serving cell.

A first channel/RS (e.g., PDSCH/PUSCH, PDCCH/PUCCH, SRS, PRACH, CSI-RS, SSB, etc.) and a second channel/RS (e.g., PDSCH/PUSCH, PDCCH/PUCCH, SRS, PRACH, CSI-RS, SSB, etc.), for example, may not be associated (e.g., QCL-TypeD′). A base station may configure the first channel/RS with a first QCL assumption. The base station may configure the second channel/RS with a second QCL assumption. A first transmission/reception of a first channel/RS and a second transmission/reception of the second channel/RS, for example, may overlap (e.g., in at least one OFDM symbol). A wireless device may transmit/receive a channel/RS with a higher priority, for example, if the first QCL assumption and the second QCL assumption are not the same. The wireless device may, for example, drop and/or skip a channel with a lower priority. A first channel/RS may, for example, be deemed more important than a second channel/RS. The first channel/RS (e.g., associated with a BFR procedure), for example, may have a higher priority than the second channel/RS. The wireless device may perform the first transmission/reception of the first channel/RS, via the first QCL assumption associated with the BFR procedure. The wireless device may perform the second transmission/reception of the second channel/RS with the second QCL assumption, for example, after the first transmission/reception of the first channel/RS (e.g., sequentially based on the priority).

A first transmission/reception of a first channel/RS and a second transmission/reception of a second channel/RS may overlap (e.g., in at least one OFDM symbol). The wireless device may override the first QCL assumption (or the second QCL assumption), for example, if the first QCL assumption of the first channel/RS and the second QCL assumption of the second channel/RS are not the same. The wireless device may perform the first transmission/reception of the first channel/RS with the second QCL assumption, for example, if the wireless device overrides the first QCL assumption. The wireless device may perform the first transmission and the second transmission simultaneously with the second QCL assumption. The performing the first transmission/reception of the first channel/RS with the second QCL assumption may result in missing and/or poorly receiving the first channel/RS.

A first transmission of a first channel/RS of a first serving cell and a second transmission of a second channel/RS of a second serving cell may overlap (e.g., in at least one OFDM symbol). A base station may configure the first channel/RS with a first QCL assumption. The base station may configure the second channel/RS with a second QCL assumption. The wireless device may simultaneously transmit the first channel/RS and the second channel/RS, for example, if the first QCL assumption and the second QCL assumption are the same. For simultaneous transmission of the first channel/RS of the first serving cell and the second channel/RS of the second serving cell, a prioritization rule may be applied, for example, if the first QCL assumption and the second QCL assumption are not the same. The prioritization rule may be based on at least one of content and/or importance of the first channel/RS and the second channel/RS. The first serving cell may, for example, have an ongoing BFR procedure. The first channel/RS (e.g., PRACH, PUCCH, SSB) may, for example, be used for a BFR procedure (e.g., preamble transmission via PRACH). A BFR procedure (e.g., via PRACH, PUCCH, etc.) may have a higher priority than, for example, data transmission on a PUSCH. The wireless device may perform a first transmission and drop a second transmission (e.g., in a slot, mini-slot, etc.), for example, if a first serving cell has an ongoing BFR procedure. The first serving cell and the second serving cells may be BWPs on a same carrier (e.g., multiple active BWPs). The first serving cell and the second serving cell may be intra-band carrier-aggregation component carriers (e.g., the first serving cell may be a PCell and the second serving cell may be an SCell).

A first transmission of a first channel/RS of a first serving cell and a second transmission of a second channel/RS of a second serving cell may overlap (e.g., in at least one OFDM symbol). A base station may configure the first channel/RS with a first QCL assumption. The base station may configure the second channel/RS with a second QCL assumption. The wireless device may simultaneously transmit the first channel/RS and the second channel/RS, for example, if the first QCL assumption and the second QCL assumption are the same. For simultaneous transmission of the first channel/RS of the first serving cell and the second channel/RS of the second serving cell, an overriding rule may be applied, for example, if the first QCL assumption and the second QCL assumption are not the same. The overriding rule may be based on at least one of content and/or importance of the first channel/RS and the second channel/RS. The first serving cell may, for example, have an ongoing BFR procedure. The first channel/RS (e.g., PRACH, PUCCH, SSB) may, for example, be used for a BFR procedure (e.g., preamble transmission via PRACH). A BFR procedure (e.g., via PRACH, PUCCH, etc.) may have a higher priority than, for example, data transmission on a PUSCH. The wireless device may apply a first QCL assumption of the first channel/RS of the first serving cell to both the first transmission of the first serving cell and the second transmission of the second serving cell. The first and the second serving cells may, for example, be BWPs on a same carrier (e.g., multiple active BWPs). The first and the second serving cells may, for example, be intra-band carrier-aggregation component carriers (e.g., the first serving cell may be a PCell and the second serving cell may be an SCell). The base station may miss a reception of the first transmission, for example, if the wireless device does not apply the first QCL assumption of the first channel/RS to the first transmission for the ongoing BFR procedure. Missing the reception of the first transmission may increase latency of the ongoing BFR procedure. Missing the reception of the first transmission may lead to an RLF.

A wireless device and/or a base station may enhance a BFR procedure, for example, in a carrier aggregation scenario and/or if bandwidth parts are configured for a cell, by performing processed described herein. A duration of a BFR procedure may be reduced and/or battery power consumption may be reduced. BFR procedures may be enhanced to improve downlink radio efficiency and/or reduce uplink signaling overhead, for example, if there is a beam failure in a carrier aggregation scenario and/or if bandwidth parts are configured for a cell.

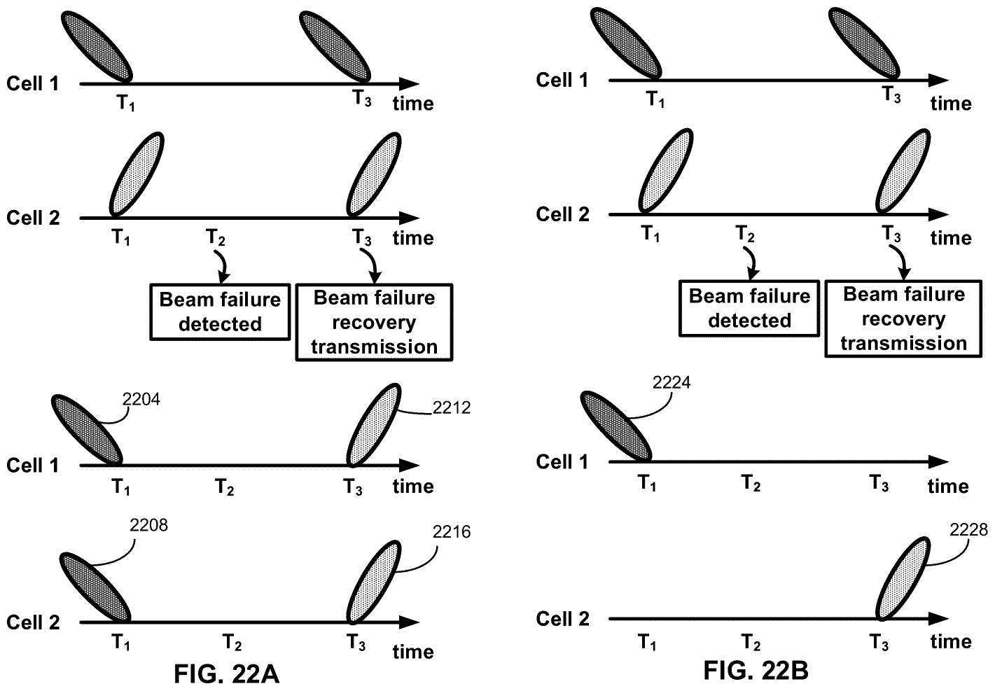

FIG. 22A and FIG. 22B show examples for BFR procedures. A base station may configure a first channel/RS of a Cell 1 with a first QCL assumption and a second channel/RS of a Cell 2 with a second QCL assumption. A first transmission of the first channel/RS and a second transmission of the second channel/RS may overlap (e.g., in at least one OFDM symbol at time T1). A wireless device and/or a base station may determine that the first channel/RS may be more important than the second channel/RS. The first channel/RS may, for example, have a higher priority than the second channel/RS.

In FIG. 22A, if a first QCL assumption of the Cell 1 and a second QCL assumption of the Cell 2 are not the same, the wireless device may, for example, override the second QCL assumption of the Cell 2. At time T1, the wireless device may, for example, apply the first QCL assumption of a first channel/RS of the Cell 1 to both a first transmission of the Cell 1 (e.g., transmission 2204) and a second transmission of the Cell 2 at time T1 (e.g., transmission 2208). The wireless device may override a first QCL assumption of the first channel/RS, for example, if the first channel/RS and the candidate RS are not associated (e.g., QCL TypeD′). The wireless device may apply a second QCL assumption of the candidate RS of the Cell 2 to both the first transmission of the Cell 1 (e.g., transmission 2212) and the at least one preamble transmission of the Cell 2 at time T3 (e.g., transmission 2216).

In FIG. 22B, if a first QCL assumption of the Cell 1 and the second QCL assumption of the Cell 2 are not the same, the wireless device may, for example, drop the second transmission of the Cell 2. At time T1, the wireless device may, for example, perform a first transmission of a first channel/RS in Cell 1 (e.g., transmission 2224) with the first QCL assumption and drop (or skip) a second transmission of the Cell 2 at time T1. The wireless device may drop the first transmission of the first channel/RS, for example, if the first channel/RS and the second channel/RS are not associated (e.g., QCL Type D′). The wireless device may perform the at least one preamble transmission of the Cell 2 with a second QCL assumption of the candidate RS (e.g., transmission 2228) and drop the first transmission of the Cell 1 at time T3.

A wireless device may declare a beam failure of Cell 2, for example, at time T2. The wireless device may initiate an RA procedure for a BFR procedure. The wireless device may initiate a candidate beam identification procedure based on initiating the RA procedure for the BFR procedure. The wireless device may indicate a candidate RS in one or more RSs (e.g., a periodic CSI-RS, an SSB, etc.) of the Cell 2 for the candidate beam identification procedure. The one or more RSs may be provided by RRC signaling. A radio link quality (e.g., a BLER, an L1-RSRP) of the candidate RS may be better (e.g., a lower BLER, a higher L1-RSRP, and/or a higher SINR) than a threshold. The threshold may be a value provided by, for example, a higher layer (e.g. RRC, MAC). The candidate RS may be associated with a BFR procedure resource of one or more BFR procedure resources of the Cell 2. The one or more BFR procedure resources may be provided, for example, by a base station via RRC signaling. The BFR procedure resource may comprise, for example, at least one preamble and at least one PRACH (e.g., time and/or frequency) resource. The BFRQ resource may comprise, for example, a PUCCH resource for a PUCCH-based BFR.

A first transmission of a first channel/RS of the Cell 1 and the at least one preamble transmission of the Cell 2 via the at least one PRACH resource associated with the candidate RS may overlap (e.g., in at least one OFDM symbol at time T3). The base station may not receive the at least one preamble, for example, if the wireless device does not transmit the at least one preamble via the at least one PRACH resource with a QCL assumption of the candidate RS. The wireless device may not complete the BFR procedure successfully, for example, if the base station does not receive the at least one preamble. This may result in an increase in a latency of the BFR procedure and/or result in a declaration of RLF by the wireless device. Cell 1 and Cell 2 may be, for example, a PCell and an SCell, respectively. Cell 1 and Cell 2 may be, for example, an SCell and a PCell, respectively. Cell 1 and Cell 2 may be, for example, a first active BWP and a second active BWP of the same carrier, respectively.

The base station may transmit a BFR response in one or more CORESETS, for example, based on receiving the at least one preamble via the at least one PRACH resource. The one or more CORESETS may be configured by a base station, for example, via RRC signaling. The wireless device may monitor at least one PDCCH in one or more CORESETs for the BFR response to complete the BFR procedure. The one or more CORESETs may be, for example, on the Cell 1 or the Cell 2. The wireless device may monitor the at least one PDCCH in the one or more first CORESETs according to an antenna port associated (e.g., QCLed) with the candidate RS. At least one RS (e.g., DM-RS) of the at least one PDCCH may be associated (e.g., QCLed) with the candidate RS. A base station may transmit an indication of QCL between antenna port(s) of the candidate RS and the at least one RS.

The base station may drop a first transmission of a first channel/RS of the Cell 1, for example, if the first transmission of the Cell 1 and a second transmission of a BFR response associated with a candidate RS of the Cell 2 overlap (e.g., in at least one OFDM symbol). The base station may transmit the second transmission of the BFR response in one or more first CORESETs according to an antenna port associated (e.g., QCLed) with the candidate RS. The wireless device may receive at least one PDCCH in the one or more first CORESETs according to an antenna port associated (e.g., QCLed) with the candidate RS.

The base station may transmit a first transmission of a first channel/RS of the Cell 1 simultaneously with a second transmission of the BFR response associated with a candidate RS of the Cell 2, for example, if the first transmission and the second transmission overlap (e.g., in at least one OFDM symbol). The first transmission and the second transmission are transmitted simultaneously, for example, according to an antenna port associated (e.g., QCLed) with the candidate RS. The wireless device may receive at least one PDCCH in one or more first CORESETs according to the antenna port associated (e.g., QCLed) with the candidate RS.

A wireless device may allocate power to PUSCH, PUCCH, PRACH, and/or SRS transmissions based on a priority order, such as for a single cell operation with two uplink carriers or for an operation with carrier aggregation, for example, if a total wireless device transmit power for the PUSCH, the PUCCH, the PRACH, and/or the SRS transmissions in a first transmission period exceeds a maximum transmit power (e.g., which may be configured by a higher layer, RRC, MAC, etc.). The priority order may be, for example, pre-defined or fixed. Allocating power based on a priority order may enable the wireless device not to exceed the maximum transmit power in the first transmission period. The first transmission period may comprise of one or more symbols. A BFR procedure for an SCell may have a higher priority than an uplink transmission (e.g., PUSCH, PUCCH, etc.) of a PCell. The priority order (e.g., in descending order) may be, for example: a PRACH transmission on a PCell, a PRACH transmission on a serving cell other than the PCell for a BFR procedure, PUCCH transmission with HARQ-ACK/SR or a PUSCH transmission with HARQ-ACK, a PUCCH transmission with CSI or a PUSCH transmission with CSI, a PUSCH transmission without HARQ-ACK or CSI, and a SRS transmissions (with aperiodic SRS transmissions having higher priority than semi-persistent and/or periodic SRS transmissions), or a PRACH transmission on a serving cell other than the PCell. A PRACH transmission for a BFR procedure may have a higher priority than other uplink transmissions (e.g., a PUSCH transmission, or a PUCCH transmission). By prioritizing transmissions such as described above, a BFR procedure may be completed successfully in a timely manner and/or with reduced delay.

A wireless device may receive, from a base station, one or more messages comprising one or more configuration parameters. The one or more configuration parameters may indicate one or more PUCCH resources for transmission of a first signal for a BFR procedure of a cell. The one or more configuration parameters may indicate, for example, one or more first RSs of the cell, one or more second RSs of the cell, and/or radio resources of a dedicated CORESET on the cell. The one or more first RSs may comprise, for example, one or more first CSI-RSs and/or one or more first SS blocks. The one or more second RSs may comprise, for example, one or more second CSI-RSs and/or one or more second SS blocks. The one or more configuration parameters may indicate, for example, an association between each of the one or more second RSs and each of one or more PUCCH resources.

A wireless device may detect a beam failure on the cell, for example, if a radio link quality of the one or more first RSs satisfies certain criteria. The beam failure may occur, for example, if an RSRP and/or SINR of the one or more first RSs is less than a first threshold and/or if a BLER is greater than a first threshold. This assessment may be for a consecutive number of times based on a value provided by a higher layer (e.g., RRC, MAC). The wireless device may initiate a BFR procedure (e.g., PUCCH-based BFR), for example, based on or in response to detecting the beam failure.

Initiating the BFR procedure may comprise selecting a selected RS, in the one or more second RSs, for transmission of a first signal. The selected RS may be associated with one of the one or more second RSs with radio quality greater than a second threshold. The second threshold may be based on an L1-RSRP, an RSRQ, a hypothetical BLER, and/or an SINR. The selected RS may be associated with a first PUCCH resource of the one or more PUCCH resources. The first PUCCH resource may comprise at least one channel resource. The at least one channel resource may comprise, for example, one or more time resources and/or one or more frequency resources.

The wireless device may trigger the transmission of the first signal via the first PUCCH resource, for example, based on selecting the selected RS. The first PUCCH resource may overlap, for example, with a scheduled transmission of a second signal via a PUSCH resource of the cell. The wireless device may drop the scheduled transmission of the second signal, for example, based on or in response to determining that the first PUCCH resource overlaps with the PUSCH resource. The wireless device may perform the transmission of the first signal via the first PUCCH resource, for example, based on dropping the scheduled transmission.

The wireless device may monitor, for control information, a downlink control channel based on or in response to the transmission of the first signal. The monitoring of the downlink control channel may comprise, for example, searching for the control information in the downlink control channel addressed by an identifier associated with the wireless device. The control information may be received on a dedicated CORESET. The wireless device may complete the BFR procedure successfully, for example, based on or in response to receiving the control information on the dedicated CORESET.

A BFR procedure may be prioritized by, for example, using a CORESET with a high priority. A BFR procedure may be prioritized by, for example, setting a CORESET (e.g., BFR-CORESET) to have a higher priority than other CORESETs. A BFR procedure may be prioritized, for example, by using a CORESET, among a plurality of CORESETs, with a highest priority for a BFR procedure. A BFR procedure may be prioritized, for example, by using a primary CORESET for a BFR procedure.

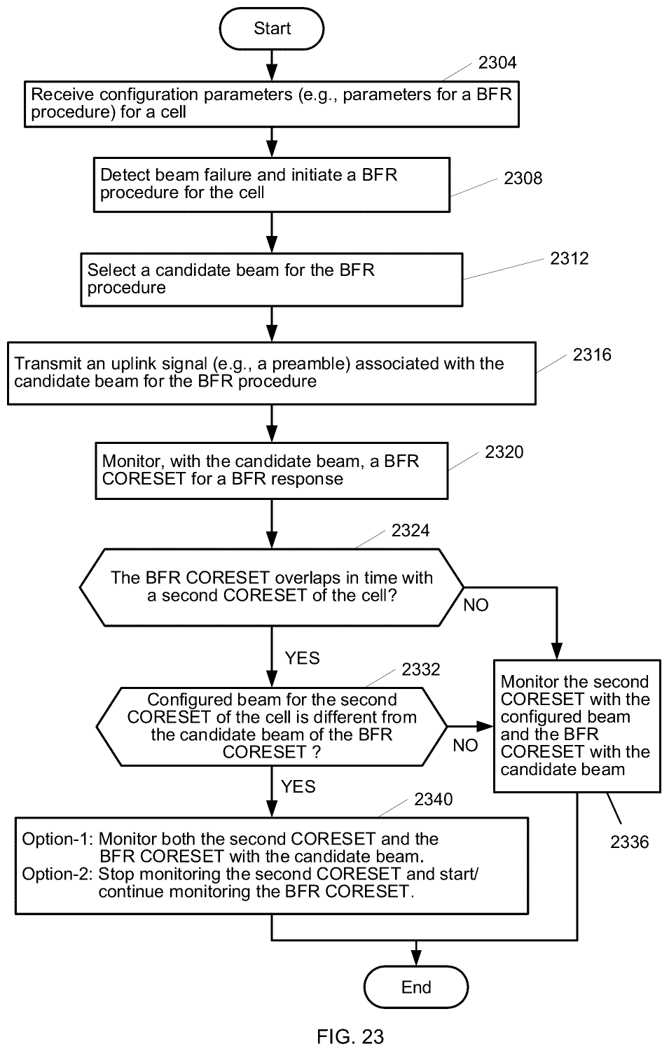

FIG. 23 shows an example method for a BFR procedure by a wireless device. At step 2304, the wireless device may receive, from a base station, one or more messages comprising one or more configuration parameters for a cell. The one or more configuration parameters may indicate, for example, parameters for a BFR procedure. The parameters for the BFR procedure may include, for example, one or more PUCCH resources for transmission of a first signal for the BFR procedure of a cell. At step 2308, the wireless device may detect a beam failure and initiate a BFR procedure for the cell. At step 2312, the wireless device may select a candidate beam for the BFR procedure. At step 2316, the wireless device may transmit an uplink signal (e.g., a BFR signal such as a preamble transmitted on a PRACH resource) associated with the candidate beam for the BFR procedure. At step 2320, the wireless device may monitor (e.g., with the candidate beam) a BFR CORESET for a BFR response (e.g., response to the BFR signal). At step 2324, the wireless device may determine if the BFR CORESET overlaps in time with a second CORESET of the cell. At step 2336, the wireless device may monitor: (i) the second CORESET of the cell with the configured beam, and (ii) the BFR CORESET with the candidate beam, for example, if the wireless device determines that the BFR CORESET does not overlap in time with the another CORESET. At step 2332, the wireless device may determine if a configured beam for the second CORESET of the cell is different from (or not QCL-ed with) the candidate beam of the BFR CORESET. If the wireless device determines the configured beam for the another CORESET of the cell is the same as (or QCL-ed with) the candidate beam of the BFR CORESET, at step 2336, the wireless device may monitor: (i) the second CORESET of the cell with the configured beam, and (ii) the BFR CORESET with the candidate beam. At step 2340, the wireless device may either (i) monitor the second CORESET of the cell with the configured beam and monitor the BFR CORESET with the candidate beam (e.g., option 1), or (ii) stop monitoring the second CORESET of the cell and start and/or continue monitoring the BFR CORESET with the candidate beam (e.g., option 2). The base station and/or the wireless device may determine which of option 1 or option 2 to perform. The base station may send, to the wireless device, one or more messages indicating which of option to perform (e.g., option 1 or option 2). A selection of option 1 or option 2 may be based on a predetermined rule that the base station and/or the wireless device may apply, such as based on an index (e.g., CORESET index, BWP index, etc.), numerology, service (e.g., eMBB, URLLC, etc.), or any other indicator.

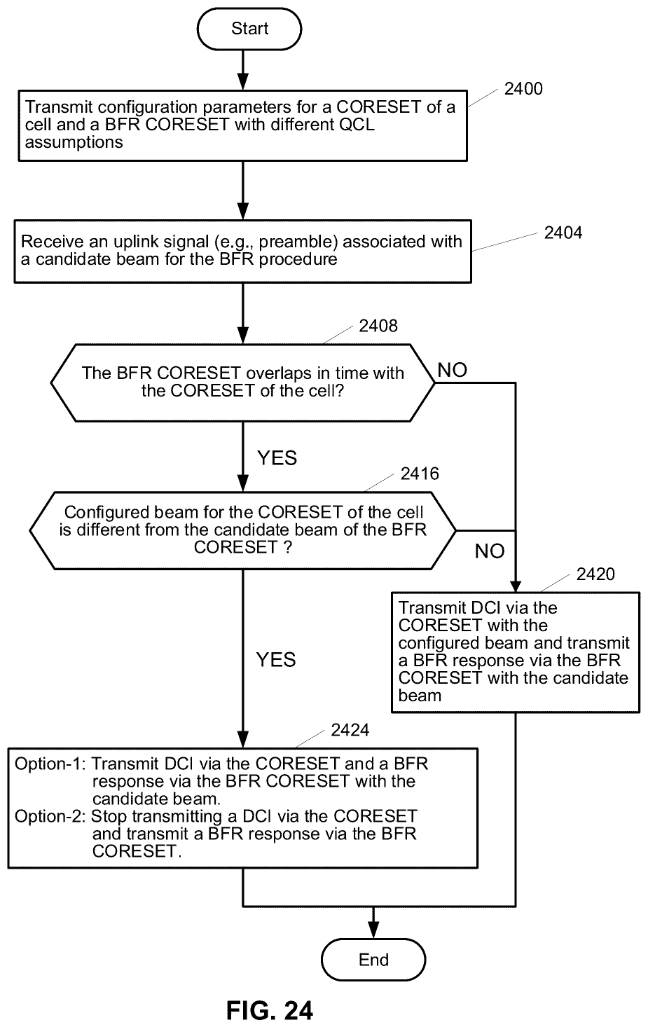

FIG. 24 shows an example method for a BFR procedure at a base station. At step 2400, the base station may transmit configuration parameters for a first CORESET of a cell and a BFR CORESET, each with different QCL assumptions (or different beams/RSs). At step 2404, the base station may receive an uplink signal (e.g., a BFR signal such as a preamble transmitted on a PRACH resource) associated with a candidate beam. The candidate beam may be a beam corresponding to a BFR procedure. At step 2408, the base station may determine if the BFR CORESET overlaps in time with the CORESET of the cell. At step 2420, the base station may transmit: (i) a DCI via the CORESET of the cell with the configured beam and (ii) a BFR response via the BFR CORESET with the candidate beam, for example, if the base station determines that the BFR CORESET does not overlap in time with the CORESET of the cell. At step 2416, the base station may determine if a configured beam for the CORESET of the cell is different from (or not QCL-ed with) the candidate beam of the BFR CORESET. If the base station determines that the configured beam for the CORESET of the cell is the same as (or QCL-ed with) the candidate beam of the BFR CORESET, at step 2420, the base station may transmit: (i) a DCI via the CORESET of the cell with the configured beam and (ii) a BFR response via the BFR CORESET with the candidate beam. At step 2424, the base station may (i) transmit DCI via the CORESET of the cell and transmit a BFR response via the BFR CORESET with the candidate beam, or (ii) stop transmitting DCI via the CORESET of the cell and transmit a BFR response via a BFR CORESET with the candidate beam.

A base station may send, to a wireless device that may receive, one or more messages (e.g., RRC messages). The one or more messages may comprise one or more configuration parameters. The one or more configuration parameters may comprise beam failure recovery request configuration parameters. The one or more configuration parameters may indicate one or more PUCCH resources for transmission of a first signal for a beam failure recovery procedure. The first signal may comprise a beam failure recovery request. The one or more configuration parameters may indicate one or more of: one or more first reference signals (RSs), one or more second RSs, an association between the one or more second RSs and the one or more PUCCH resources, and/or radio resources of a dedicated CORESET. The one or more first RSs may comprise one or more first CSI-RSs and/or one or more first SS/PBCH blocks. The wireless device may detect a beam failure. The wireless device may detect the beam failure, for example, by assessing the one or more first RSs with radio quality lower than a first threshold. The first threshold may be based on hypothetical BLER, RSRP, RSRQ, and/or SINR. The wireless device may initiate the beam failure recovery procedure (e.g., based on detecting the beam failure). The wireless device may initiate the beam failure recovery procedure, for example, by selecting a selected RS of the one or more second RSs. The selected RS may be associated with the first PUCCH resource, and/or the first PUCCH resource may comprise at least one channel resource. The selected RS may have a radio quality greater than a second threshold. The second threshold may be based on L1-RSRP, RSRQ, hypothetical BLER, and/or SINR. The wireless device may trigger transmission of the first signal and/or determine to transmit the first signal (e.g., based on detecting the beam failure). The wireless device may determine that a first PUCCH resource, of the one or more PUCCH resources for transmission of the first signal overlaps with a scheduled transmission of one or more transport blocks via a PUSCH. Based on the determining that the first PUCCH resource overlaps with the scheduled transmission of the one or more transport blocks via the PUSCH, the wireless device may: drop the scheduled transmission of the one or more transport blocks via the PUSCH, and/or transmit, via the first PUCCH resources, the first signal. Instead of dropping the scheduled transmission of the one or more transport blocks via the PUSCH, the wireless device may suspend the scheduled transmission of the one or more transport blocks via the PUSCH (e.g., at least until the beam failure recovery procedure is successfully completed). The wireless may transmit the first signal via at least one channel resource of the first PUCCH resource. The first signal may be a scheduling request (SR) for the beam failure recovery procedure. The wireless device may monitor, for control information, a downlink control channel based on the transmitting the first signal. The monitoring may comprise searching for the control information in the downlink control channel addressed for an identifier associated with the wireless device. The wireless device may determine to transmit a first SR. Based on determining that a second PUCCH resource, for transmission of the first SR, overlaps with a second scheduling transmission of one or more transport blocks via the PUSCH, the wireless device may: drop the transmission of the first SR, and/or transmit, via the PUSCH, the second scheduled transmission of the one or more transport blocks. The wireless device may successfully complete a beam failure recovery procedure based on receiving control information via a dedicated CORESET. The wireless device may cancel a transmission of the first signal based on successfully completing the beam failure recovery procedure. The wireless device may determine that a second PUCCH resource, of the one or more PUCCH resources for transmission of the first signal, overlaps with a second scheduling transmission of one or more transport blocks via the PUSCH. Based on the determining, the wireless device may suspend the second scheduling transmission of the one or more transport blocks via the PUSCH at least until the beam failure recovery procedure is successfully completed. The wireless device may transmit, after a determination that the beam failure procedure is successfully completed, the second scheduling transmission of the one or more transport blocks via the PUSCH. The wireless device may delay the scheduled transmission of the one or more transport blocks via the PUSCH at least until successfully completing the beam failure recovery procedure. The wireless device may cancel the first SR based on successfully completing the beam failure recovery procedure. The wireless device may keep the first SR pending, for example, based on successfully completing the beam failure recovery procedure.

A base station may send, to a wireless device that may receive, one or more messages comprising configuration parameters that indicate one or more of: a first reference signal (RS) of a first channel, and a second RS of a second channel. The wireless device may select a channel (e.g., a selected channel) from the first channel and the second channel, for example, based on one or more of: a channel configuration for a beam failure recovery procedure, a first channel and the second channel overlapping in at least one symbol, and first antenna ports of the first RS not being quasi-colocated with the second antenna ports of the second RS. The base station may send, to the wireless device that may receive, downlink control information via the selected channel. The wireless device may transmit, via the selected channel, an uplink signal. The wireless device may apply a selected RS of the selected channel for the first channel and the second channel.

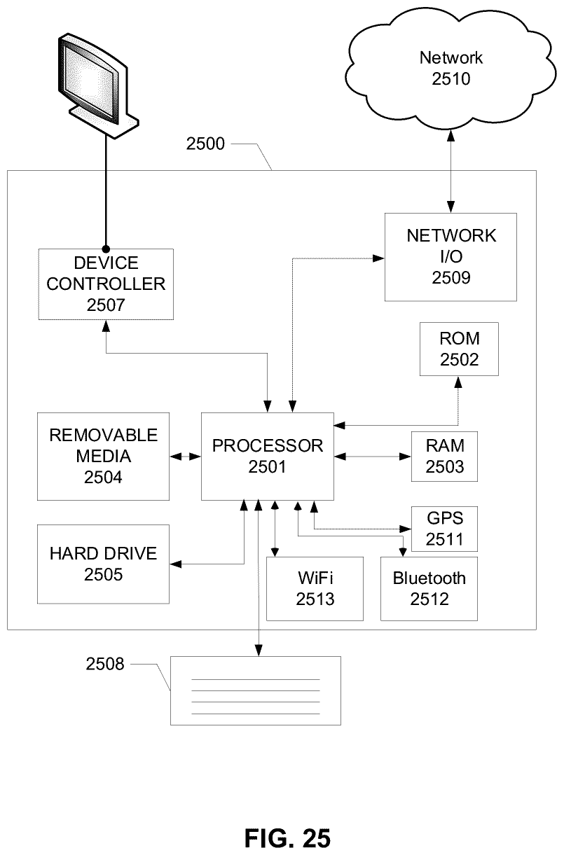

FIG. 25 shows example elements of a computing device that may be used to implement any of the various devices described herein, including, e.g., the base station 122A and/or 122B, the wireless device 110 (e.g., 110A and/or 110B), or any other base station, wireless device, or computing device described herein. The computing device 2500 may include one or more processors 2501, which may execute instructions stored in the random access memory (RAM) 2503, the removable media 2504 (such as a Universal Serial Bus (USB) drive, compact disk (CD) or digital versatile disk (DVD), or floppy disk drive), or any other desired storage medium. Instructions may also be stored in an attached (or internal) hard drive 2505. The computing device 2500 may also include a security processor (not shown), which may execute instructions of one or more computer programs to monitor the processes executing on the processor 2501 and any process that requests access to any hardware and/or software components of the computing device 2500 (e.g., ROM 2502, RAM 2503, the removable media 2504, the hard drive 2505, the device controller 2507, a network interface 2509, a GPS 2511, a Bluetooth interface 2512, a WiFi interface 2513, etc.). The computing device 2500 may include one or more output devices, such as the display 2506 (e.g., a screen, a display device, a monitor, a television, etc.), and may include one or more output device controllers 2507, such as a video processor. There may also be one or more user input devices 2508, such as a remote control, keyboard, mouse, touch screen, microphone, etc. The computing device 2500 may also include one or more network interfaces, such as a network interface 2509, which may be a wired interface, a wireless interface, or a combination of the two. The network interface 2509 may provide an interface for the computing device 2500 to communicate with a network 2510 (e.g., a RAN, or any other network). The network interface 2509 may include a modem (e.g., a cable modem), and the external network 2510 may include communication links, an external network, an in-home network, a provider's wireless, coaxial, fiber, or hybrid fiber/coaxial distribution system (e.g., a DOCSIS network), or any other desired network. Additionally, the computing device 2500 may include a location-detecting device, such as a global positioning system (GPS) microprocessor 2511, which may be configured to receive and process global positioning signals and determine, with possible assistance from an external server and antenna, a geographic position of the computing device 2500.

The example in FIG. 25 may be a hardware configuration, although the components shown may be implemented as software as well. Modifications may be made to add, remove, combine, divide, etc. components of the computing device 2500 as desired. Additionally, the components may be implemented using basic computing devices and components, and the same components (e.g., processor 2501, ROM storage 2502, display 2506, etc.) may be used to implement any of the other computing devices and components described herein. For example, the various components described herein may be implemented using computing devices having components such as a processor executing computer-executable instructions stored on a computer-readable medium, as shown in FIG. 25. Some or all of the entities described herein may be software based, and may co-exist in a common physical platform (e.g., a requesting entity may be a separate software process and program from a dependent entity, both of which may be executed as software on a common computing device).

The disclosed mechanisms herein may be performed if certain criteria are met, for example, in a wireless device, a base station, a radio environment, a network, a combination of the above, and/or the like. Example criteria may be based on, for example, wireless device and/or network node configurations, traffic load, initial system set up, packet sizes, traffic characteristics, a combination of the above, and/or the like. If the one or more criteria are met, various examples may be used. It may be possible to implement examples that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). A base station may comprise multiple sectors. A base station communicating with a plurality of wireless devices may refer to base station communicating with a subset of the total wireless devices in a coverage area. Wireless devices referred to herein may correspond to a plurality of wireless devices of a particular LTE or 5G release with a given capability and in a given sector of a base station. A plurality of wireless devices may refer to a selected plurality of wireless devices, and/or a subset of total wireless devices in a coverage area. Such devices may operate, function, and/or perform based on or according to drawings and/or descriptions herein, and/or the like. There may be a plurality of base stations or a plurality of wireless devices in a coverage area that may not comply with the disclosed methods, for example, because those wireless devices and/or base stations perform based on older releases of LTE or 5G technology.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

Many of the elements in examples may be implemented as modules. A module may be an isolatable element that performs a defined function and has a defined interface to other elements. The modules may be implemented in hardware, software in combination with hardware, firmware, wetware (i.e., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and complex programmable logic devices (CPLDs). Computers, microcontrollers, and microprocessors may be programmed using languages such as assembly, C, C++ or the like. FPGAs, ASICs, and CPLDs may be programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

A non-transitory tangible computer readable media may comprise instructions executable by one or more processors configured to cause operations of multi-carrier communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as base stations, wireless devices or user equipment (wireless device), servers, switches, antennas, and/or the like. A network may comprise any wireless technology, including but not limited to, cellular, wireless, WiFi, 4G, 5G, any generation of 3GPP or other cellular standard or recommendation, wireless local area networks, wireless personal area networks, wireless ad hoc networks, wireless metropolitan area networks, wireless wide area networks, global area networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
receiving, by a wireless device, at least one configuration parameter associated with beam failure recovery;
transmitting, via a first physical uplink control channel (PUCCH) in a transmission occasion, a request for beam failure recovery; and
transmitting, via a second PUCCH in the transmission occasion, a second transmission using a transmission power that is less than a configured transmission power for the second transmission based on:
transmission of the request for beam failure recovery via the first PUCCH in the transmission occasion; and
the first PUCCH and the second PUCCH in the transmission occasion.

2. The method of claim 1, further comprising:
based on a determination that a third transmission via a third PUCCH overlaps with a physical uplink shared channel (PUSCH) transmission, and based on the third PUCCH not being associated with beam failure recovery:
determining that the PUSCH transmission is prioritized over the third transmission; and
dropping the third transmission.

3. The method of claim 1, further comprising:
based on a determination that the second transmission overlaps with a physical uplink shared channel (PUSCH) transmission in the transmission occasion, and based on the second transmission comprising channel state information that is not associated with beam failure recovery:
determining that the second transmission is prioritized over the PUSCH transmission; and
performing the second transmission.

4. The method of claim 1, further comprising:
determining, based on at least one configured power parameter, the configured transmission power for the second transmission; and
reducing the configured transmission power,
wherein the transmitting the second transmission using the transmission power comprises transmitting, based on the reducing the configured transmission power, the second transmission.

5. The method of claim 1, wherein the transmitting the second transmission is further based on:
the transmission of the request for beam failure recovery being prioritized over the second transmission; and
a combined transmission power, comprising a configured transmission power for the transmission of the request for beam failure recovery and the configured transmission power for the second transmission, exceeding an allowed transmission power.

6. The method of claim 1, further comprising:
initiating, based on a beam failure associated with a secondary cell, a beam failure recovery procedure,
wherein the transmitting the request for beam failure recovery comprises transmitting, based on the beam failure, the request for beam failure recovery, and
wherein the request for beam failure recovery comprises a scheduling request (SR) for beam failure recovery.

7. The method of claim 1, wherein:
the transmission occasion comprises a plurality of symbols corresponding to a transmission period;
the transmission of the request for beam failure recovery is associated with at least one first symbol of the transmission period; and
the second transmission is associated with at least one second symbol of the transmission period.

8. The method of claim 1, wherein the transmission of the request for beam failure recovery at least partially overlaps in time with the second transmission.

9. A method comprising:
receiving, by a wireless device, at least one configuration parameter associated with beam failure recovery;
transmitting, via a first physical uplink control channel (PUCCH) in a transmission occasion, a request for beam failure recovery; and
dropping a scheduled transmission via a second PUCCH in the transmission occasion, wherein the dropping is based on:
transmission of the request for beam failure recovery via the first PUCCH in the transmission occasion; and
power for the first PUCCH being prioritized over power for the second PUCCH.

10. The method of claim 9, further comprising:
based on a determination that a third transmission via a third PUCCH overlaps with a physical uplink shared channel (PUSCH) transmission, and based on the third PUCCH not being associated with beam failure recovery:
determining that the PUSCH transmission is prioritized over the third transmission; and
dropping the third transmission.

11. The method of claim 9, further comprising:
determining, based on at least one configured power parameter, a configured transmission power for the scheduled transmission; and
reducing the configured transmission power to zero.

12. The method of claim 9, wherein the dropping is further based on a combined transmission power, comprising a configured transmission power for the transmission of the request for beam failure recovery and a configured transmission power for the scheduled transmission, exceeding an allowed transmission power.

13. The method of claim 9, further comprising:
initiating, based on a beam failure associated with a secondary cell, a beam failure recovery procedure,
wherein the transmitting the request for beam failure recovery comprises transmitting, based on the beam failure, the request for beam failure recovery, and
wherein the request for beam failure recovery comprises a scheduling request (SR) for beam failure recovery.

14. The method of claim 9, wherein:
the transmission occasion comprises a plurality of symbols corresponding to a transmission period;
the transmission of the request for beam failure recovery is associated with at least one first symbol of the transmission period; and
the scheduled transmission is associated with at least one second symbol of the transmission period.

15. The method of claim 9, wherein the transmission of the request for beam failure recovery at least partially overlaps in time with the scheduled transmission.

16. A wireless device comprising:
one or more processors; and
memory storing instructions that, when executed by the one or more processors, configure the wireless device to:
receive at least one configuration parameter associated with beam failure recovery; and
transmit, via a first physical uplink control channel (PUCCH) in a transmission occasion, a request for beam failure recovery; and
transmit, via a second PUCCH in the transmission occasion, a second transmission using a transmission power that is less than a configured transmission power for the second transmission based on:
transmission of the request for beam failure recovery via the first PUCCH in the transmission occasion; and
the first PUCCH and the second PUCCH in the transmission occasion.

17. The wireless device of claim 16, wherein the instructions, when executed by the one or more processors, configure the wireless device to:
based on a determination that a third transmission via a third PUCCH overlaps with a physical uplink shared channel (PUSCH) transmission, and based on the third PUCCH not being associated with beam failure recovery:
determine that the PUSCH transmission is prioritized over the third transmission; and
drop the third transmission.

18. The wireless device of claim 16, wherein the instructions, when executed by the one or more processors, configure the wireless device to:
based on a determination that the second transmission overlaps with a physical uplink shared channel (PUSCH) transmission in the transmission occasion, and based on the second transmission comprising channel state information that is not associated with beam failure recovery:
determine that the second transmission is prioritized over the PUSCH transmission; and
perform the second transmission.

19. The wireless device of claim 16, wherein the instructions, when executed by the one or more processors, configure the wireless device to:
determine, based on at least one configured power parameter, the configured transmission power for the second transmission; and
reduce the configured transmission power, and
wherein the instructions, when executed by the one or more processors, configure the wireless device to transmit the second transmission by transmitting, based on the reducing the configured transmission power, the second transmission.

20. The wireless device of claim 16, wherein the instructions, when executed by the one or more processors, configure the wireless device to transmit the second transmission further based on:
the transmission of the request for beam failure recovery being prioritized over the second transmission; and
a combined transmission power, comprising a configured transmission power for the transmission of the request for beam failure recovery and the configured transmission power for the second transmission, exceeding an allowed transmission power.

21. The wireless device of claim 16, wherein the instructions, when executed by the one or more processors, configure the wireless device to:
initiate, based on a beam failure associated with a secondary cell, a beam failure recovery procedure; and
transmit, based on the beam failure, the request for beam failure recovery, and
wherein the request for beam failure recovery comprises a scheduling request (SR) for beam failure recovery.

22. The wireless device of claim 16, wherein:
the transmission occasion comprises a plurality of symbols corresponding to a transmission period;
the transmission of the request for beam failure recovery is associated with at least one first symbol of the transmission period; and
the second transmission is associated with at least one second symbol of the transmission period.

23. The wireless device of claim 16, wherein the transmission of the request for beam failure recovery at least partially overlaps in time with the second transmission.

24. A wireless device comprising:
one or more processors; and
memory storing instructions that, when executed by the one or more processors, configure the wireless device to:
receive at least one configuration parameter associated with beam failure recovery;
transmit, via a first physical uplink control channel (PUCCH) in a transmission occasion, a request for beam failure recovery; and
drop a scheduled transmission via a second PUCCH in the transmission occasion, wherein dropping the scheduled transmission is based on:
transmission of the request for beam failure recovery via the first PUCCH in the transmission occasion; and
power for the first PUCCH being prioritized over power for the second PUCCH.

25. The wireless device of claim 24, wherein the instructions, when executed by the one or more processors, configure the wireless device to:
based on a determination that a third transmission via a third PUCCH overlaps with a physical uplink shared channel (PUSCH) transmission, and based on the third PUCCH not being associated with beam failure recovery:
determine that the PUSCH transmission is prioritized over the third transmission; and
drop the third transmission.

26. The wireless device of claim 24, wherein the instructions, when executed by the one or more processors, configure the wireless device to:
determine, based on at least one configured power parameter, a configured transmission power for the scheduled transmission; and
reduce the configured transmission power to zero.

27. The wireless device of claim 24, wherein the instructions, when executed by the one or more processors, configure the wireless device to drop the scheduled transmission further based on a combined transmission power, comprising a configured transmission power for the transmission of the request for beam failure recovery and a configured transmission power for the scheduled transmission, exceeding an allowed transmission power.

28. The wireless device of claim 24, wherein the instructions, when executed by the one or more processors, configure the wireless device to:
initiate, based on a beam failure associated with a secondary cell, a beam failure recovery procedure; and
transmit, based on the beam failure, the request for beam failure recovery, and
wherein the request for beam failure recovery comprises a scheduling request (SR) for beam failure recovery.

29. The wireless device of claim 24, wherein:
the transmission occasion comprises a plurality of symbols corresponding to a transmission period;
the transmission of the request for beam failure recovery is associated with at least one first symbol of the transmission period; and
the scheduled transmission is associated with at least one second symbol of the transmission period.

30. The wireless device of claim 24, wherein the transmission of the request for beam failure recovery at least partially overlaps in time with the scheduled transmission.
